(19) United States
(12) Patent Application Publication
(10) Pub. No.: US 2025/0058207 A1
(43) Pub. Date: Feb. 20, 2025

(54) SYSTEM FOR DIGITIZING PHYSICAL CARD GAMES TO PROVIDE VIRTUAL EXTENSIONS

(71) Applicants: James Andrew Aman, Celebration, FL (US); Scott Rigby, Dallas, TX (US)

(72) Inventors: James Andrew Aman, Celebration, FL (US); Scott Rigby, Dallas, TX (US)

(21) Appl. No.: 18/804,400

(22) Filed: Aug. 14, 2024

Related U.S. Application Data
(60) Provisional application No. 63/533,159, filed on Aug. 17, 2023.

(51) Int. Cl. A63F 1/18; A63F 1/06; G06F 3/041; G06Q 50/10

(52) U.S. Cl. CPC A63F 1/18; A63F 1/067; G06F 3/041; G06Q 50/10

(57) ABSTRACT

The present invention relates to apparatus and methods for transducing (“digitizing”) the physical play and mechanics of card games to generate digital information at least comprising the current and on-going state of a given game. Further apparatus and methods are provided for implementing real-time game functions (“virtual extension”) using at least in part the on-going game state digital information, where functions include situational game instruction and advice, rule execution, game streaming, remote competition, game card valuation and acquisition advice and marketplace support, as well as game, player, and card histories for sale as NFTs. At least some transducing apparatus and methods are also applicable to board games, or the combination of board games and card games.

### CROSS-REFERENCE TO RELATED APPLICATIONS

The present application is related to the following six (6) U.S. patents: 1) U.S. Pat. No. 10,719,134 entitled INTERACTIVE OBJECT TRACKING MIRROR-DISPLAY AND ENTERTAINMENT SYSTEM filed on May 9, 2018, 2) U.S. Pat. No. 10,688,378 entitled PHYSICAL-VIRTUAL GAME BOARD AND CONTENT DELIVERY SYSTEM filed on Jul. 4, 2018, 3) U.S. Pat. No. 10,861,267 entitled THEME PARK GAMIFICATION, GUEST TRACKING AND ACCESS CONTROL SYSTEM filed on Aug. 4, 2018, 4) U.S. Pat. No. 10,974,135 entitled INTERACTIVE GAME THEATER WITH SECRET MESSAGE IMAGING SYSTEM filed on Sep. 27, 2018, 5) U.S. Pat. No. 11,025,892 entitled SYSTEM AND METHOD FOR SIMULTANEOUSLY PROVIDING PUBLIC AND PRIVATE MESSAGES filed on Apr. 4, 2019, and 6) U.S. Pat. No. 10,857,450 entitled PHYSICAL-VIRTUAL GAME BOARD AND CONTENT DELIVERY PLATFORM filed on Aug. 9, 2019.

### FIELD OF INVENTION

The present invention relates to apparatus and methods for transducing (“digitizing”) the physical play and mechanics of card games to generate digital information at least comprising the current and on-going state of a given game. Further apparatus and methods are provided for implementing real-time game functions (“virtual extension”) using at least in part the on-going game state digital information, where functions include situational game instruction and advice, rule execution, game streaming, remote competition, game card valuation and acquisition advice and marketplace support, as well as game, player, and card histories for sale as NFTs (non-fungible tokens).

### BACKGROUND OF THE INVENTION

In the cross-referenced related applications especially including U.S. Pat. No. 10,688,378 entitled PHYSICAL-VIRTUAL GAME BOARD AND CONTENT DELIVERY SYSTEM filed on Jul. 4, 2018, and U.S. Pat. No. 10,857,450 entitled PHYSICAL-VIRTUAL GAME BOARD AND CONTENT DELIVERY PLATFORM filed on Aug. 9, 2019, apparatus and methods were taught for application with physical board games that also included the use of playing cards. Several of these teachings have been brought forward in the present application as PRIOR ART onto which and around which additional novel teachings are provided. These novel teachings are primarily motivated by consideration of a “physical-virtual card game,” where card games are not limited to any given card game, but where a current popular game known in the marketplace as “Magic the Gathering,” manufactured and sold by Wizards of the Coast, is used as an instructive example.

Physical-virtual gaming falls within a general category referred to as “mixed reality,” where a gamer is interacting with physical objects while then also perceiving artificial or virtual experiences, such as but not limited to visual or audio augmentation. Physical game-play has well-known socialization and psychological benefits but is also limited by its physical nature in significant ways. Virtual game-play has greatly expanded the opportunities for “extended” socialization (e.g., to include players that are not physically present) and deeper game-engagement, further enhancing the psychological benefits, but likewise has been faulted for other socialization deficiencies. What is desirable is to implement a physical-virtual gaming environment that enables the majority of benefits from each distinct category.

Physical-virtual gaming offers significant opportunities beyond real-time augmented visual and audio experiences (such as provided by an “AR”/augmented reality devices including AR glasses or a smartphone). Some of the greatest benefits to both players and game manufacturers include increasing game adoption and play rates by “lowering the learning-bar to entry.” Many of today's most popular games, including Magic the Gathering, are not based upon a single deck of 52 possible “standard” cards (like traditional poker cards) but rather continue to issue new playing cards with variation “play features,” where this continued influx of new cards and features provides virtually limitless play variations introducing both the upside of “never-ending-novelty” (similar to a video game) as well as the downside of a significant learning curve. This learning curve serves to naturally stratify player competencies, even beyond the traditional “novice,” “intermediate,” and “expert,” levels, where measuring and classifying players for better competitive matching is also problematic without game state digitization supported by data analytics.

Many of the newer card games have significant sub-cultures comprising players and followers (spectators, loyalists, pundits) where a natural result is the formation of tournaments necessitating the physical presence of the players and realistically the followers as well. Game state digitization supports both live and on-demand streaming of these tournaments as well as individual games that are “decentralized,” for example played in geographically distributed homes collectively hosting at least some level of the tournament play (e.g., “qualifying rounds”). Given the complexity of the newer card games, many such tournaments include referees or game officials to rule on individual hand results, where game state digitization offers a means for supporting or automating this rule officiating, both at centralized tournaments and decentralized play.

Player registration and game tracking are important in the substantiation of any sport, where the typical cost for these “player associations” and “leagues” can be significant. Game state digitization is combinable with digital/distributed player registration and game tracking to facility virtual associations and leagues along with their attendant game matchups, tournaments, championships, etc. The tracking an official sanctioning of “league games” leads to a significant body of statistics, where this marketplace of game state data and statistics supports player rankings and individual “card-value” assessments. In many of these newer card games using “non-standard” cards, the cards themselves have features that naturally lend themselves to greater value for certain types and styles of play, where players seeking to trade and acquire new cards are desirous to know these relative card-values. Conversely, as teams and leagues are formed, players can be assessed for their relative “player-values” especially related to certain types and styles of play, thus forming the additional basis for fantasy leagues, or “virtual opponents,” in which case less skilled players manage made-up teams or play against made-up opponents with game-play skill levels and styles matching the more skilled and well-known players.

Along with the tracking of players, cards, leagues, tournaments, etc., all supported by game state digitization, there is a significant new opportunity for advertising and sponsorship, two important tools used to grow any particular sport. With physical-virtual gaming there is also a significant opportunity for multi-modal game-play as discussed in the related parent provisional application U.S. 63/399,338, entitled GAME ACCESS POINTS USING SURFACE COLOR CHANGING EFFECTS, filed on Aug. 19, 2022. In multi-modal game-play, the experiences of the physical-virtual card game are extended and otherwise made to seem “continuous” as persons that are card-players also participate in other activities such as companion physic-virtual board games (see especially U.S. Pat. No. 10,688,378 entitled PHYSICAL-VIRTUAL GAME BOARD AND CONTENT DELIVERY SYSTEM filed on Jul. 4, 2018, and U.S. Pat. No. 10,857,450 entitled PHYSICAL-VIRTUAL GAME BOARD AND CONTENT DELIVERY PLATFORM filed on Aug. 9, 2019), companion video games, companion arts and crafts such as coloring books, companion school work apps, and companion “destination games” (see especially the related U.S. Pat. No. 10,861,267 entitled THEME PARK GAMIFICATION, GUEST TRACKING AND ACCESS CONTROL SYSTEM filed on Aug. 4, 2018, and U.S. Pat. No. 10,974,135 entitled INTERACTIVE GAME THEATER WITH SECRET MESSAGE IMAGING SYSTEM filed on Sep. 27, 2018). In continuous multi-modal gaming, not only are game contexts and state communicated and shared between different modes of game-play, but any individual game-play mode and/or related experience is substantially affected by play results of a companion game mode.

Physical-virtual card games, like physical-virtual board games (or the combination,) also support tight integration with non-game “related-contextual-experiences,” such as a book, movie, or streaming multi-episode show whose release of content is impactful to the current possibilities of physical-virtual play, virtual augmentation, rules, settings, characters, moods, hints, quests, etc., thus deepening the engagement of a player with a content brand and its promoting entity. Such deeper engagement offers content entities (as well as advertisers) new means for promoting, for example using real-time “in-game” “random” opportunities that transform expected play with unexpected play (akin to a surprise “daily-double” in the game Jeopardy).

### BRIEF SUMMARY OF THE INVENTION

The present invention builds upon and extends the related cross-references which should be studied for the best understanding of at least the PRIOR ART apparatus and methods that are briefly recapped herein, as well as other PRIOR ART apparatus and methods that are assumed by the present invention to be understood based upon the references. The interested reader is also encouraged to review the parent application dealing with “game access points” primarily used in a destination interactive gaming system, where this destination “modality” of game-play was shown to be “continuable” in other and different modalities of game-play including an interactive physical-virtual game board (see the reference PRIOR ART,) where the presently taught interactive physical-virtual card game is a derivative and enhancement of the board game and can be combined in various ways not only with the physical-virtual board game, but also with the other stated and anticipated game modalities especially including the physical-virtual destination game.

The present invention can roughly be divided into 1) means for the transduction and digitization of the physical mechanics of card game-play into real-time game state information, 2) means for the translation of the digitized real-time game state information through combination with other determined game metrics, game descriptions, and player characteristics into new and useful game assist and presentation datum, and 3) means for providing the useful game assist and presentation datum including at least in part using the datum to create physical perceptible outputs. These three categories of means for are generally referred to herein as 1) game state determination, 2) game state processing, and 3) game state enhancement.

Game state determination (1) builds upon the PRIOR ART that taught means for identifying individual playing cards using either of (a) image processing, or (b) short-range wireless electronic data exchange with passive electronic tags. A preferably mobile computing device such as a smartphone was shown to include two necessary sensing components, first a camera to capture card images for image processing (a), and second a wireless reader (preferably and typically an NFC/“near field communications” reader) for emitting RF (radio frequency) signals and capturing responses from a passive NFC “tag” thus providing electronic data exchange (b). The mobile computing device was also shown to preferably include additional (c) longer-range wireless electronic data exchange with active computing devices (e.g., using Bluetooth or WiFi communications). One such active computing device was shown to be a “game piece base” comprising at least the combination of (b) and (c), wherein by using (b) this game piece base was capable of also reading the NFC tag associated with a particular game card and by using (c) this game piece base was capable of communicating the alternatively sensed NFC card data back to the mobile computing device (where it is understood that this pathway includes also writing data provided by the mobile computing device onto the passive NFC tag via communication through the game piece base).

The PRIOR ART was also shown to teach a game card comprising a passive (preferably NFC) electronic tag, and/or a “game card sleeve” for inserting and holding a game card where the sleeve alternatively comprised the preferred passive NFC tag, as well as also a “passive game board base” comprising a matrix of preferably NFC electronically readable tags. Both the mobile computing device and the game piece base were shown to be capable of detecting either or both of the identity of a game card (or game card within a game card sleave) and the location of a game card if laid down upon a passive game board. The PRIOR ART also taught an “active game board 1” that comprised electronics for reading an NFC tag (such as comprised within a game card or game card sleeve) placed over the surface of the active game board (comprising a matrix of NFC reader antenna) such that alternative to the mobile computing device and/or game piece base, the active game board could also determine either or both the identity of a game card (or game card within a game card sleave) and the location of a game card if laid down upon an active game board 1.

The PRIOR ART showed additional important apparatus and methods for maintaining a communication path with either or both of a “global environment eco-system” or a “local environment eco-system,” where for example the global eco-system included an entity (content, experience producer) for exchanging game state data as well as game content with the local game-play apparatus such as the (any connected) mobile computing device or active game board. The local eco-system was shown to include ancillary devices such for effecting the perceptions of the local game-players and included interactive jewelry, room lighting and sound augmentation, “magic mirrors” and other “secret message devices,” etc.

The present application extends these PRIOR ART teachings, for example where an active computing device for reading and writing to an NFC tag (e.g., embedded in a game card, game card sleeve, passive game board, etc.) and also communicating with a mobile computing device comprises a wearable, for example worn on a finger/thumb tip, as a ring or even a watch. The PRIOR ART game piece base was further extended to sense relative orientation and/or game-play surface location by interacting with a magnetic field and/or using any of absolute orientation sensors. Further extensions to the game piece base including an NFC antenna switch for multiplexing between at least two NFC tag reading antennas, for example one antenna facing down and the other antenna facing up, a local data communication port for communicating between co-joined game piece bases, as well as a game piece “decoration” for ornamenting the game piece base.

The present application teaches a variation of an active game board 1 comprising one or more side-arranged arrays of transducers for use in sensing the identity and location of NFC tags embedded in for example game cards, game card sleeves, or game piece bases located substantially within a sensing area comprising the playing surface. These portable transducer arrays can be located to circumscribe a variably sized “playing surface” within which the placement of “tagged” objects can be determined. This variably sized playing surface is discussed to optionally comprise a passive game board and/or a passive game board overlay, where either or both of the game board and overlay can be calibrated to the one or more arrays such that tagged objects that are identified and located can then also be “mapped” and correlated to physical sensing locations on a passive game board and/or logical play locations on a game board overlay.

Card game-play apparatus taught herein include further adapted game card sleeves comprising non-visible markings (e.g., around the edges of the sleeve) and optionally thin-film power and switching means for changing the state of an electrochromic polymer coating the sleeve window that exposes the game card held within the sleeve. The non-visible markings, such as made using an IR/infrared ink, are shown to work in combination with modified AR glasses further comprising one or more matched-frequency IR light emitters (such as an IR LED) and preferably two IR sensitive cameras for capturing images processed to at least locate in 3D any of the IR markers within the player's field-of-view. Once located, the display technology traditionally available in typical AR glasses is then used to augment the player's view of these IR marked sleeves, for example making an individual sleeve/card appear to “glow” to the player and or otherwise providing augmenting game information.

The game cards themselves (or in a variation, the game card sleeve) are shown to be further adapted with a non-visible coating capable of absorbing a non-visible energy such as UV for conversion and emission as a visible energy, thus when so illuminated making the card appear to glow (via either fluorescence or phosphoresce). The AR glasses are also shown as further adapted to also include one or more non-visible light emitters (such as a UV LED) for energizing the fluorescing or phosphorescing coating. The non-visible IR markings provided for the game cards sleeves (or game cards) are also shown to be possible and beneficial for marking any of an active or passive game board, or a game board overlay, such markings (“fiducials”/“landmarks”) then also being detectable by the modified AR glasses for assisting in the augmentation of a player's view of either or both the playing cards and the game board.

The present invention considers the “game mechanics flow” of a card game such as Magic the Gathering, detailing several key mechanics that are real player motions interacting with the game cards to provide on-going game meaning. These various mechanics are identified as game-play steps including: 1) acquiring cards for a deck, 2) selecting a current deck from the available acquired cards, 3) randomly shuffling the current deck, 4) adding cards to a current hand (hidden from the opponents view), 5) laying down a card into the opponents view as a play, 6) “tapping” (physically turning in orientation for example from portrait to landscape) a card to indicate a change of state, 7) touching a first card to a second card as a means of creating an “instant” effect “joining” the two cards with respect to any of their features/powers/values, etc., 8) determining results based upon current played and joined cards, 9) the updating and resetting of the current hand, and 10) the discarding of used cards.

Steps 2-7 are shown to use apparatus and methods as herein discussed for transducing into signals for digitizing as the “current game state.” Steps 8-10 are shown to be at least in part accomplished by using a “game app” which then also updates the current game state. During steps 1, 2, and 4-7, the player is shown to be optionally “assisted” by the processing of at least the current game state and/or the use of additional game information (such as from the game manufacturer or pundits) provided as presentation datum. The present application provides a data structures view of the current game state and additional game information, where such additional information preferably comprising player determined preferences and motivations, and where these preferences and motivations are shown to be used at least in part to affect the presentation datum.

The present invention has application in card games, board games, and combined card and board games, as well as any of these games of which being used a single modality of a “continuous game” played over multiple game modalities including physical-virtual destination gaming, video gaming, coloring book gaming, and schoolwork educational gaming, all as further discussed in the present application's related patent application. Other applications will also be apparent from a careful review of the related applications and of the detailed description and figures provided herein.

### BRIEF DESCRIPTION OF THE SEVERAL VIEWS OF THE DRAWING

In the following description, numerous specific details are set forth, such as examples of specific components, types of usage scenarios, etc. in order to provide a thorough understanding of the present disclosure. It will be apparent, however, to one skilled in the art that the present disclosure may be practiced without these specific details and with alternative implementations, some of which are also described herein. In other instances, well known components or methods have not been described in detail in order to avoid unnecessarily obscuring the present disclosure. Thus, the specific details set forth are merely exemplary. The specific details may be varied from and still be contemplated to be within the spirit and scope of the present disclosure.

### BRIEF DESCRIPTION OF THE DRAWINGS

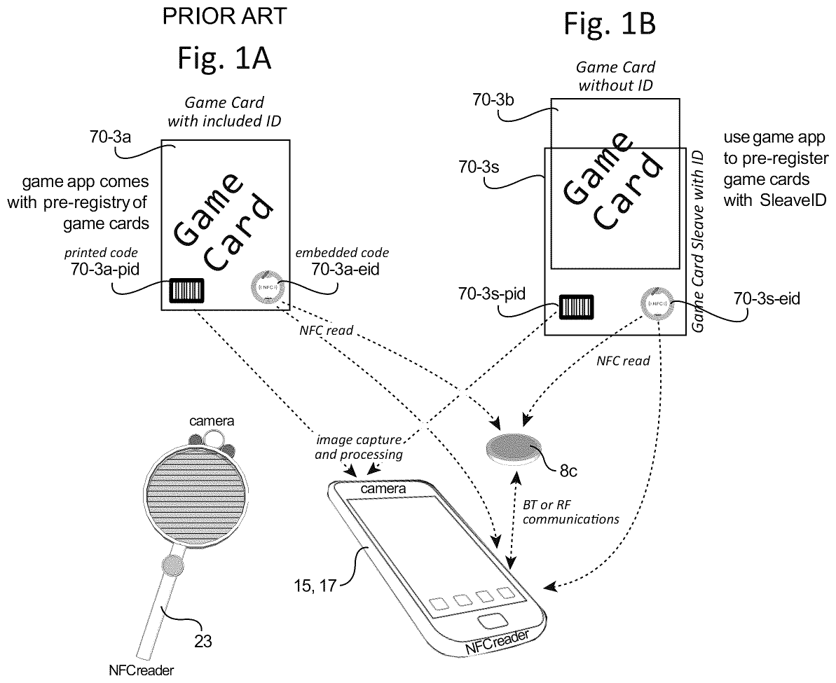

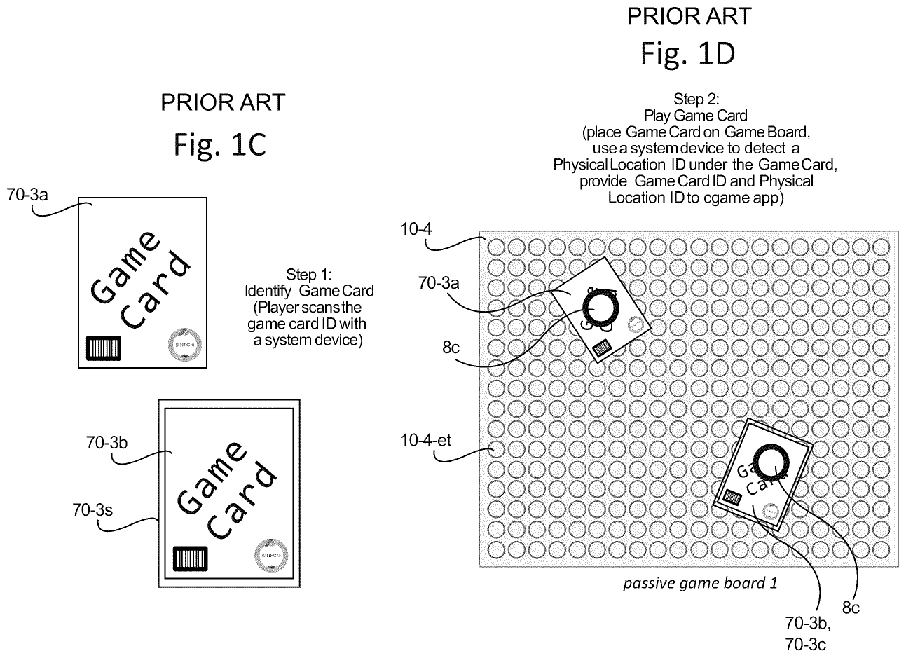

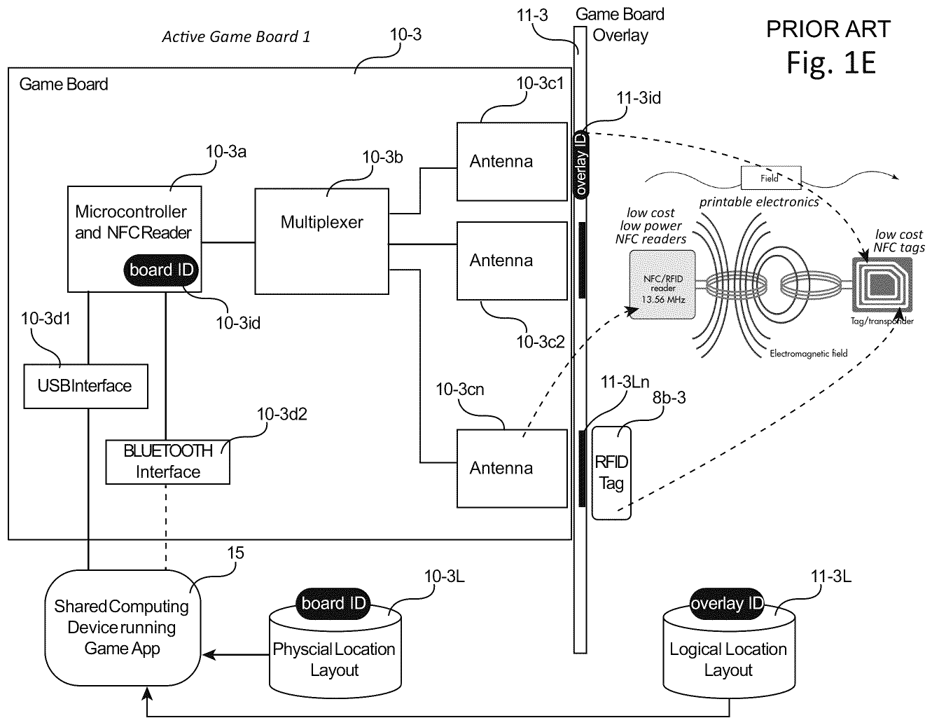

FIGS. 1A and 1B are a direct copy of FIGS. 9A and 9B from the PRIOR ART cross-referenced U.S. Pat. No. 10,857,450 entitled PHYSICAL-VIRTUAL GAME BOARD AND CONTENT DELIVERY PLATFORM filed on Aug. 9, 2019. (The following brief descriptions of FIGS. 1A and 1B are taken directly from the brief descriptions in the PRIOR ART for FIGS. 9A and 9B, respectively.)

FIG. 1A “depicts a preferred game card 70-3a within an included game card ID, such as a printed ID 70-3a-pid, e.g. a bar code, or an embedded ID 70-3a-eid, e.g. an NFC tag. Players input the ID 70-3a-pid or 70-3a-eid of a game card 70-3a using for example the game app running on a computing device 15 or 17, where the computing device 15 or 17 further includes for example a camera for capturing and processing printed ID 70-3a-pid and/or an NFC reader for capturing and processing an embedded ID 70-3a-eid. Players preferably have access to a game toy device such as magnifying glass 23 that also includes either or both a camera and an NFC reader, and therefore device 23 can also be used by a player to input a game card ID such as 70-3a-pid or 70-3a-eid.”

FIG. 1B “depicts a game card 70-3b that does not include a game card ID, where game card 70-3b is then inserted into a game card sleeve 70-3s, where sleeve 70-3s further comprises either or both of a printed ID 70-3s-pid or embedded ID 70-3s-eid, and where IDs 70-3s-pid or 70-3s-eid are detectable by devices such as 15, 17 or 23. A player preferably uses the game app running on a computing device such as 15 of 17 to register individual game cards without IDs 70-3b, matching the game cards 70-3b with the game card sleeves 70-3s into which they have been inserted.”

FIGS. 1C and 1D are a direct copy of FIGS. 9C and 9D from the PRIOR ART cross-referenced U.S. Pat. No. 10,857,450 entitled PHYSICAL-VIRTUAL GAME BOARD AND CONTENT DELIVERY PLATFORM filed on Aug. 9, 2019. (The following brief descriptions of FIGS. 1C and 1D are taken directly from the brief descriptions in the PRIOR ART for FIGS. 9C and 9D, respectively.)

FIG. 1C “depicts either of a game card with ID 70-3a or a game card without ID 70-3b inserted into a sleeve 70-3c being identified in a step 1 of game card-play, where preferably the player is first prompted by the game app on a device 15 or 17 to identify a game card to play, after which the player uses any of system devices to scan the registered game card 70-3a ID or game card sleeve 70-3c ID, and where system devices include any of computing devices 15 or 17, active game pieces 8c, an active game board 10b (see parent application) or a game toy such as magnifying glass 23.”

FIG. 1D “depicts an optional step 2 of game card-play where a game card with ID 70-3a or a game card without ID 70-3b inserted into a sleeve 70-3c has been placed onto a game overlay after which any of system devices including the game app running on a computing device 15 or 17, an active game piece 8c, an active game board (10b of the parent application,) or a game toy such as magnifying glass 23 are used to determine a physical location over which the game card 70-3a or 70-3b has been placed, where the physical location is translatable into a logical location and also usable to direct any of system 2 (or 1) responses to the playing of the game card by the player.”

FIG. 1E is a direct copy of FIG. 8 from the PRIOR ART cross-referenced U.S. Pat. No. 10,688,378 entitled PHYSICAL-VIRTUAL GAME BOARD AND CONTENT DELIVERY SYSTEM filed on Jul. 4, 2018. (The following brief description of FIG. 1E is taken directly from the brief description in the PRIOR ART for FIG. 8.)

FIG. 1E “depicts an alternative game board 10-3 and game board overlay 11-3 where the combination of the microcontroller and multiplexer connect at least one NFC reader to multiple antenna, thus saving on the cost of NFC readers where the antennas can be produced using lower cost printable electronics. Physical locations, such as 10-3c1, 10-3c2 and 10-3cn are implemented as individual addressable NFC antennas, and game piece bases 8b-3 are implemented as NFC tags.”

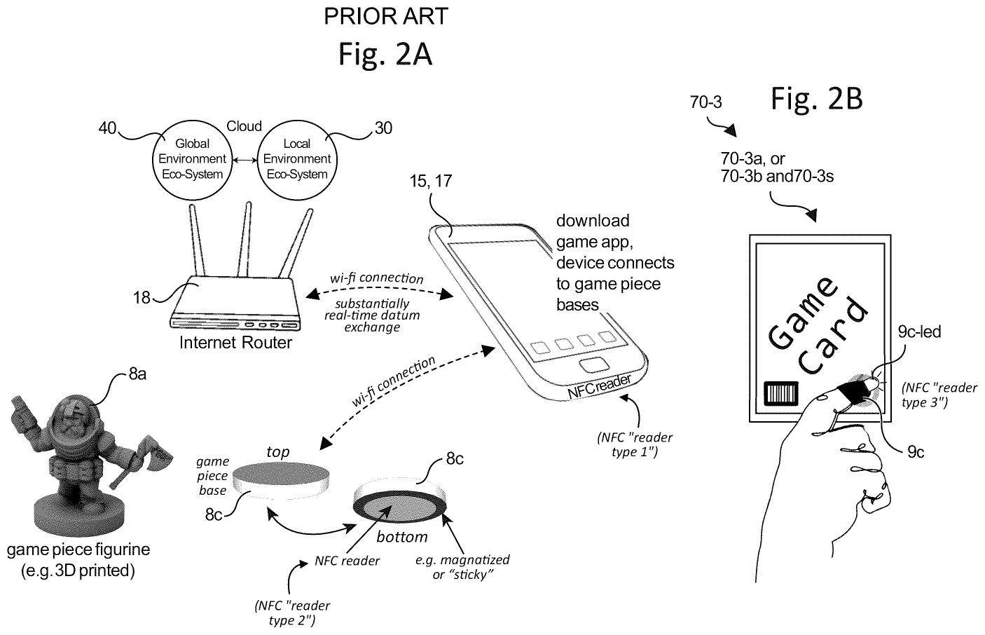

FIG. 2A is a direct copy of select elements from FIGS. 1 and 2B from the PRIOR ART cross-referenced U.S. Pat. No. 10,857,450 entitled PHYSICAL-VIRTUAL GAME BOARD AND CONTENT DELIVERY PLATFORM filed on Aug. 9, 2019. (The following brief descriptions of FIG. 2A comprises language taken from the brief descriptions in the PRIOR ART for FIGS. 1 and 2B, respectively.)

FIG. 2A provides key apparatus for use with a physical-virtual board game and content delivery system comprising a “game board,” a “game board overlay,” and “game piece bases” such as 8c that “optionally accept game piece figurines 8a,” “a game app running on a computing device 15 or 17, where the computing device 15 or 17 preferably has access to a remote system such as 40 or 30 for providing the game app and related datum or receiving game app related datum.” “Active game piece bases” such as 8c are intended for use with “passive game board(s).” The present figure “depicts top and bottom perspective views of a representative active game piece base 8c that includes both a sensing area, for example including an NFC reader, and an attaching area, for example including a material such as a magnet or a sticky substance especially useful for attaching the game piece base 8c to a vertically oriented game board and overlay attached or being held by a vertically oriented surface such as a refrigerator.”

FIG. 2B depicts either game card with ID 70-3a or a game card without ID 70-3b inserted into a sleeve 70-3c being identified in a step of game card-play, where either implementation of a game card (such as 70-3a, or 70-3b combined with 70-3c) comprising a detectable ID is herein generally referred to as simply playable game card 70-3. A playable game card 70-3 comprising an electronically readable ID such as an NFC tag is shown as being detected/“read”/communicated with including writing information to the tag, using a “game piece base” implemented as a wearable, in this depiction a fingertip wearable 9c.

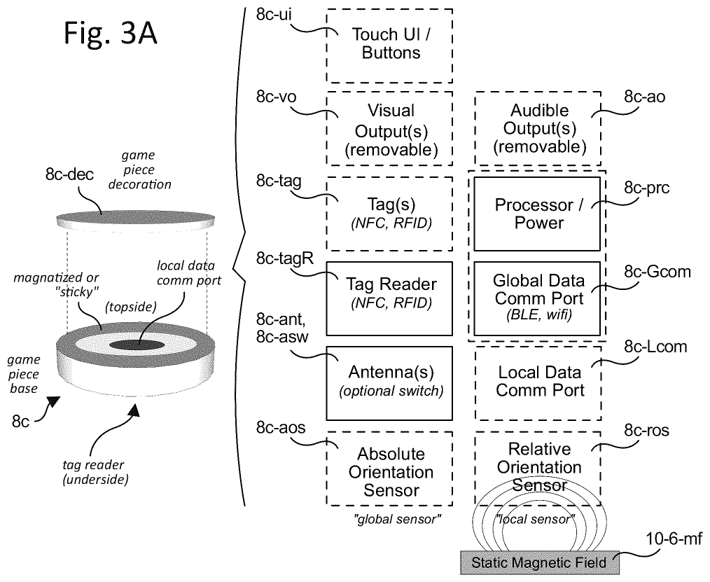

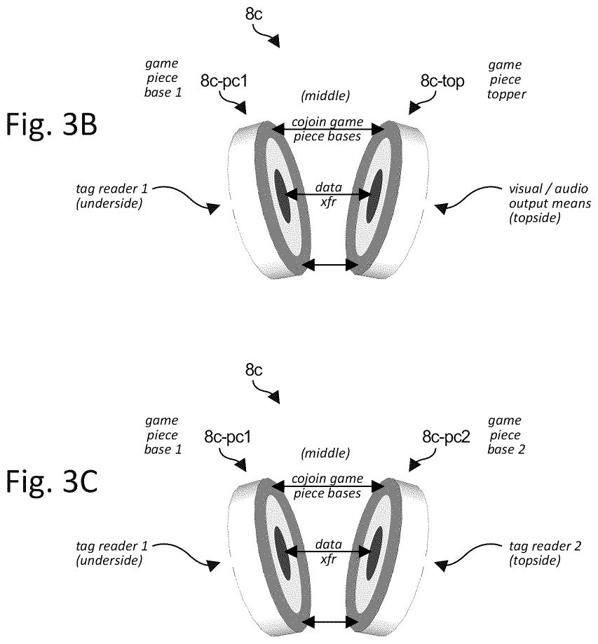

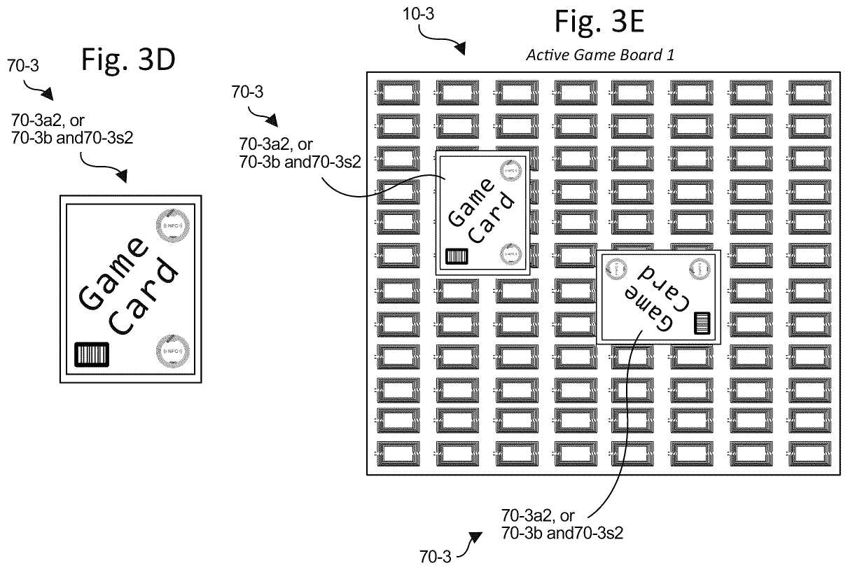

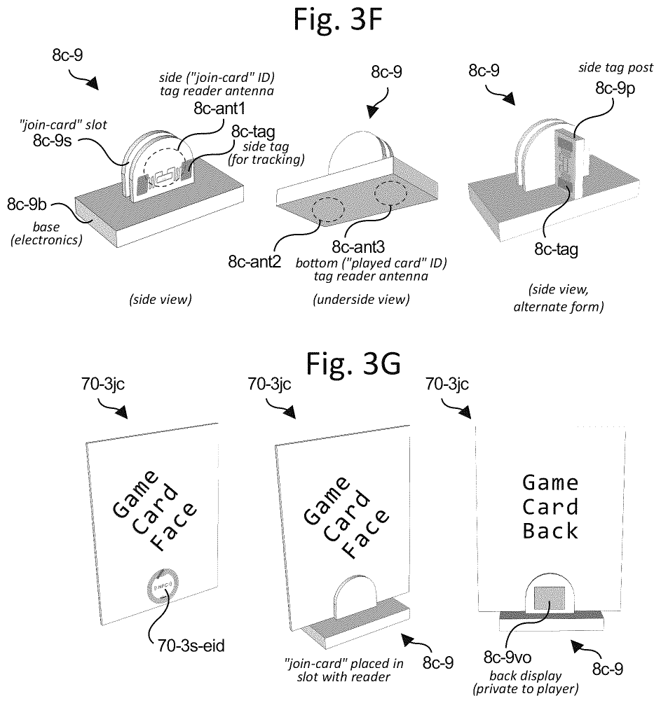

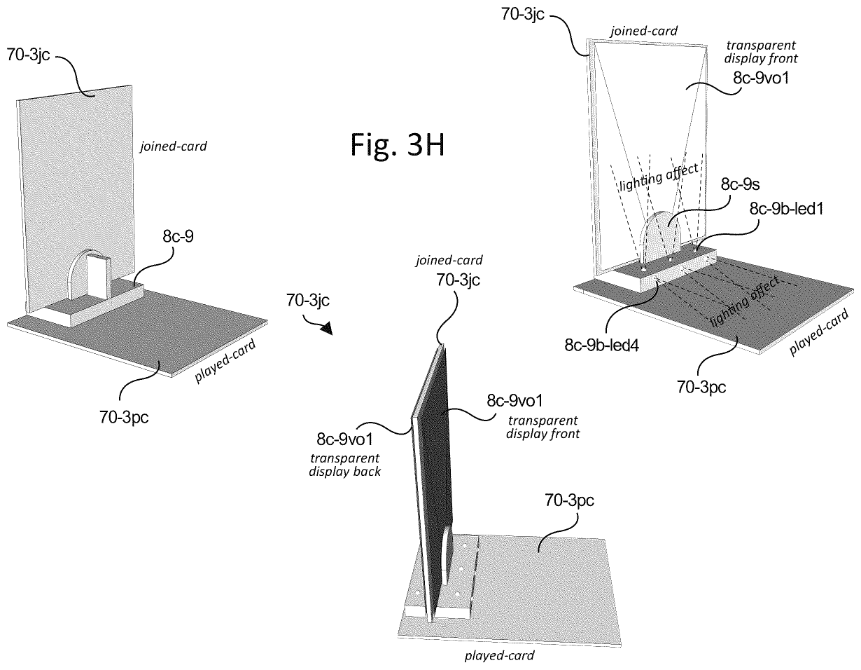

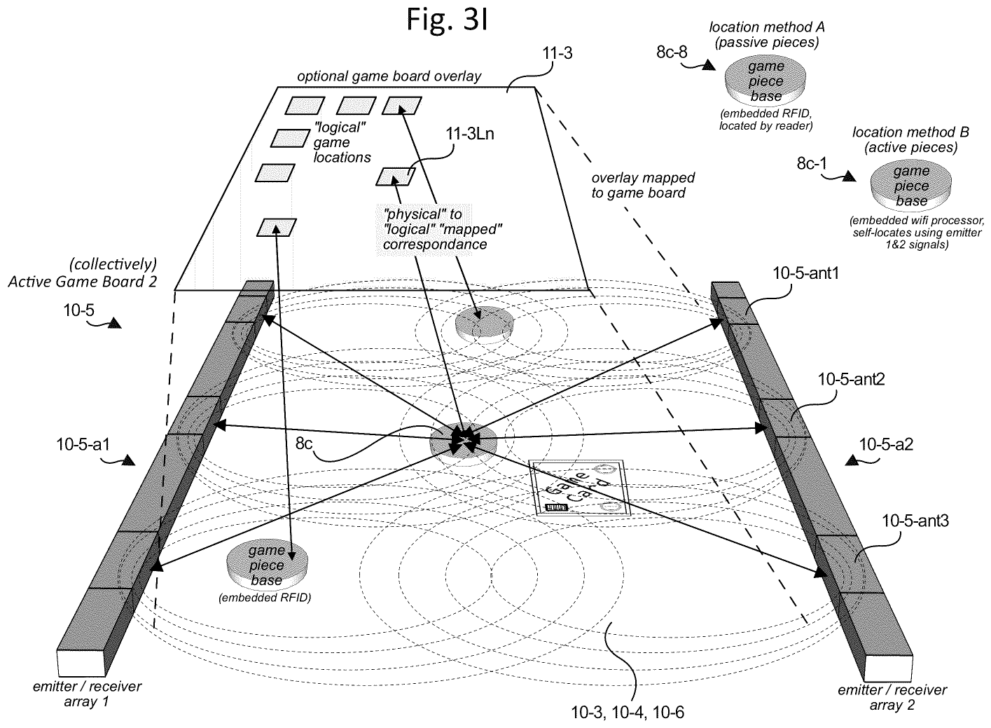

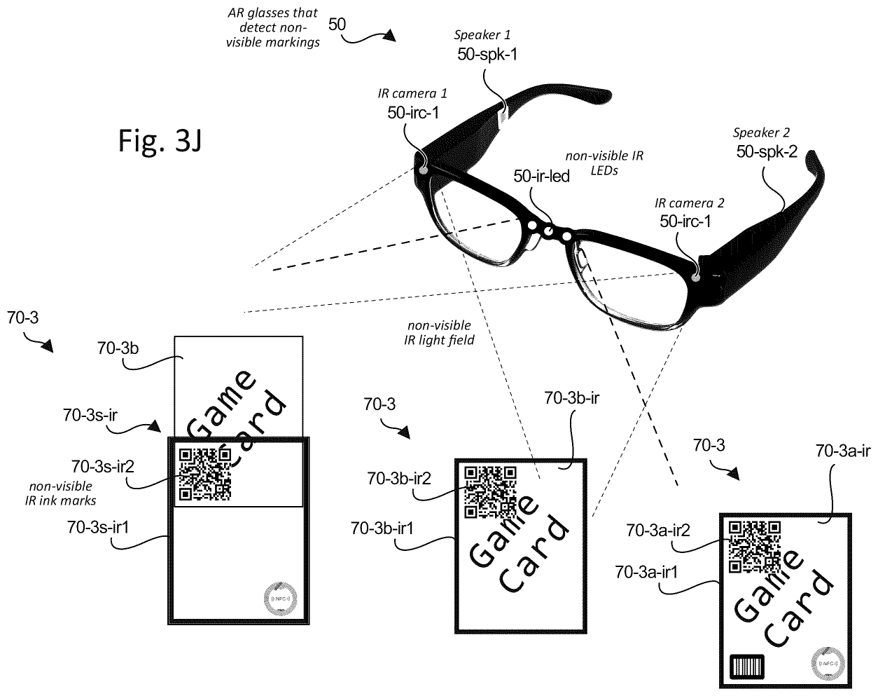

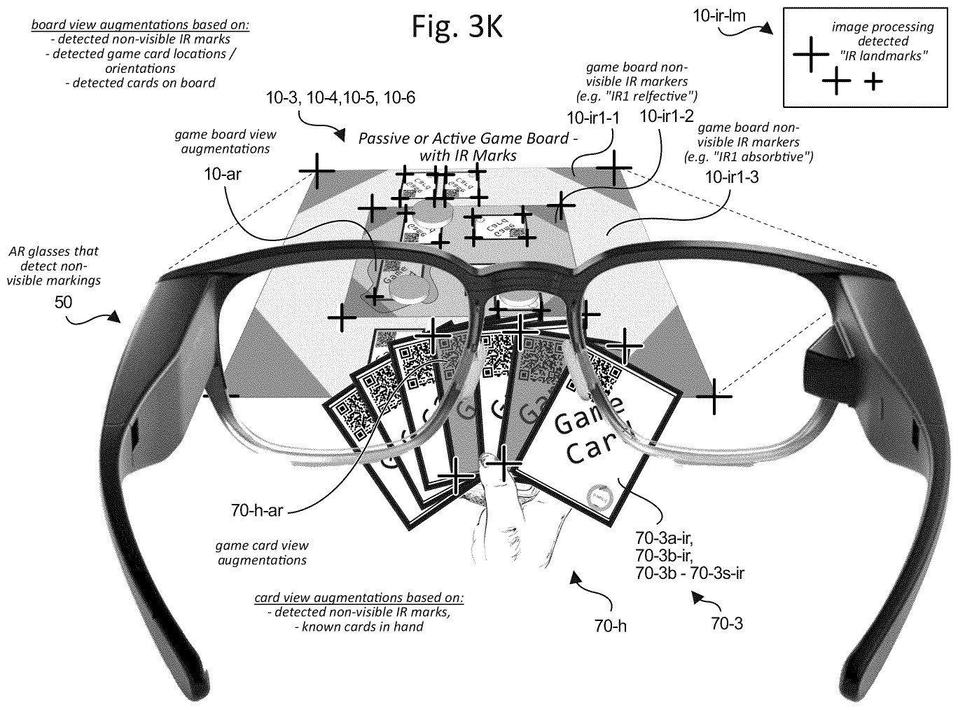

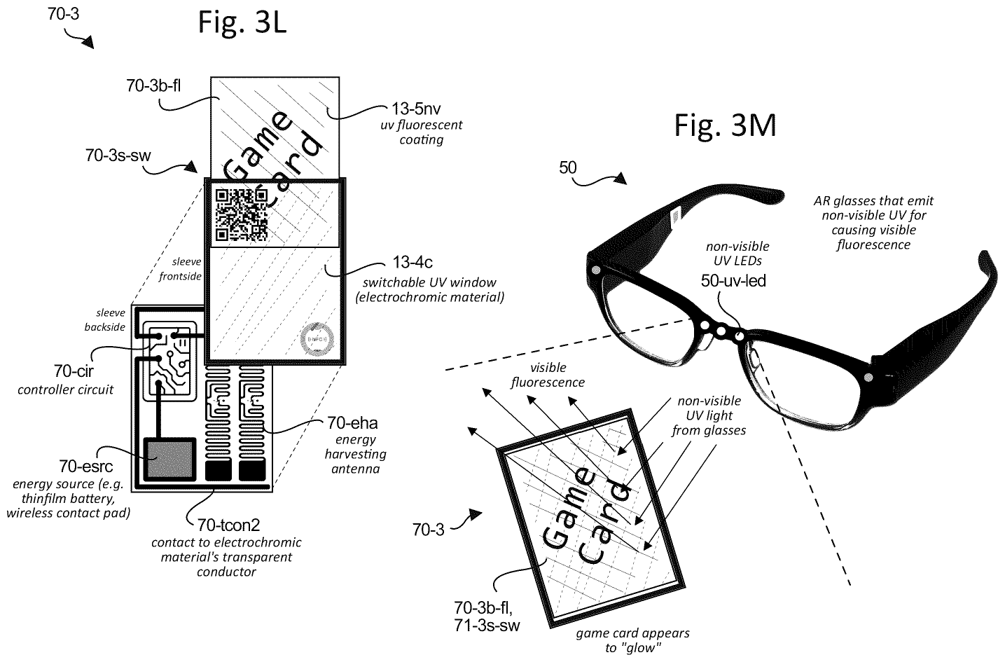

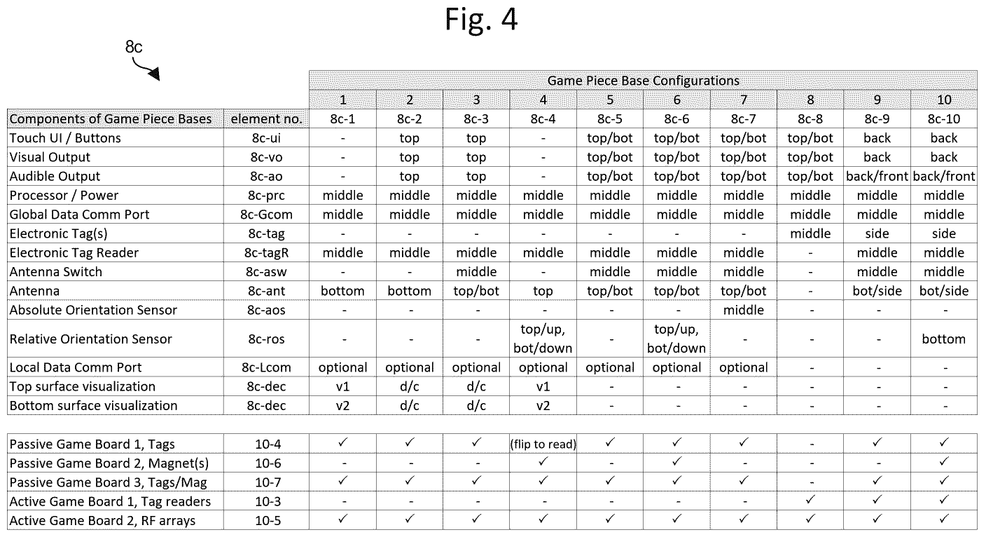

FIG. 3A is a combination perspective/side view of a game piece base 8c along with an optional and passive game piece decoration 8c-dec for attachment to either or both of the top and bottom of a base 8c, as well as a block diagram showing the major components of a possible game piece base 8c that has many possible configurations (see especially FIG. 4 for more details).

FIG. 3B is a perspective view depicting the combining of a configuration of a game piece base, thus 8c-pc1, with a game piece topper 8c-top, where topper 8c-top includes at least one active component (as opposed to a decoration 8c-dec without any active components) and is in communication with piece 8c-pc1, either directly through a communication port or indirectly through an intermediary such as a game app.

FIG. 3C is a perspective view depicting the combining of a configuration of a game piece base, thus 8c-pc1, with a second game piece base, thus 8c-pc2, where each of 8c-pc1 and 8c-pc2 are of any game piece base configuration, and where the combination of 8c-pc1 and 8c-pc2 forms a new game piece base 8c.

FIG. 3D depicts either game card with ID 70-3a or a game card without ID 70-3b inserted into a sleeve 70-3c, now further adapted to include multiple electronic (preferably NFC) tags depicted in the present figure as two (2) tags, thus becoming 70-3a2 or the combination of 70-3b and 70-3c2, and in either case still being a plaslyable game card 70-3.

FIG. 3E depicts a playable game card 70-3 comprising multiple electronic tags being placed on a PRIOR ART “active game board 1” 10-3, where the relative orientation (such as “vertical” versus “horizontal”) of the playable game card 70-3 with respect to the active game board 10-3 is determined at least in part by reading the multiple electronic tags.

FIG. 3F is a set of three perspective views of an alternate form game piece base 8c-9, where, as opposed to the “coin” form of generic base 8c as otherwise depicted, alternate form 8c-9 comprises a “join-card” slot 8c-9s attached to a base 8c-9b. Slot 8c-9s preferably comprises a tag reader antenna 8c-tra1 for detecting an electronic tag (such as a short-read distance NFC tag) comprised in a join-card inserted into the slot 8c-9s, and an electronic tag 8c-tag (such as an longer-read distance RFID) for use in game piece base 8c-9 location tracking. Game piece 8c-9's base 8c-9b preferably comprises electronics sufficient for operating, where operations also include reading preferably NFC tags using one or more electronic tag reader antennas such as 8c-tra2 and 8c-tra3. Base 8c-9b and slot 8c-9s may have additional side tag post 8c-9p for alternatively including long-read distance electronic tag 8c-tag so as to position tag 8c-tag at a more advantageous orientation with respect to any wireless reader antennas used for emitting and/or receiving base 8c-9 location tracking signals.

FIG. 3G is a series of three perspective views of a playable game card 70-3 being used as a “join-card” 70-3jc, where in the leftmost view the join-card 70-3jc is not placed in the game piece base 8c-9's reader slot 8c-9s, and where in the middle view and rightmost views the join-card 70-3jc is placed in reader slot 8c-9s, thus being detected by the game piece base 8c-9 by means for slot antenna 8c-ant1 (see FIG. 3F). While the middle view shows the game card face (presumably as seen by an opponent,) the rightmost view shows the game card back (presumably as seen by the player of the join-card 70-3jc,) where the slot 8c-9s of game piece base 8c-9 has been further adapted to comprise a display/visual output 8c-9vo for indicating information to the join-card-player, and where display 8c-9vo is preferably positioned so as to not be in the view of the opponent.

FIG. 3H is a set of three perspective drawings of game piece base 8c-9, first on the left as described in relation to FIGS. 3F and 3G, and then in the middle and on the right as a further adapted variation of game piece base 8c-9, where the further adaptions at least including expanding the size of display/visual output 8c-9vo to substantially comprise the entire “size” of an anticipated join-card, and using a transparent display technology for visual output 8c-9vo, such that the expanded transparent visual output 8c-9vo is usable to serve for real-time visual augmentation of the join-card. Other adaptations include one or more LEDs such as 8c-9b-led1 or 8c-9b-led4 for controllably emitting light to create a lighting effect on either or both of the vertically oriented join-card 70-3jc or the horizontally oriented played-card 70-3pc.

FIG. 3I is a perspective drawing of an alternative “active game board 2” 10-5, where the array of sensing antennas such as 10-5-a1 and 10-5-a2 is moved from substantially underneath the playing area (see “active game board 1” in FIG. 3E as well as the PRIOR ART U.S. Pat. No. 10,688,378 entitled PHYSICAL-VIRTUAL GAME BOARD AND CONTENT DELIVERY SYSTEM filed on Jul. 4, 2018) to one or more sides of the playing surface area. Any configuration of one or more sensing arrays such as 10-5-a1 and 10-5-a2 preferably comprises two or more antenna such as 10-5-ant1, 10-5-ant2, and 10-5-ant3 included within array 10-5-a2. Antennas such as 10-5-ant1, 10-5-ant2, and 10-5-ant3 are configured to either emit and/or receive signals that are substantially oriented to sense the playing surface area where player cards and game piece bases such as 8c-1 and 8c-8 are anticipated to be set down during on-going game-play. Locations of any card or base are determined using a number of possible available technologies, each with varying degrees of accuracy, power requirements, size requirements, etc., including for use in a “method A” where the pieces are passive and “method B” where the pieces are active. Any of a game board such as 10-3, 10-4, 10-6 and/or game board overlay 11-3 are also optionally placed within the sensed playing surface area and registered to the one or more arrays 10-5-a1 and 10-5-a2 such that tracked physical locations of cards and/or game piece bases within the playing surface area are then mappable to logical locations of the game board and/or overlay for determining game board situations and progression.

FIG. 3J is a perspective drawing of AR glasses 50 (such as currently available in the marketplace or to become available) that have been further adapted to preferably comprise one or more non-visible light emitters 50-ir-led such as LEDs for emitting any of UV or IR light, preferably two or more cameras 50-irc-1 and 50-irc-2 for sensing non-visible light such as IR light emitted by the lights 50-ir-led, and preferably one or more audible outputs such as speakers 50-spk-1 and 50-spk-2 (if these speakers are not already present in the AR glasses 50 to be further adapted). Playable game card 70-3 is depicted in three different configurations, where each configuration such as a game card without ID 70-3b inserted into a game card sleeve with non-visible markings 70-3s-ir, comprises one or more non-visible markings such as card edge markings 70-3s-ir1 or card ID markings 70-3s-ir2, where for example the non-visible markings comprise a non-visible IR responsive substance for substantially reflecting and/or absorbing non-visible energy emitted by non-visible light emitters 50-ir-led.

FIG. 3K is a perspective drawing from the viewpoint of a card game-player looking though further adapted AR glasses 50 at any of “game portions” such as their playing hand 70-h comprising one or more playable game cards 70-3 and then also possibly any of a passive or active game board 10-3, 10-4, 10-5, or 10-6, with or without a game overlay 11-3 (not depicted). Playable game cards 70-3 and any of boards 10-3, 10-4, 10-5, or 10-6 preferably comprise non-visible markings that are detectable using image processing by glasses 50 for locating non-visible fiducials such as “IR landmarks” 10-1r1-1, 10-1r1-2, and 10-ir1-3, where using at least in part the detected fiducials/landmarks glasses 50 provide visible augmentations for the player to any of the “game portions” such as card 70-3 augmentation 70-h-ar, or game board augmentation 10-ar.

FIG. 3L is a top-view depiction of a playable game card 70-3 comprising the combination of a fluorescent game card 70-3b-fl inserted into a switchable window game card sleeve 70-3s-sw. Card 70-3b-fl is preferably coated with a UV fluorescent coating 13-5nv for absorbing a non-visible, such as UVA energy emitted by further adapted glasses 50 (see FIG. 3M,) and then readmitting visible light to be perceived by a card game-player. Switchable window sleeve 70-3s-sw is preferably coated with an electronically switchable electrochromic coating 13-4c that is capable of electronic switching between a state of substantially blocking any non-visible (such as UVA, or NIR) energy emitted by glasses 50, and a state of substantially transmitting the emitted non-visible energy, such that when in the transmitting state game card 70-3b-fl is caused to fluoresce the transmitted non-visible energy as visible light to be perceived by a player. Coatings such as 13-5nv and 13-4c are discussed in the related parent provisional application 63/399,338. Sleeve 70-3s-sw is shown to comprise a controller circuit 70-pcir for switching the electrochromic material between states, an energy source 70-escr for powering the controller circuit 70-pcir, and/or an energy harvesting antenna 70-eha for either powering the controller circuit 70-pcir or recharging the energy source 70-escr.

FIG. 3M is a perspective drawing of AR glasses 50 that are further adapted to include one or more non-visible UV LEDs 50-uv-led for emitting preferably UVA energy to be controllably transmitted through switchable window sleeve 70-3s-sw for receiving and fluorescing by fluorescent game card 70-3b-fl, where the fluorescing is then perceived by a player as playable game card 70-3 appearing to glow.

FIG. 4 is a table showing various game piece base 8c configurations 8c-1, 8c-2, 8c-3, 8c-4, 8c-5, 8c-6, 8c-7, 8c-8, 8c-9, and 8c-10, each comprising different combinations of components including touch UI/buttons 8c-ui, visual output 8c-vo, audible output 8c-ao, processor/power 8c-prc, global data, wireless comm port 8c-Gcom, electronic tag(s) 8c-tag, electronic tag reader 8c, antenna switch 8c-ants, antenna 8c-ant, absolute orientation sensor 8c-aos, relative orientation sensor 8c-ros, local data comm port 8c-Lcom, top surface visualization 8c-dec, and bottom surface visualization 8c-dec, where the various game piece bases 8c work in combination with any one or more of “passive game board 1” 10-4 using electronic tags, “passive game board 2” 10-6 using magnets, “passive game board 3” 10-7 using electronic tags and magnets, “active game board 1” 10-3 using underside electronic tag readers, and “active game board 2” 10-5 using side electronic tag reader arrays.

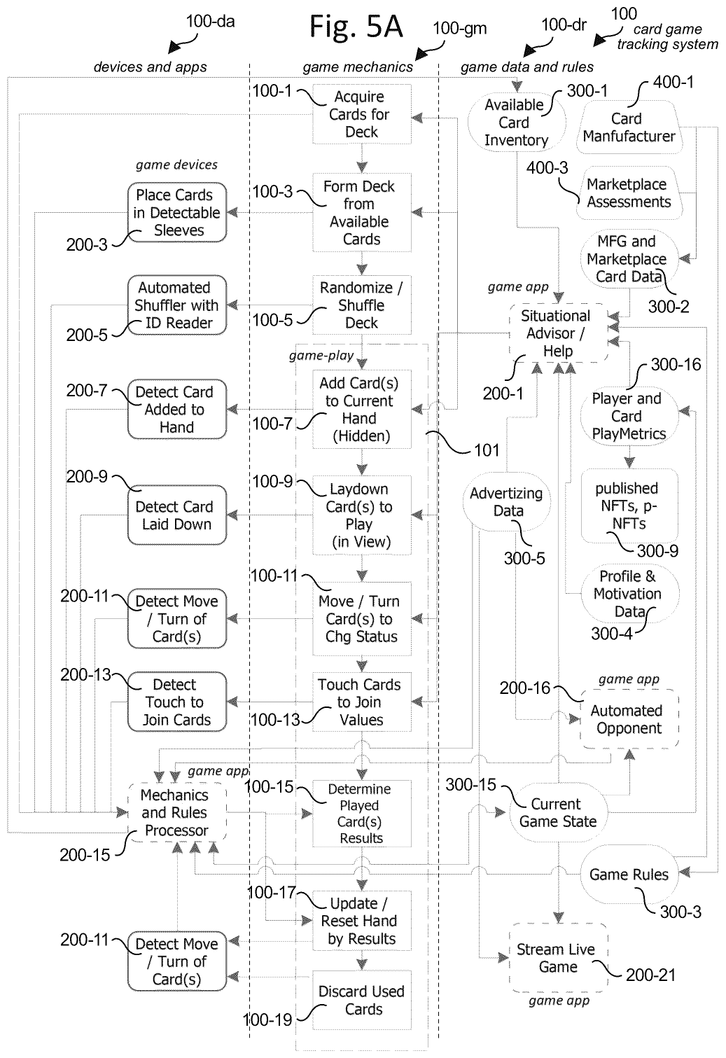

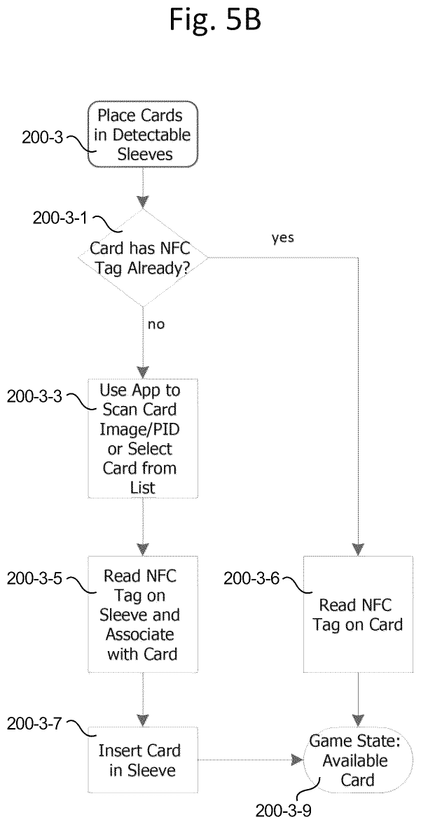

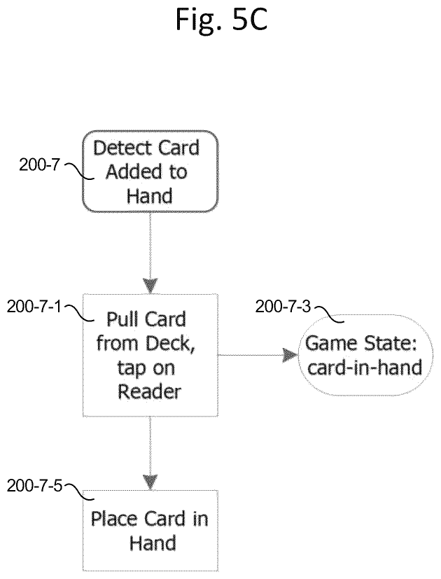

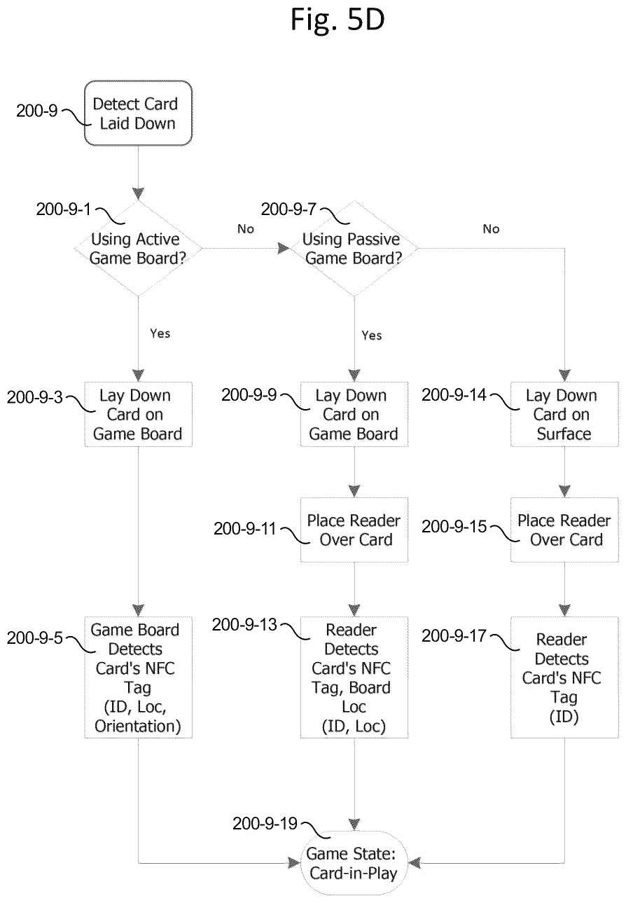

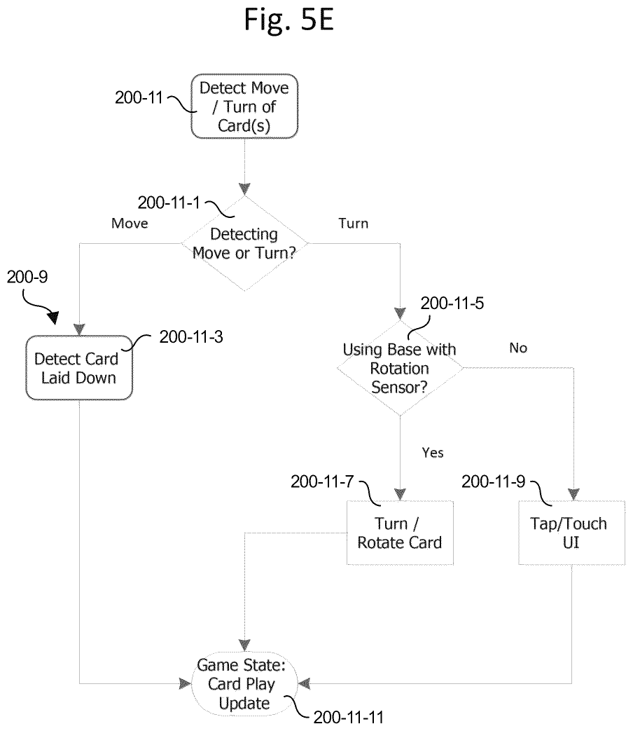

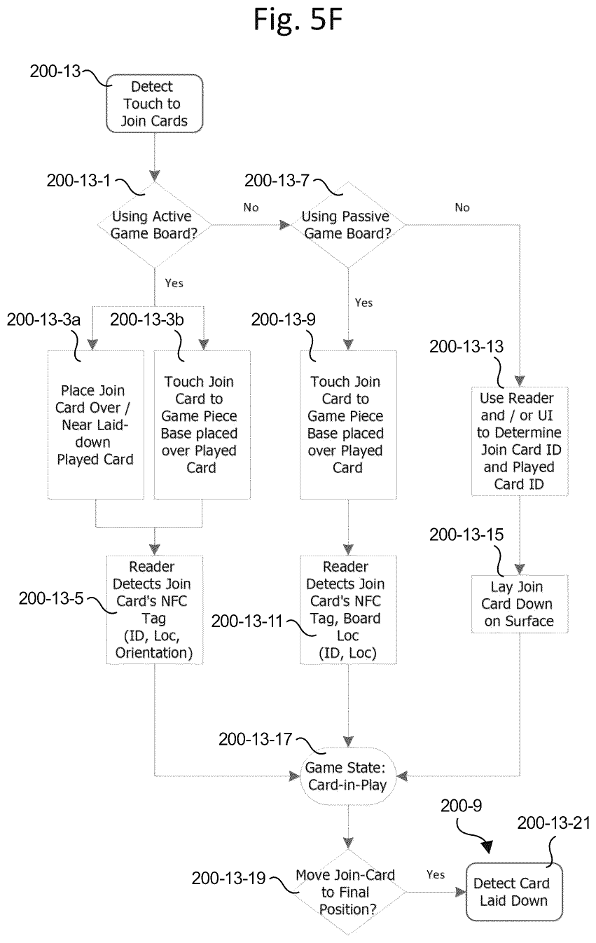

FIG. 5A is a flow chart of card game tracking system 100 comprising devices and apps 100-da for use in sensing and transforming physical card game mechanics 100-gm into game data for combining into game data and rules 100-dr. Data and rules 100-dr are usable with a game app 200-15 that provides game mechanics and rules processing as well as game app 200-1 that provides situational advice/help, such that the combination of game apps 200-15 and 200-1 provides for customized game information and virtual augmentations synchronized with, and situationally relevant to, each player's physical game play experiences, where the game information and augmentations are provided via one or more computing devices such as tablet 15, smartphone 17, or AR glasses 50. The flow chart depicts an exemplary sequence of game mechanics 100-1 through 100-19 for conducting a typical physical card game, where each of the physical game mechanics are associated with game devices and apps 100-da, including specialized game devices 200-3 through 200-13 for sensing and transforming the mechanics into electronic signals in order to create mechanics data for providing to the game app 200-15. Game app 200-15 further processes the game mechanics data into game data such as a current game state 300-15 and player and card playmetrics 300-16. Additional game apps include automatic opponent app 200-16 and stream live game app 200-21, where the apps 200-1, 200-16, 200-21 preferably interface with mechanics and rules processor game app 200-15. Card manufacturer 400-1 and marketplace assessments 400-3 provide game related data combined as MFG and marketplace card data 300-2 for use by situational adviser/help app 200-1 when advising a player. Manufacturer 400-1 provides game rules 300-3 for use by mechanics and rules processor game app 200-15 in order to determine played card(s) results in on-going game-play 101 mechanics step 100-15. Advisor app 200-1 also has access to player profile & motivation data 300-4 for use in tailoring advice and help to a player. All games apps have access to advertising data 300-5 for connecting advertisers with real-time play.

FIG. 5B is a flowchart of process steps for determining digital game state information related to devices for detecting the play mechanic of placing game cards into detectable sleeves 200-3, where the result of the process steps is to update the available card information and current game state in step 200-3-9.

FIG. 5C is a flowchart of process steps for determining digital game state information related to devices for detecting the play mechanic of adding cards into a current player hand 200-7, where the result of the process steps is to update the current game state with card-in-hand information in step 200-7-3.

FIG. 5D is a flowchart of process steps for determining digital game state information related to devices for detecting the play mechanic of laying down a game card onto a playing surface 200-9, where the result of the process steps is to update the current game state with card-in-play information in step 200-9-19.

FIG. 5E is a flowchart of process steps for determining digital game state information related to devices for detecting moving or turning of card(s) on a playing surface 200-11, where the result of the process steps is to update the current game state with cards moved or turned information in step 200-11-11.

FIG. 5F is a flowchart of process steps for determining digital game state information related to devices for detecting the touching of one card to another to “join” cards 200-13, where the result of the process steps is to update the current game state with cards joined information in step 200-11-13.

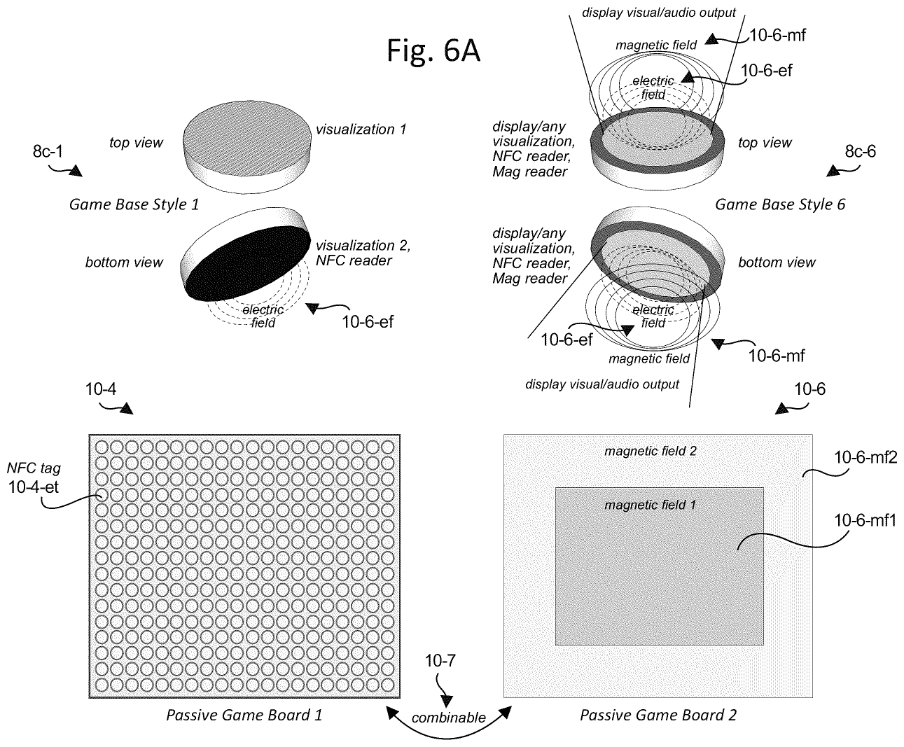

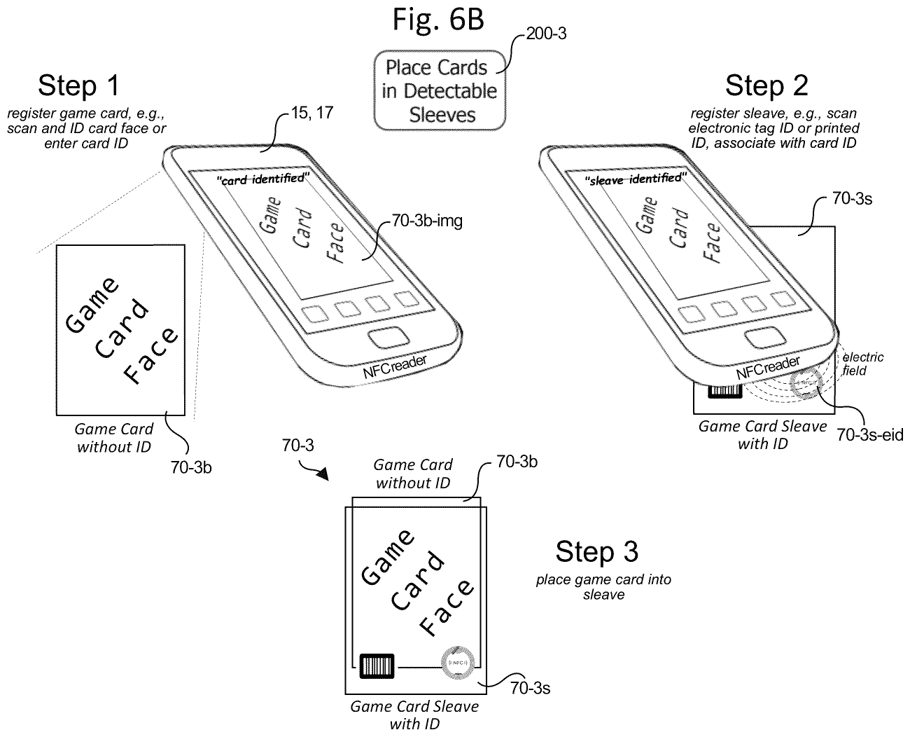

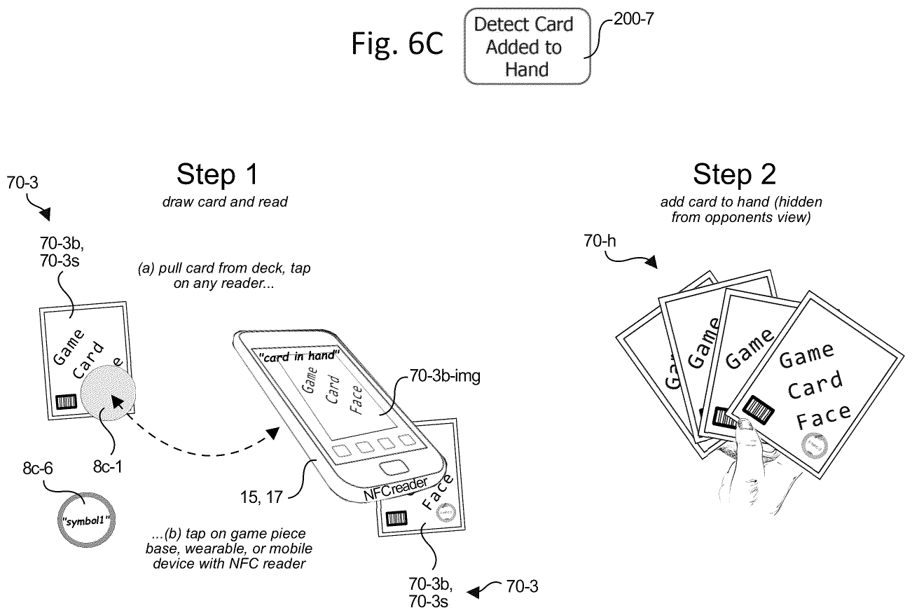

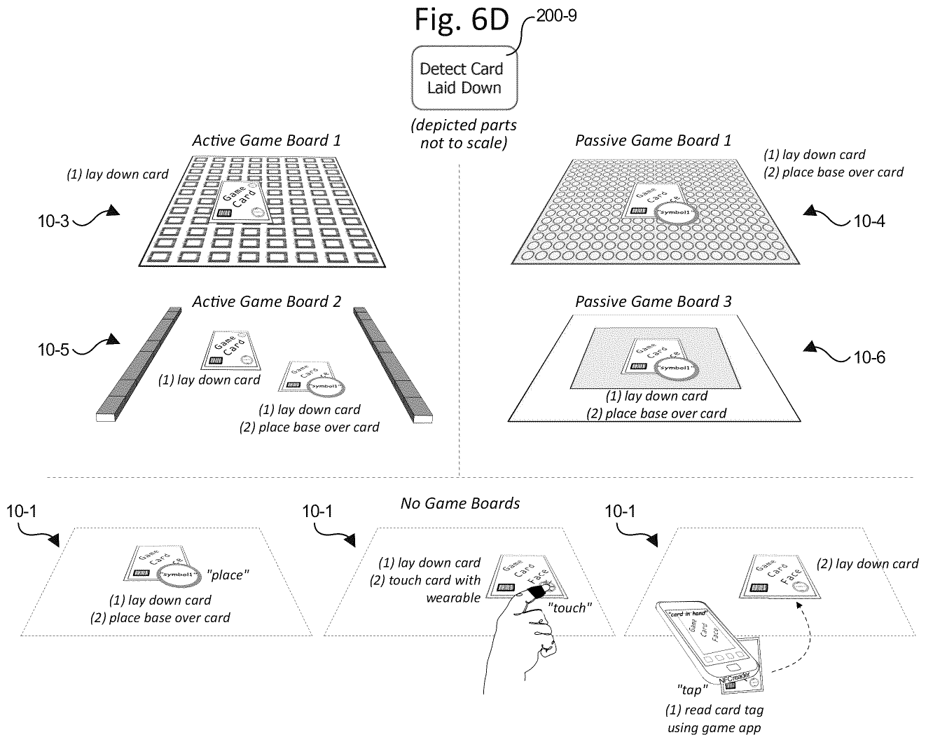

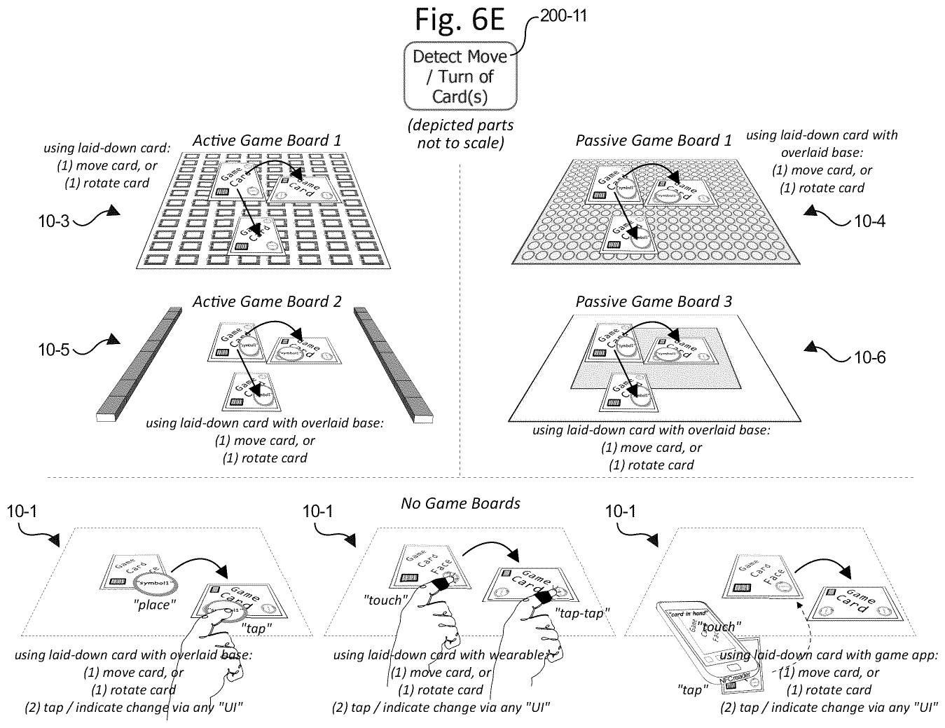

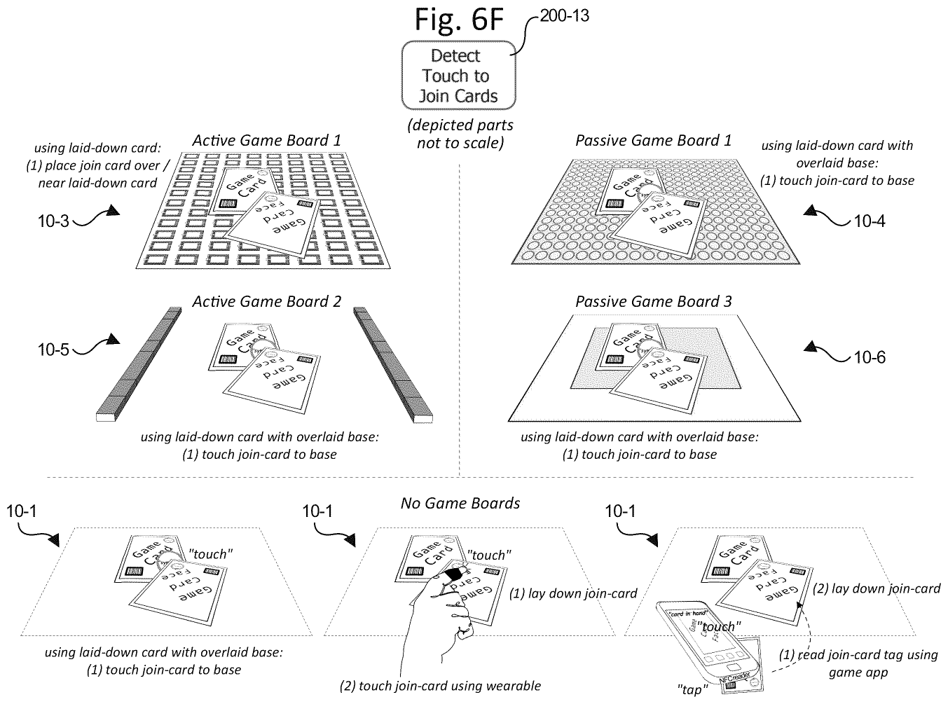

FIG. 6A depicts in the upper left a game piece base configuration 8c-1 that at least comprises an electronic tag reader using an emitted electronic field 10-6-ef for detecting electronic tags 10-4-et comprising a “passive game board 1” 10-4 as depicted in the lower left, and in the upper right a game piece base configuration 8c-6 that additionally comprises a magnetic field 10-6-mf reader for use in detecting the proximity or contact with a “passive game board 2” 10-6 comprising one or more sections for generating a magnetic field such as 10-6-mf1 or 10-6-mf2 of a certain field strength.

FIG. 6B depicts a series of three physical steps related to the devices for detecting the play mechanic 200-3 of placing game cards into detectable sleeves, wherein the steps comprise using a computing device such as a tablet 15 (not depicted) or a smartphone 17 (depicted,) in order to process the insertion of a game card 70-3b into a game card sleeve 70-3s to form the combination playable game card 70-3.

FIG. 6C depicts a series of two physical steps related to the devices for detecting the play mechanic 200-7 of adding a playable game card into a player's current “hand” 7-h, wherein the steps comprise using a computing device such as a tablet 15 (not depicted) or a smartphone 17 (depicted,) or otherwise a device such as a game piece base 8c or wearable 9c in communication with computing device 15 or 17, for example a game piece configuration “1” 8c-1 or a game piece configuration “6” 8c-6, in order to process the insertion of a playable game card 70-3 into a player's current hand 8-h comprising zero or more playable cards 70-3.

FIG. 6D depicts three variations of a physical step related to the devices for detecting the play mechanic 200-9 of placing a playable game card 70-3 (for example taken from hand 70-h) onto a playing surface to be a laid down (“played”) card 70-3, wherein the variations comprise (1) using any of an active game board 10-3 or 10-5 wherein the laying down of playable card 70-3 is automatically detected by the active game board 10-3 or 10-5, (2) using any of a passive game board 10-4 or 10-6 wherein the laying down of playable card 70-3 is not automatically detected by the passive game board 10-4 or 10-6 but thereafter detected by the use of a game piece base 8c or wearable 9c placed substantially over the playable card 70-3, or (3) not using a game board but rather any playing surface 10-1 wherein the laying down of playable card 70-3 is not automatically detected by the playing surface 10-1, but before or thereafter detecting by the use of either a mobile computing device such as 15, 17, a game piece base 8c, or wearable 9c placed substantially over the playable card 70-3 in order to detect the ID of the card 70-3 to be placed, or having been placed, onto the playing surface 10-1.

FIG. 6E depicts three variations of a physical step related to the devices for detecting the play mechanic 200-11 of moving or turning a played game card 70-3 that is substantially resting upon a playing surface, wherein the variations comprise (1) using any of an active game board 10-3 or 10-5 wherein the move or turn of the playable card 70-3 is automatically detected by the active game board 10-3 or 10-5, (2) using any of a passive game board 10-4 or 10-6 wherein the move or turn of the playable card 70-3 is automatically detected by the passive game board 10-4 or 10-6 operating in combination with a game piece base 8c, or wearable 9c placed substantially in contact with the playable card 70-3, or (3) not using a game board but rather any playing surface 10-1 wherein the move or turn of the playable card 70-3 is not automatically detected by the playing surface 10-1 but before or thereafter detected by the use of either a mobile computing device such as 15, 17, a game piece base 8c, or wearable 9c placed substantially over the playable card 70-3 in order to detect the ID of at least the card 70-3 to be moved/turned or having been moved/turned on the playing surface 10-1.

FIG. 6F depicts three variations of a physical step related to the devices for detecting the play mechanic 200-13 of “joining” a second playable game card 70-3 with a laid-down first playable game card 70-3 so as to associate the second “join-card” with the first “played-card,” wherein the variations comprise (1) using any of an active game board 10-3 or 10-5 wherein the joining of the second playable card 70-3 is automatically detected by the active game board 10-3 or 10-5 as the second card is placed sufficiently over or near the first card on the active game board 10-3 or 10-5, (2) using any of a passive game board 10-4 or 10-6 wherein the joining of the second playable card 70-3 is not automatically detected by the passive game board 10-4 or 10-6 but thereafter detected by the use of a game piece base 8c, wearable 9c, or game app 200-15 running on a computing device such as 17 or 15, any of which are placed within a sufficient proximity of both the first and second playable cards, either simultaneously or sequentially, or (3) not using a game board but rather any playing surface 10-1 wherein the joining of the second playable card 70-3 is not automatically detected by the playing surface 10-1 but before or thereafter detected by the use of either a game piece base 8c, wearable 9c, or game app 200-15 running on a computing device such as 17 or 15, any of which are placed within a sufficient proximity of both the first and second playable cards, either simultaneously or sequentially.

In the following description, numerous specific details are set forth, such as examples of specific components, types of usage scenarios, etc. in order to provide a thorough understanding of the present disclosure. It will be apparent, however, to one skilled in the art that the present disclosure may be practiced without these specific details and with alternative implementations, some of which are also described herein. In other instances, well known components or methods have not been described in detail in order to avoid unnecessarily obscuring the present disclosure. Thus, the specific details set forth are merely exemplary. The specific details may be varied from and still be contemplated to be within the spirit and scope of the present disclosure.

### DETAILED DESCRIPTION OF THE INVENTION

Referring to FIGS. 1A and 1B, there is shown a direct copy of FIGS. 9A and 9B as found in the PRIOR U.S. Pat. No. 10,857,450 ART cross-referenced entitled PHYSICAL-VIRTUAL GAME BOARD AND CONTENT DELIVERY PLATFORM filed on Aug. 9, 2019. The reader is directed to the PRIOR ART for a full understanding of the teachings in relation to the present FIGS. 1A and 1B.

The following quoted descriptions are provided as directly taken from this PRIOR ART FIGS. 9A and 9B to describe what is now herein FIGS. 1A and 1B, respectively. It is noted that the following are excerpts and as such do not repeat the full teachings of the PRIOR ART but rather are meant as a summary for the present figures and should not be considered as a limitation of either the PRIOR ART or the present invention. Also note that—underlined text—has been inserted for clarity.

As first described in relation to the PRIOR ART U.S. Pat. No. 10,857,450 FIG. 9A, and now in relation to present FIG. 1A “there is shown game card with included ID 70-3a, where the included ID is preferably either a printed ID 70-3a-pid such as a bar code, QR code or an alpha-numeric code, or an embedded ID 70-3a-eid such as an NFC tag or an RFID tag. Those familiar with image processing will understand that the printed ID 70-3a-pid can be imaged and decoded using an image processing function preferably included with the game app running for example on a mobile device including a camera such as a tablet 15 or smart phone 17. As discussed herein, game bases such as 8c in any of its various technology stacks (see”—PRIOR ART—“FIGS. 4A, 4B) and forms (see”—PRIOR ART—“FIGS. 5A, 5B, 5C, 5D and 5E) includes an NFC controller capable of reading an imbedded ID 70-3a-eid such as an NFC tag. As also discussed, game bases 8c are also in communications with game app and computing devices such as 15 or 17 such that game card IDs scanned by a game base 8c are then provided to the game app via the communications path such as Bluetooth or RFID. Many mobile devices including cell phones now also include NFC readers and as such are capable of directly reading an embedded ID 70-3a-eid that is for example and NFC tag.”

Furthermore, the PRIOR ART U.S. Pat. No. 10,857,450 describes that “when using game cards that have been produced with included ID 70-3a, it is expected that the game app has access to or includes a dataset of registered game cards 70-3a, such that for example if the game is based upon the popular “Yu-Gi-Oh! Trading Cards” that typically already include identifying printed numbers on one of the surfaces, the game app will already be able to identify any given card 70-3a once it is properly scanned, where identification additionally includes accessing any other set of datum associated with the identified card 70-3a, such as character names, special powers, gear, etc. Also, as will be discussed in greater detail with respect to upcoming”—PRIOR ART—“FIGS. 10A and 10D, a game toy such as magnifying glass 23 preferably also includes both a camera and an NFC reader and therefore can be used to detect and determine either of game card printed ID 70-3a-pid or embedded ID 70-3a-eid, where this for example removes the need for younger children to have access to a smart phone such as 17 for playing with gaming system 2 (or 1.)”

As first described in relation to the PRIOR ART U.S. Pat. No. 10,857,450 FIG. 9B, and now in relation to present FIG. 1B “there is shown game card without ID 70-3b that has been inserted into game card sleeve including ID 70-3s, where the sleeve included IDs are like those of game card 70-3a for example being either a printed ID 70-3s-pid or an embedded ID 70-3s-eid. Whether using a game card with included ID 70-3a or game card without ID 70-3b (that has been inserted into a game card sleeve 70-3s,) it is possible for the game app running on a computing device such as 15 or 17 to identify the game cards using either of image processing or NFC reading. Unlike using game cards with ID 70-3a, when using game cards without ID 70-3b it is necessary to register each card preferably using a function included with the game app running on a computing device such as 15 or 17. In this case, the game app preferably already has a game card list of the possible cards (and therefore also any other set of datum associated with the card as discussed above,) and for example this list includes a card name and image of the card front surface. During registration, a player for example first scans an ID included with a sleeve 70-3s, such as printed ID 70-3s-pid or embedded ID 70-3s-eid, after which the player selects a game card without ID 70-3b from the game card list, thus associating the game card 70-3b with the sleeve 70-3s. Once all game cards 70-3b and associated sleeves 70-3s are registered, either of game cards with ID 70-3a or game cards without ID 70-3b are usable in an active game board-based gaming system 1 (described in the parent patent)”-see different PRIOR ART herein cross-referenced as U.S. Pat. No. 10,688,378 entitled PHYSICAL-VIRTUAL GAME BOARD AND CONTENT DELIVERY SYSTEM filed on Jul. 4, 2018, where U.S. Pat. No. 10,688,378 is the parent patent of PRIOR ART U.S. Pat. No. 10,857,450, and where this parent patent's “copending system 1 game board” is also referred to herein as “active game board 1” 10-3-“or an active game piece gaming system 2 as herein described.”

Furthermore, the PRIOR ART U.S. Pat. No. 10,857,450 describes that “As will also be appreciated by those skilled in the art of image processing, it is possible that an image of either the front or back surface of a game card without an ID 70-3b be used as a unique identifier. In this case, the game app running on a computing device such as 15 or 17 has a pre-known registry of game card front (or back) surface images and uses image processing of a captured image of the card 70-3b to perform feature matching against the pre-known registry surface images, where the feature matching is like facial recognition or other well-known pattern and texture matching algorithms. The result of the comparison uniquely identifies a match (or a short list of possible matches where the card match is then confirmed by the player.) As with game card 70-3a, magnifying glass 23 is also usable for capturing any of game card surface images for registration or game card sleeve IDs 70-3s-pid or 70-3s-eid.”

Referring next to FIGS. 1C and 1D, there is shown a direct copy of FIGS. 9C and 9D as found in the PRIOR ART cross-referenced U.S. Pat. No. 10,857,450 entitled PHYSICAL-VIRTUAL GAME BOARD AND CONTENT DELIVERY PLATFORM filed on Aug. 9, 2019. The reader is directed to the PRIOR ART for a full understanding of the teachings in relation to the present FIGS. 1C and 1D.

The following quoted descriptions are provided as directly taken from this PRIOR ART U.S. Pat. No. 10,857,450 FIGS. 9C and 9D to describe what is now herein FIGS. 1C and 1D, respectively. It is noted that the following are excerpts and as such do not repeat the full teachings of the PRIOR ART but rather are meant as a summary for the present figures and should not be considered as a limitation of either the PRIOR ART or the present invention. It is especially noted that this referenced PRIOR ART U.S. Pat. No. 10,857,450 teaches several variations of what is herein referred to as “passive game board 1” 10-4, for example see the PRIOR ART's FIGS. 1, 2A, 4A, 4B, 6A, 6B, 10D, 11A, and 11B, and as such the reader is cautioned not to limit the understanding of the present “passive game board 1” 10-4 based upon an understanding of the present FIG. 1D and the corresponding descriptions as repeated from the description of PRIOR ART FIG. 9D. Also note that—underlined text—has been inserted for clarity.

As first described in relation to the PRIOR ART U.S. Pat. No. 10,857,450 FIG. 9C, and now in relation to present FIG. 1C “whether using a game card with ID 70-3a that preferably comes with a game that includes a pre-registered list of game cards or using game cards without ID 70-3b that must be identified and registered (preferably using a pre-known list of unregistered game cards,) it is then possible using the present system 2 or copending system 1”-see different PRIOR ART herein also cross-referenced as U.S. Pat. No. 10,688,378 entitled PHYSICAL-VIRTUAL GAME BOARD AND CONTENT DELIVERY SYSTEM filed on Jul. 4, 2018, where “copending system 1 game board” is also referred to herein as “active game board 1” 10-3-“for a player to play these game cards 70-3a or 70-3b onto a game board and overlay such as 10-4 providing additional game card physical/logical location information. In preferred game-play, regardless of using copending system 1 or present system 2, step 1 includes the game app running on a computing device such as 15 or 17 to prompt the player to select the game card such as 70-3a or 70-3b (preferably in sleeve 70-3c) that they wish to play for their turn. In response to the game app prompting, the player then uses a system device for identifying the card as prior discussed, where system devices include a computing device 15 or 17 camera, a computing device 15 or 17 NFC reader, an active game piece base 8c NFC reader, an active game board NFC reader (see 10b variations in copending system 1, copending FIGS. 7 and 8,) or a game toy device such as magnifying glass 23 camera or NFC reader (see present FIGS. 10A and 10D.)”

As first described in relation to the PRIOR ART U.S. Pat. No. 10,857,450 FIG. 9D, and now in relation to present FIG. 1D “once a player has identified the game card such as 70-3a or 70-3b (in sleeve 70-3c) that they intend to play for their turn, in an optional step 2 the player places the game card onto for example the passive game board 10-4”—herein referred to as “passive game board 1” 10-4-“, after which they place an active game piece 8c on top of the played card when using system 2, or a passive game piece 8b on top of the played card when using system 1. When using system 2 as herein described, game piece 8c is then able to detect the physical location where the game card has been played on the passive game board 10-4, as a careful reading and understanding of the present invention will make clear. When using system 1 as described in the parent application, active game board base 10b is then able to detect passive game piece 8b to be located at a specific physical location on the active game board 10, as a careful reading and understanding of the copending invention will make clear. In either case, the determined physical location of the active game piece 8c or passive game piece 8b is then usable by the respective gaming system as a physical location of the played game card 70-3a or 70-3b.”

Furthermore, the PRIOR ART describes that “For many games it will be sufficient and exciting simply to perform step 1 (of FIG. 9C)”—herein FIG. 1C—“such that the gaming system 1 or 2 can cause further actions such as displaying video content on a shared computing device (such as tablet 15) and/or private computing device (such as smart phone 17.) For example, the popular “Yu-Gi-Oh!” game has a companion TV show where the TV characters play their cards that then come to life as an animation. Using the present teachings, after a player selects their card in step 1, a similar animation could then be played via the game app running on a computing device such as 15 or 17. Or, the similar animation could be played on the device 15 or 17 only after a step 2 is performed. Another benefit of including the optional step 2 in a game is that the game functions can then be further adapted to cause for example different questions, clues, assignments, tasks, action control signals, etc. as discussed in the copending application based upon what portion of the game board onto which the game card is played. As will be clear from a careful reading of the present invention, it is also possible to determine a physical location where a game card 70-3a or 70-3b has been played using system devices such as 15, 17 or 23.”

Regarding PRIOR ART U.S. Pat. No. 10,857,450 FIG. 9D (herein FIG. 1D), the PRIOR ART concludes: “And finally, with respect to both game cards 70-3a and game card sleeves 70-3c, the present invention teaches a variation where the card 70-3b or sleeve 70-3c can be detected as being laid down upon the game board either facing up or facing down providing for further game functionality. A preferred apparatus for implementing this feature is the provision of a multi-layer composition including: 1) a “face of the card is facing down” NFC tag; 2) a “backside of the card is facing down” NFC tag, and 3) a shield layer for substantially blocking any interrogation signal attempting to read an NFC tag, where the shield layer is placed such that an NFC tag (1) or (2) is substantially detectable from only one direction such as the up direction or the down direction. As a careful consideration will show, when the top or face of a further adapted active game card or sleeve is placed such that the “face of the card is facing down” upon an active game board capable of detecting NFC tags (such as used with passive game pieces,) then the (1) NFC tag is substantially detectable while the (2) NFC tag is shielded by the shielding layer (3). Conversely, when the bottom or backside of a further adapted game card or game card sleeve is placed such that the “backside of the card is facing down” upon the game board, then the (2) NFC tag is substantially detectable while the (1) NFC tag is shielded by the shielding layer (3). Thus, an active game board detects only one of the “face-down” or “backside-down” NFC tags such that the game app receives this indication allowing for different “face-down” vs. “backside-down” game responses. If the game board base is passive, then an active game piece placed on top of a further adapted game card or sleeve will detect the NFC tags oppositely from the just described active game board detection, wherein the game app considers this reversal before responding.”

Referring next to FIG. 1E, there is shown a direct copy of FIGS. 8 as found in the PRIOR ART cross-referenced U.S. Pat. No. 10,688,378 entitled PHYSICAL-VIRTUAL GAME BOARD AND CONTENT DELIVERY SYSTEM filed on Jul. 4, 2018. The reader is directed to the PRIOR ART for a full understanding of the teachings in relation to the present FIG. 1E.

The following quoted descriptions are provided as directly taken from this PRIOR ART U.S. Pat. No. 10,688,378 FIGS. 8 to describe what is now herein FIG. 1E. It is noted that the following are excerpts and as such do not repeat the full teachings of the PRIOR ART but rather are meant as a summary for the present figures and should not be considered as a limitation of either the PRIOR ART or the present invention. It is especially noted that this referenced PRIOR ART U.S. Pat. No. 10,688,378 teaches several variations of what is herein referred to as “active game board 1” 10-3, for example see the PRIOR ART's FIGS. 1, 5, 6, and 7, and as such the reader is cautioned not to limit the understanding of the present “active game board 1” 10-3 based upon an understanding of the single present FIG. 1E and its description as repeated from the descriptions of the PRIOR ART FIG. 8. Also note that—underlined text—has been inserted for clarity.

As first described in relation to the PRIOR ART U.S. Pat. No. 10,688,378 FIG. 8, and now in relation to present FIG. 1E, “there is shown an alternative game board 10-3 and game board overlay 11-3 that employs one or more NFC readers shared to read two or more antennas, where the individual addressable antennas represent the physical locations, such as 10-3c1, 10-3c2 and 10-3cn, and where game piece bases 8b-3 are implemented using NFC tags. Game board 10-3 preferably comprises a computing element 103-a comprising a microcontroller to control all internal electronic parts and to communicate with the game app running on the shared computing device 15, where communication means preferably include either or both of a wire means such as USB interface 10-3d1 or a wireless interface such as Bluetooth interface 10-3d2. The microcontroller of computing element 10-3a preferably controls one or more NFC readers, connecting each NFC reader to one or more antenna such as 10-3c1, 10-3c2 and 10-3cn using a multiplexer. The multiplicity of antennas forms a regular matrix of physical locations at the surface of the game board 10-3 that interfaces with the game board overlay 11-3. As is well known in the art, a controlled by NFC reader 10-3a connected to an antenna is capable of remote coupling and reading information from an NFC tag. It is preferred that each game piece base 8b-3 comprise at least one NFC tag such that as the piece base 8b-3 in placed over and upon a marked logical location such as 11-3Ln as demarcated on board overlay 11-3, the NFC tag comes into the proximity of an antenna such as 10-3cn. It is also preferred that microcontroller-multiplexer and NFC reader 10-3a regularly scans the matrix of antennas such as 10-3c1, 10-3c2 and 10-3cn to determine if any NFC tags such as for example comprised within game base 8b-3 are currently detectable in the proximity of any given antenna situated over potential logical game overlay locations, such as 10-3c2 and 10-3cn.”

It is noted, and the reader is so advised, that the PRIOR ART U.S. Pat. No. 10,688,378 includes three additional paragraphs of description following the above paragraph that are also directly in relation to the PRIOR ART FIG. 8, where these three additional paragraphs are not copied from the PRIOR ART for the sake of brevity and clarity, but are non-the-less important to a full understanding of the PRIOR ART and thus also the teachings of the present application.

It is also noted for clarity, that in the preceding quoted specification taken directly from PRIOR ART U.S. Pat. No. 10,857,450 entitled PHYSICAL-VIRTUAL GAME BOARD AND CONTENT DELIVERY PLATFORM filed on Aug. 9, 2019, there are references to “gaming system 1” and “gaming system 2.”

“Gaming system 1” is taught in U.S. Pat. No. 10,688,378 entitled PHYSICAL-VIRTUAL GAME BOARD AND CONTENT DELIVERY SYSTEM filed on Jul. 4, 2018, where U.S. Pat. No. 10,688,378 is the source for the present FIG. 1E. “Gaming system 1” teaches what the PRIOR ART referred to as an “active game board” “10-3” which is herein referred to as “active game board 1” “10-3” because a second variation referred to as “active game board 2” “10-5” is also now taught in the present specification.

“Gaming system 2” is taught in U.S. Pat. No. 11,025,892 entitled SYSTEM AND METHOD FOR SIMULTANEOUSLY PROVIDING PUBLIC AND PRIVATE MESSAGES filed on Apr. 4, 2019, where U.S. Pat. No. 11,025,892 is the source for the present FIGS. 1A, 1B, 1C, 1D, and 2A. “Gaming system 2” teaches what the PRIOR ART referred to as an “passive game board” “10-4” which is herein referred to as “passive game board 1” “10-4” because a second variation referred to as “passive game board 2” “10-6” is also now taught in the present specification. “Gaming system 2” U.S. Pat. No. 11,025,892 is a continuation-in-part of the parent “Gaming system 1” U.S. Pat. No. 10,688,378, and both are still co-pending as divisional applications.

Referring next to FIG. 2A, there is shown direct copies of portions of FIGS. 1 and 2B as found in the PRIOR U.S. Pat. No. 10,857,450 ART cross-referenced entitled PHYSICAL-VIRTUAL GAME BOARD AND CONTENT DELIVERY PLATFORM filed on Aug. 9, 2019. The reader is directed to the PRIOR ART for a full understanding of the teachings in relation to the present FIG. 2A.

The following quoted descriptions are provided as directly taken from this PRIOR ART FIGS. 1 and 2B to describe what is now herein FIG. 2A. It is noted that the following are excerpts and as such do not repeat the full teachings of the PRIOR ART but rather are meant as a summary for the present figures and should not be considered as a limitation of either the PRIOR ART or the present invention. Also note that—underlined text—has been inserted for clarity.

As first described in relation to the PRIOR ART U.S. Pat. No. 10,857,450 FIG. 1, and now in relation to present FIG. 2A “is a perspective drawing of”—select components of—“a physical-virtual game board and content delivery system 2 that is an alternative to the physical-virtual game board and content delivery system 1 as described in the parent application. Like the co-pending system 1, system 2 comprises a game app running on a computing device, such as a tablet or notebook 15 (not depicted) or a smart phone 17 (depicted.) Also, like system 1, game app and computing device are in communications preferably with a remote system for providing game apps and game related datum and for receiving game related datum, for example comprising any one of, or any combination of a global environment eco-system 40 or local environment eco-system 30, where the communications are preferably conducted over the internet through a router, all as was prior taught.”

It is noted that FIG. 1 of PRIOR ART U.S. Pat. No. 10,857,450 includes significant additional description beyond that copied and provided above, including with respect to the herein also depicted “game piece base” 8c with attachable “figurine 8a” that is mentioned in relation to PRIOR ART FIG. 1 as “a game piece such as 8c-1 fitted with figurine 8a,” where it is herein noted for clarity that PRIOR ART “8c-1” is referring to a first instance of a defined “active game piece base” 8c. This active game piece base 8c has extensive teachings in the PRIOR ART U.S. Pat. No. 10,857,450, where the reader is especially directed to PRIOR ART U.S. Pat. No. 10,857,450 FIGS. 1, 2B, 4A, 4B, 5A, 5B, 5C, 5D, 5E, 6A, 6B, 11A, and 11B, as well as FIGS. 9A, 9B, 9C, and 9D (referred to herein as 1A, 1B, 1C, and 1D). Active game piece base 8C as first taught in the PRIOR ART U.S. Pat. No. 10,857,450 is further adapted by the present teachings and the reader is especially directed to the present invention's FIGS. 3A, 3B, 3C, 3F, 3G, 3H, and 4 for additional discussion of these herein taught further adaptations to the PRIOR ART active game piece base 8C.

Still referring to present FIG. 2A, and now specifically the depiction of game piece base 8c that is taken directly from FIG. 2B of the PRIOR ART U.S. Pat. No. 10,857,450, the PRIOR ART teaches “there is shown a top and bottom view of a game piece 8c, where the bottom view depicts an arrangement for providing both a sensing area for the preferred NFC reader and contact area for providing a material useful for causing the game piece 8c to adhere to a vertically oriented game board 10-4 and overlay 11-4, where for example the game board 10-4 and overlay 11-4 have been affixed to a refrigerator (see“—PRIOR ART—”FIG. 2C.) There are many possible materials for providing adhesion such as magnets sticky substances or Velcro. For the metal surfaces such as a refrigerator, the magnetic materials are preferred. What is important is that the either a passive game piece base (such as copending 8b) or an active game piece 8c, in any of its various implementations or forms (see FIGS. 5A, 5B, 50, 5D and 5E,) including or not including an attached figurine such as 8a (see FIG. 1,) can work with a vertically oriented active game board 10 from co-pending system 1 or vertically oriented passive game board 10-4 as presently described.”

Referring next to FIG. 2B, game piece base 8c is shown in a wearable configuration such as fingertip reader 9c. The wearable configuration of a game piece base 8c shares at least some components with a game piece base 8c (for a list of these game piece base 8c components, see especially upcoming FIG. 4,) while then also having a fundamental difference in that wearable reader 9c does not remain upon a game board surface such as 10-3, 10-4, 10-5, 10-6, a non-gameboard playing surface 10-1 (see especially upcoming FIGS. 6D and 6E,) or a game card 70-3, where remaining upon a gameboard or game card is an accepted convention for visually representing game state to the game-players. However, with card-play more so than game board play (that typically requires the remaining placement and movement of a physical game piece as a means of game state cuing and/or tracking for the player(s),) which is then the basis for further adaptation into a game piece base 8c with optional figurine 8a, playing cards themselves serve as visual cues to the players.

Thus, a game base 8c further adapted to be a wearable 9c especially for use primarily in card game-play (as opposed to board game-play or combined board game with cards play) provides at least the functions of next card 70-3 ID gathering during any one or more next card-play mechanics, even if the wearable 9c then after gathering this ID information does not remain in direct visual association with this “next” card 70-3. Examples of game state (including “next”/“current” card ID) detection for card-play mechanics that can be fully or at least partially addressed using a wearable 9c include (but are not limited to,) 1) placing a card without ID 70-3b into a sleeve with ID 70-3s (see FIG. 6B,) 2) placing an available game-play card 70-3 into a current hand 70-h (see FIG. 6C,) 3) placing a card 70-3 in-hand to be laid down on a game board or playing surface (see FIG. 6D,) or 4) laying down a second card 70-3 in spatial juxtaposition with a first laid down card 70-3 as a means of association or “joining” (see FIG. 6E). (It is noted that while these upcoming figures do not depict the use of wearable 9c for determining this “next” card ID but rather show the use of a mobile device 15, 17, a game base 8c, or an active game board 10-3, 10-5, a careful consideration will show that wearable 9c is sufficient for use at least in these card-play mechanics.)

Still referring to FIG. 2B, a careful consideration will also show that use of a wearable 9c provides for a single-use apparatus in the tracking of at least card game game state, thus reducing the physical cost for card game game state determination, this as opposed to having multiple game piece bases each of which might then remain “in the visual field-of-view” spatially related to any/each of a “next” card. Wearable 9c and game piece bases 8c-1, 8c-2, 8c-3, 8c-4, 8c-5, 8c-6, 8c-7, 8c-8, 8c-9, and 8c-10 (see FIG. 4) all comprise necessary processor/power 8c-prc means for device functioning, global data wireless communication port 8c-Gcom means for at least communicating with a game app (or equivalent) as is being operated on a computing device such as 15 or 17, and optionally comprise means for visual output 8c-vo (such as 9c-led on wearable 9c) and/or means for audible output (8c-ao). Wearable 9c preferably includes tactile output means (not depicted) for providing game-play feedback, where tactile/“haptic”/vibrational output means are well-known in the art even including some form of a mild electric shock and are often used for example in wearable gaming gloves or clothing, where any of wearable 9c (or game piece base 8c) sensory feedback, including visual, audio, or tactile, for example may serve as prompting or confirmation in virtually any play mechanic step 100-3 through 100-1 (see upcoming FIG. 5A).

Wearable 9c, and all game piece bases except 8c-8, further include at least one tag reader 8c-tagR that is preferably an NFC tag reader using at least one antenna 8c-ant and possibly an antenna switch 8c-asw for use with multiple antenna 8c-ant, where also each playable game card 70-3 comprises at least one NFC tag for at least providing card identification (“ID”) such that by simply touching a playable game card 70-3 with a wearable or any game piece base except 8c-8, it is possible to determine at least the ID of the touched card 70-3.

The referenced PRIOR ART U.S. Pat. Nos. 10,688,378 and 10,857,450 each taught means for providing “secret messages” including any of video or audio to the game-players, where the present application further provides for “secret messages”/“private feedback” that is accomplished using tactile/haptic feedback, either in association with a wearable 9c or a further adapted game piece 8c. For example, when a player is holding one or more playing cards in their hand 70-h (see FIGS. 3K and 6C,) or has played/laid down one or more cards on the playing surface (see FIGS. 6D and 6E,) by touching any of the one or more cards with wearable 9c such that the wearable 9c then identifies the touched game card for communication to the game app, the game app may then communicate back to the wearable 9c signals for at least in part causing a tactile/haptic vibrational feedback to the player, where this tactile feedback may be substantially private to the player and can convey many different types of information.

In another anticipated adaptation, wearable 9c or game piece base 8c further includes electronic means for providing a device ID, such an electronic tag that is preferably the same type of tag used for conveying the ID of a playing card, such as an NFC tag, such that any two game-play devices including a mobile device 15, 17, a game piece base 8c, a wearable 9c, or an active game board 10-3 or 10-5 can be used to determine the ID of a wearable 9c or game piece base 8c, and thus in so doing also determine the identity of the game-player associated with the wearable 9c or base 8c. In one anticipated use, two opposing players touch their wearables 9c, for example by touching their fingertips comprising the wearables 9c, where after each player's wearable 9c preferably read the other player's wearable 9c ID for communication to the game app, whereafter some result is determined by the game app including any of a change to the game state and/or a presentation of a visible, audible, tactile, or otherwise perceivable output achievable by any of the game devices anticipated herein or in the referenced PRIOR ART (including changes to an interactive wearable such as a necklace or active glasses, see U.S. Pat. No. 10,688,378, or changes to the state of an active figurine, see U.S. Pat. No. 10,857,450).

With respect to the new use of at least a fingertip wearable 9c in relation to an interactive board game (such as the interactive board games as first taught in the referenced PRIOR ART,) and in particular the use in relation to a logical location 11-3Ln on a mapped game overlay 11-3 (see herein FIG. 3I as well as the PRIOR ART of U.S. Pat. Nos. 10,688,378 and 10,857,450,) as a careful consideration will show, whether using an active game board such as 10-3 or 10-5, or a passive game board such as 10-4 or 10-5, it is possible to determine both the ID of a player touching the logical location 11-3Ln using a wearable 9c, as well as the identity of the logical location 11-3Ln being currently touched, where then this information is also then usable by the game app for at least in part also causing any of a change to the game state and/or a presentation of a visible, audible, tactile, or otherwise perceivable output achievable by any of the game devices anticipated herein or in the referenced PRIOR ART (including changes to an interactive wearable such as a necklace or active glasses, see U.S. Pat. No. 10,688,378, or changes to the state of an active figurine, see U.S. Pat. No. 10,857,450).

Although wearable 9c is depicted for use on the end of the player's pointer-finger, as will be clear to those familiar with wearables, many alternatives are possible including the use of 9c adapted for any of the fingers tips or thumb tip, or otherwise a ring, watch, or even a necklace as depicted in the PRIOR ART U.S. Pat. No. 10,688,378,) where what is preferred is easy physical motions for touching at least a playable game card 70-3 to the wearable 9c, or conversely the wearable 9c to the card 70-3. And finally, there is no restriction as to the number of concurrent wearables 9c a player might be using at any point in time during a game, where for example a player has a wearable 9c on each of their two left- and right-hand pointer fingers. In this two-finger use case, the player may than touch any two ID readable “game portions” at substantially the same time, where “game portions” include physical game board locations mapped to logical overlay locations 11-3Ln (see especially the referenced PRIOR ART,) playable game cards 70-3, game piece bases 8c, figurines 8a with electronic tags, other wearables such as 9c, where substantially touching any combination of two such game portions is interpretable by the game app for any of the anticipated purposes herein including changing the game state (such as “joining” a second card 70-3 to a first card 70-3) or associating an overlay logical game location with a game card 70-3.

Referring next to FIG. 3A, there is shown on the left a perspective view of a game piece base 8c along with an optional game piece decoration 8c-dec, where decorations 8c-dec are attachable to either or both the “top” or “bottom” of a game piece base 8c. Decorations 8c-dec are preferably passive and similar to collectable “pogs” or “slammers,” which are well-known in the art of children's toys. The preferred decoration 8c-dec is also substantially non-interfering (such as cardboard) to any of the electrical or magnetic fields (see FIG. 6A for a visualization) associated for example with NFC reader 8c-tagR and antenna 8c-ant or relative orientation sensor 8c-ros, respectively. Those familiar with game-play will understand the many gaming uses for decorations 8c-dec, where it is also possible for the decoration 8c-dec to comprise means for identification such as a visual marking/bar code that for example is read by a mobile device 15, 17 using the game app, or even an electronic tag such as an NFC tag, where then using the identification means the decoration 8c-dec can become directly sensed by an active component of the interactive gaming system for use in automatic game state updating. There are many possible and well-known solutions for attaching a decoration 8c-dec to a game piece base 8c, such as but not limited to magnetization, a sticky substance, “Velcro” or similar material, or a mechanical solution such as indentations or shaped features on either or both the base 8c and the decoration 8c-dec.

Still referring to FIG. 3A, there is also depicted on the right a block diagram for a set of components for use in game piece base 8c, where many variations of base 8c are possible based upon different combinations of these components (see especially upcoming FIG. 4). Preferred minimum components include processor/power 8c-prc, global data communication port 8c-Gcom, tag reader 8c-tagR, and one or more antenna 8c-ant, where multiple antenna are then controlled by optional antenna switch 8c-asw. Each of these components are well-known in the art, where newer versions of each component, such as processor/power 8c-prc, are anticipated as the underlying various technologies continue to advance, and as such the present invention should not be limited to a particular technology or marketplace solution with the understanding that lower-power and smaller form-factor are preferred. As will also be understood by those familiar with electronics and especially “internet-of-things” electronics, multiple of these components may be combined into a single integrated device/component, where for example processor/power 8c is combined with global data communication port 8c-Gcom, and as such the component description should be considered as a description of features and functions rather than necessarily a description of distinct physical parts.

Currently, the preferred global data communication port 8c-Gcom implements a version of Bluetooth technology, where at least some Bluetooth technology is both low cost and low power and has “native” support in mobile computing devices such as tablets 15 and smartphone 17, but otherwise most computing devices in general. However, wi-fi communications are also possible and newer technologies are currently being demonstrated in research centers such as in the University of California, SanDiego, where Professor Dinesh Bharadia and his team are demonstrating a Wi-Fi radio that is “smaller than a grain of rice,” uses “5,000 times less power than today's Wi-Fi radios” (“just 28 microwatts of power”) and transmits “at a rate of 2 megabits per second” (sufficient for the anticipated uses of a game piece base 8c). Professor Bharadia anticipates that when operated with a coin cell battery, this communications means could “last for years.” Local positioning system (LPS) are already well-known in the art for tracking the location of a Bluetooth or Wi-Fi device, such that global data comm component port 8c-Gcom is also usable for determining the location of the game piece base 8c to a certain accuracy based upon the techniques implemented (see upcoming FIG. 3I).

Electronic tags 8c-tag are preferably but not limited to NFC tags (e.g., as opposed to RFID tags,) primarily because NFC typically requires less power, works over shorter distances, and has “native” support in mobile computing devices such as tablets 15 and smartphones 17. Tag reader 8c-tagR uses a technology matched to the type of electronic tag, and as such NFC tag readers are preferred. Both NFC tags and tag readers are well-known in the art and anticipated by the PRIOR ART for use in a game piece base 8c. It is also possible to include in base 8c a multiplexer/antenna switch that allows the NFC reader to alternatively read from two or more antenna located within the base 8c (or wearable 9c,) for example in consideration of base 8c where one antenna is oriented “down” and the other “up,” thus allowing the base 8c to read two NFC tags substantially simultaneously. In one use case, a first playable game card 70-3 is laid down on the playing surface, a base 8c is placed over the first laid down card 70-3 such that the first card is readable with the down-oriented NFC antenna, and then a second joined card 70-3 is tapped onto the top surface of the base 8c such that the second card is readable with the up-oriented NFC antenna. A careful consideration will show that any two “game portions” with ID's may be substantially simultaneously read in a similar manner.

Still referring to FIG. 3A, absolute orientation sensors 8c-aos are also well-known in the art, where such sensors are sometimes also referred to as “9-DoF” (nine degrees of freedom) sensors and typically include the combination of an accelerometer, a gyroscope, and a magnetometer whose individual datasets are then synthesized into a “3D space orientation.” (The interested reader is directed to, for example, the Adafruit BNO055 Absolute Orientation Sensor for more information.) What is important to see is that using sensor 8c-aos within game base 8c allows for many advantages including determining if the base 8c is oriented “top-up” or “top-down” (where “top” vs. “bottom” is a designation dependent upon the implementation of the base 8c). Furthermore, orientation sensor 8c-aos allows the base 8c to also determine its current “rotational” angle with respect to the earth's magnetic field, which then can be calibrated so as to be with respect to, for example, the playing surface. In either case, whether further calibrated to the playing surface so as to determine an absolute orientation, or not calibrated and thus providing only a relative orientation change, a change in game piece base 8c orientation can be interpreted as a game mechanic and thus have game-play meaning for updating the current game state.

In one example, when playing the card game Magic the Gathering, a card 70-3 is laid down on the playing surface with a “vertical” alignment with respect to the positioning of the card-player and their opponent. If the game piece base 8c comprising absolute orientation sensor 8c-aos is then placed upon the card 70-3 it is possible to read the card 70-3's ID from the associated NFC tag. In the Magic the Gathering game, it is also then possible that the player rotates the orientation of the laid down card 70-3, for example from the original “vertical” orientation to a substantially orthogonal “horizontal” orientation, where during the rotation of the card 70-3 the game piece base 8c may then at least sense a relative change in orientation (again at least with respect to the earth's magnetic field,) where this relative change in orientation is usable for determining that the laid down card 70-3 has been rotated by the player thus changing the game state, all as will be understood by those familiar with Magic the Gathering.

Still referring to FIG. 3A, it is also possible to determine game state meaning differentiated by a game piece base 8c being oriented “up” versus “down,” where preferably the base 8c comprises means for visually indicating the top versus bottom of the base such that players are able to visually perceive the current game piece based 8c relative orientation while the game base 8c also automatically/electronically determines its own relative orientation, for example using the absolute orientation sensor 8c-aos, or the relative orientation sensor 8c-ros to be described shortly. It is noted that for example the “top” of a game piece base 8c comprises a distinct game piece decoration 8c-dec or is otherwise without decoration visually distinct (such as through colorization) from the bottom of the base 8c. Game piece bases may also comprise visual outputs 8c-vo, for example using any suitable display technology including OLED, LCD, or electrophoretic (“e-ink”,) where then this display technology is usable to indicate for example the “top” vs. “bottom” of a particular game piece base 8c. (It is also noted that a game piece base 8c also optionally comprises audio output component 8c-ao, and that any arrangement of visual output 8c-vo and/or audio output 8c-ao may be comprised as a detachable “topper”-see upcoming FIG. 3B.)

Those familiar with visual output technologies will also appreciate that touch sensitive layers may be added in order to create a “touch user interface” 8c-ui, where the touch UI 8c-ui may additionally or alternately comprise any technology implemented for detecting a player-touch, including for example physically actuated buttons. Game piece base 8c user interface 8c-ui provides means for accepting player input/commands in combination with determining the relationship of the base 8c with any one or more of 1) a game board (either active such as 10-3 or 10-5 or passive such as 10-4 or 10-6) comprising a multiplicity of “physical locations,” 2) a “logical location” represented on a overlay 11-3 (see the cross-referenced PRIOR ART) mapped in relation to the determined “physical location,” 3) a figurine 8a, 4) another game piece base 8c or wearable 9c, 5) a playable game card 70-3, or 6) a game computing device such as a tablet 17 or smartphone 15, where then complex game-play mechanics, interactions, etc., are determinable and actionable for causing game responses.

Still referring to FIG. 3A, relative orientation sensor 8c-ros fundamentally works in response to a local magnetic field 10-6-mf that is preferably a static (i.e., unchanging) magnetic field, for example as provided by a magnetic mat (see especially upcoming FIG. 6A, “passive game board 2” 10-6). Sensors for detecting the presence of a local magnetic field 10-6-mf are well known in the art and include what are referred to as “reed switches” as well as “hall effect sensors.” For the purposes of the present invention, while both the reed switch and hall effect sensor are sufficient for implementing relative orientation sensor 8c-ros in combination with a local magnetic field 10-6-mf provided preferably by a game board or card-playing surface comprising a magnetic material emitting a static magnetic field 10-6-mf, the reed switch simply detects the presence of the magnetic field 10-6-mf and responds in an “on/off”/“yes/no”/“open/closed” bi-state manner, whereas it is possible with the hall effect sensor to determine at least a relative magnitude of the magnetic field 10-6-mf and thus when used with a game board/card-playing surface implementing at least two distinguishable playing areas, each with different strength magnetic fields (such as 10-6-mf1 and 10-6-mf1 shown in FIG. 6A,) the hall effect based relative orientation sensor 8c-ros is able to differentiate between these at least two areas (again, see FIG. 6A).

Regardless of the type of magnetic sensor used, it is possible to detect a game piece being oriented “up” versus “down” using one or more sensors 8c-ros. The “top”/“upper side” of a game piece base may be determined based upon the inner arrangement of the included components, e.g., the game piece base 8c includes a single antenna 8c-ant meant to sense an NFC tag for example comprised within a passive game board 1 10-4 (see FIG. 1D) or to sense an NFC tag comprised within a playable game card 70-3 (see FIGS. 1A, 1B, 1C, and 1D). In this use case, it is helpful that the gamer recognizes the “side” of the game piece that essentially includes the NFC antenna 8c-ant, where for example this (arbitrarily designated) “bottom side” includes a distinct bottom-side visualization or even a decoration 8c-dec, as opposed to the (arbitrarily designated) and opposite “upper side.”

In any case, a careful consideration will show that it is useful to determine that the current “bottom side” side of a game piece base 8c that is coming into contact or close proximity with a magnetic surface being used as a card or game-playing surface, such as “passive game board 2” 10-6 (see FIG. 6A). As such, this sensed “coming into contact” can be used at least in part by game piece base 8c processor/power 8c-prc to for example trigger any number of functions such as 1) causing the NFC reader 8c-tagR to use the “downward facing” antenna 8c-ant to determine in there is a readable NFC tag within proximity of the antenna 8c-ant, 2) causing a visual output using a component 8c-vo or audio output using a component 8c-ao, 3) causing communication with a computing device such as 15, 17 using a global data com port component 8c-Gcom, 4) causing communication with a companion base (see FIG. 3C) or an active figurine 8a using a local data com component 8c-Lcom, or 5) causing the NFC reader 8c-tagR to engage an antenna switch component 8c-asw to alternatively or otherwise also engage an “upward facing” antenna component 8c-ant in an attempt for example to read a playing game card 70-3 being “tapped” to the “top” of the game piece base.

It is noted, as will be well understood by those familiar with the necessary technology, that while relative orientation sensor 8c-ros works in response to a local magnetic field 10-6-mf while absolute orientation sensor 8c-aos works at least in part in response to the earth's magnetic field and gravity, the net effect of sensing that a game piece is down versus up can be accomplished using both types of components and technologies, after which this sensed information is similarly useable at least in part as described in the prior paragraph by the processor/power component 8c-prc for triggering game piece base 8c functions. As will be understood by those skilled in the necessary arts, in general magnetic field sensors described for relative orientation sensor component 8c-ros tend to be less expensive and easier to integrate than absolute orientation sensors used for component 8c-aos, and at least for this reason are preferred.

Still referring to FIG. 3A, those familiar with reed switches will understand that it is possible to use a first reed switch oriented “downward” in a game piece base 8c while then also using a second reed switch oriented “upward,” where it is also possible to provide magnetic shielding between the two as a means for minimizing false reads. In this two 8c-ros sensor approach, both the up and down orientation of a game base 8c are directly detectable, where at any given time only the reed switch situated in close proximity/“contacting” the local magnetic field source 10-6-mf (such as “passive game board 2” 10-6) with be activated and thus providing useful information to processor/power component 8c-prc as discussed.

Those familiar with hall effect sensors will be familiar with the differences between “unipolar,” “bipolar,” “omnipolar,” and “linear” hall effect sensors, where in general a unipolar sensor is activated in the presence of either one of a “north pole” or “south pole” oriented magnetic field of sufficient strength, and then becomes deactivated when removed from the presence of this magnetic field. A bipolar sensor will be activated in the presence of either the north pole or south pole of a magnetic field of sufficient strength, and then deactivated in the presence of the opposite south pole or north pole exposure. An omnipolar sensor can be constructed using a pair of unipolar sensors mounted in opposite directions and thus acts like a reed switch that turns on an off regardless of the pole of the magnetic field.

In the preferred arrangement, the card-playing surface such as a “passive game board 2” 10-6 comprises two or more distinct spatial areas, each with a different magnetic field strengths depicted as 10-6-mf1 and 10-6-mf2. (It is also possible for each spatial area to be oriented with a north or south pole “facing up,” for providing different playing surface location information, or even combination of north/south pole orientation along with magnetic field strength, all as will be clear to those familiar with at least hall effect sensors.) A linear hall effect sensor provides a varying output voltage based upon the strength of the magnetic field 10-6-mf, and as such is usable to determine not just being in the presence of a particular local magnetic field 10-6-mf, but more importantly in the presence of a certain pre-known magnetic field (pre-know based at least in part upon its field strength) such as “magnetic field 1” 10-6-m1 or “magnetic field 2” 10-6-m2 (see FIG. 6A). Furthermore, the linear sensor is able to provide a distinct voltage output when in the presence of a north pole oriented magnetic field versus a south pole-oriented field, and thus “magnetic field 1” 10-6-m1 or “magnetic field 2” 10-6-m2 could also be distinguished by a linear sensor that is for example in the presence of a field 1 10-6-m1 that is oriented with the north pole facing up as opposed to being in the presence of a field 2 10-6-m2 that is oriented with the south pole facing up.

Still referring to FIG. 3A, what is important to see is that there are many possible combinations and arrangements of one or more reed switches and/or one or more hall effect sensors of one or more sensor types (such as “unipolar,” “bipolar,” “omnipolar,” and “linear”) that can be implemented in combination with a type of magnetized playing surface such as “passive game board 2” 10-6 comprising any one or more spatial areas using a magnetic material of a given magnetic field strength and pole orientation so as to determine at least that a game piece base 8c is oriented “up” versus “down,” and then optionally is located over one spatial area such as 10-6-m1 versus a different spatial area such as 10-6-m2. Although not preferred at least for cost and complexity reasons, it is possible that any given configuration of a game piece base 8c comprises either or both of an absolute orientation sensor 8c-aos and a relative orientation sensor 8c-ros, or even one or more components with a traditional absolute orientation sensor such as an accelerometer, gyroscope, or a magnetometer, being used by themselves or combined with any of a local orientation sensor 8c-los component.

FIG. 3A also teaches a local data comm port 8c-Lcom comprising any of several possible and well-known technologies for communicating between to devices in close proximity and even touching. A local data comm port 8c-Lcom for example can be implemented using NFC technology, where unlike traditional RFID technology, NFC allows for two-way communication for example to exchange information between the base 8c and a companion device, again such as a “game piece topper” 8c-top (see FIG. 3B,) a second “game piece base 2” 8c-pc2 (see FIG. 3C,) or any other active gaming device capable of exchanging data and signals, such as an active figurine 8a (see also PRIOR ART U.S. Pat. No. 10,857,450 entitled PHYSICAL-VIRTUAL GAME BOARD AND CONTENT DELIVERY PLATFORM filed on Aug. 9, 2019, PRIOR ART FIG. 7). One advantage for using NFC technology for implementing a local data comm port 8c-Lcom is that the same NFC reader 8c-tagR used for reading electronic NFC tags can also be employed for engaging in two-way communication with another NFC reader comprised with any of an active “companion devices.”

Other close proximity, even contact based, technologies are available for implementing a local data comm port 8c-Lcom, for example at least including what is referred to as an “optical port.” What is important to see is that at least some useful versions of game piece base 8c implement both a global data comm port 8c-Gcom for “longer range” two-way data communication with a gaming computing device such as a tablet 15 or smartphone 17 executing a gaming app, and a local data comm port 8c-Lcom for “short range” two-way data communication with a companion gaming device.

And finally, with respect to FIG. 3A, while the form/shape of game piece base 8c is depicted as the preferred “coin-shape,” the present invention should not be limited to any particular form or shape as there are other useful and anticipated shapes, for example see upcoming FIGS. 3F, 3G, and 3H where the game piece base 8c at least includes the combination of a base 8c-9b (e.g., in a rectangular shape) with an attached “slot” 8c-9s for holding “join-cards.” The present invention also anticipates that some shapes can be created to coincide with the look and feel of the particular game, thus being more “game-decorative” in form, beyond simply having an attached decoration 8c-dec, even being built into game style figurines 8a, and thus possibly even becoming collectibles that are periodically changed by the game maker.

Referring next to FIG. 3B, there is shown a perspective view depicting the combining of a configuration of a game piece base, thus 8c-pc1, with a game piece topper 8c-top, where topper 8c-top includes at least one active component (as opposed to a decoration 8c-dec without any active components) and is in communication with piece 8c-pc1, either directly through a communication port such as local port 8c-Lcom or indirectly through an intermediary such as a game app running on a computing device such as a tablet 15 or smartphone 17, where both game piece 8c-pc1 and topper 8c-top communicate with the computing device 15, 17 via a global communication port 8c-Gcom. In at least one example, game piece topper 8c-top comprises either or both of a visual output 8c-vo or a audio output 8c-ao, thus by being comprised within the topper 8c-top becoming a “removable” media output. As discussed in relation to the game piece decoration 8c-dec (see FIG. 3A,) there are many possible and sufficient ways for allowing a topper 8c-top to be attached to a game piece base such as 8c-pc1. It is also noted that any component described for use within a game piece base 8c (again, see FIG. 3A) may also alternatively be included in topper 8c-top, thus making a game piece base “reconfigurable.”

Referring next to FIG. 3C, there is shown a perspective view depicting the combining of a configuration of a game piece base, thus 8c-pc1, with a second game piece base, thus 8c-pc2, where each of 8c-pc1 and 8c-pc2 are of any game piece base configuration, and where the combination of 8c-pc1 and 8c-pc2 forms a new game piece base 8c. As discussed in relation to the game piece decoration 8c-dec (see FIG. 3A) and topper 8c-top (see FIG. 3B) there are many possible and sufficient ways for allowing a second game piece base 8c-pc2 to be attached to a game piece base such as 8c-pc1. The main conceptual difference between topper 8c-top and second game piece 8c-pc2, is that topper 8c-top is anticipated to be smaller (or at least “thinner”) in size and to not for example comprise a processor/power component 8c-prc, thus allowing for the “extension” of a “standard” game piece base 8c's functionality, whereas each of game piece bases 8c-pc1 and 8c-pc2 are anticipated to include processor/power component 8c-prc as well as other minimal components for forming a “stand-alone” game piece 8c.

For example, in one use case configuration, a game platform comes with multiple “standard” game piece bases of “configuration 1” (see FIG. 4) comprising a processor/power 8c-prc, global data comm port 8c-Gcom, an electronic tag reader 8c-tagR and a single antenna 8c-ant facing “downward.” In some games either comprising interactive board games, interactive card games, or the combination of interactive board and card games, this “standard” configuration is sufficient for “digitizing” the game-play mechanics. However, some other more complex game mechanics might benefit by creating a new “combined” game piece by attaching the two “standard” game pieces, thus for example forming a configuration similar to 8c-3 (without the visual output 8c-vo or audio output 8c-ao, which could later be added by using a topper 8c-top). In this example, both game piece 8c-pc1 and 8c-pc2, of configuration type 8c-1 (see FIG. 4,) communicate with each other indirectly via the intermediary computing device 15 or 17 using their global data comm ports 8c-Gcom (although, it is also possible for them to also communicate directly with each other through this same global data port 8c-Gcom). Alternatively, both pieces 8c-pc1 and 8c-pc2 could be configured to include a local data port 8c-Lcom for direct communication. Thus, as the careful reader will see, there are many possible way of providing for simpler “standard” game piece bases than can be combined with passive decorations 8c-dec, active toppers 8c-top preferably lacking a separate processor/power 8c-prc, or other game piece bases comprising separate processor/power 8c-prc and other necessary components, where these many possible ways allow for marketplace variation and adaptation to different types of interactive board, card, or board and card games, some with simpler mechanics for digitization, other with more complex mechanics for digitization.

Referring next to FIG. 3D, there is depicted either game card with ID 70-3a, or a game card without ID 70-3b inserted into a sleeve 70-3c, now further adapted to include multiple electronic (preferably NFC) tags depicted in the present figure as two (2) tags, thus becoming 70-3a2 or the combination of 70-3b and 70-3c2, and in either case still being a playable game card 70-3.

Referring next to FIG. 3E, there is depicted a playable game card 70-3 comprising multiple electronic tags being placed on a PRIOR ART “active game board 1” 10-3, where the relative orientation (such as “vertical” versus “horizontal”) of the playable game card 70-3 with respect to the active game board 10-3 is determined at least in part by the “active game board 1” 10-3 engaging with the comprised sensing apparatus, for example and as depicted a matrix of sensing antenna, in order to determine the physical locations of each of the multiple electronic tags. This method for the determination of the relative orientation of a playable game card 70-3 (and not just relative location) with respect to a playing surface such as a passive or active game board is then predicated on the determination of the current physical location (to some sufficiently differentiable approximation) of at least two electronic identifiers (e.g., two electronically detectable NFC tags,) whereas with respect to earlier FIG. 3A it is also possible to first collocate a game piece base 8c with a playable game card 70-3 (for example by placing the base 8c on top of and in physical contact with the game card 70-3,) where the base 8c comprises at least an absolute orientation sensor 8c-aos, or otherwise one or more components of sensor 8c-aos such as an accelerometer, a gyroscope, and a magnetometer, such that by changing the current orientation of the underlying (and physically supportive) card 70-3 the game piece base 8c is caused to rotate and this detected self-referential rotation is interpretable as at least an indication of orientation change and therefore usable to update game state information.

What is important to see is that at least some card games include play mechanics that derive meaning from a change in orientation of a laid down card, and that means for determining that a laid down playable game card 70-3 has thereafter been physically rotated are any combination of distinct from or substantially comprised by means for determining that a playable game card 70-3 has been laid down upon a playing surface, and thus the present invention teaches variations of means for determining a “change in orientation” game-play event.

Referring next to FIG. 3F, there is shown a game piece base 8c in a distinct non-“coin” shape 8c-9. In the first sense, this variation of game piece base 8c should be understood as “decorative” or “design” and distinct from “functional,” and as such game piece bases 8c of different physical forms and even colorizations are then usable to convey “story-meaning” to game-players where the shapes of game piece bases 8c are interpretable by players as implying some different in game-play rules processing (see discussion related to step 100-13 “determine play card(s) results” in FIG. 5A). Thus, it is also important that individual and distinct game piece bases 8c have a determinable and unique identity (and not just a “type identity” such as “game piece,” “red checker,” or even “black bishop”,) represented for example as an electronically readable code/electronic ID comprised within an electronic tag 8c-tag component of the base 8c. It is also desirable from a game manufacturer's perspective to be able to create “generic” game pieces whose distinct “personality” can be added by players, for example by applying decorations 8c-dec or joining pieces such as a topper 8c-top to a first piece 8c-pc1, or a second piece 8c-pc2 to a first piece 8c-pc1. However, it is also advantageous to a manufacturer to be able to create and sell uniquely distinct game piece bases 8c, similar to selling uniquely distinct game-play cards 70-3, where changes in the limitation of marketplace supply can affect game-play experiences and create “collectible” value. The reader is also reminded that a game piece base 8c at least also includes wearables such as 9c that include key functions such as identifying an electronic tag associated with a “game portion,” where then these wearables 9c are also differentiable by “forms” and “designs” that have game-play “story-meaning.”

In addition to these game piece base 8c design-only value considerations, game piece base 8c functional considerations are also important and can serve to for example to give all game piece bases 8c of any design a common set of game-play mechanic functions (such as determining and/or being used at least in part to determine a game-play mechanic of “adding a card to a current hand,” “laying down a card onto a playing surface,” “rotating a card,” or “tapping a card to join two cards”,) or giving some game piece bases 8c unique functions (such as determining “card rotation or orientation”,) or otherwise providing a common game piece base 8c function in a different apparatus or method, such as the means for indicating a “join” card operation, where this alternative join-card apparatus and method is currently being taught with respect to alternative game piece base configuration 8c-9.

Still referring to FIG. 3F, in a preferred embodiment game piece base with join-card slot 8c-9 comprises both a base 8c-9b and a physically attached “join-card” slot 8c-9s. Base 8c-9b preferably comprises electronics such as processor/power 8c-prc, global data comm port 8c-Gcom, tag reader 8c-tagR, an antenna switch 8c-asw, and at least one downward facing antenna 8c-ant, and then optionally also comprises any of an absolute orientation sensor 8c-aos or relative orientation sensor 8c-ros. Join-card slot 8c-9s comprises at least one antenna 8c-ant1 for use by a reader 8c-tagR in communicating with preferably an NFC tag comprised in a playable game card 70-3 once the game card 70-3 is properly inserted into the slot 8c-9s. (It is also noted and anticipated herein, as will be understood by those familiar with barcode scanners and magnetic card readers, that slot 8c-9s may alternatively comprise any of an optical or magnetic scanner means for determining either optically or magnetically encoded game card 70-3 information such as a unique ID, respectively, comprised within a further adapted playable game card 70-3, where optical encoding is for example a printed bar code 70-3a-pid (see FIG. 1A) and where magnetic encoding comprises for example a magnetic strip attached to the surface of, or included under the surface of, card 70-3 and where magnetic encoding apparatus additionally comprises writing or storing information on the game card 70-3 magnetic strip or similar.)

Still referring to FIG. 3F, join-card slot 8c-9s may also comprise a longer-range electronic tag such as an RFID or UWB (ultra-wide band) tag that can be interrogated from distances typically much greater than an NFC tag. As will be understood by those familiar with antennas and antenna field scanning, especially in consideration of upcoming alternative “active game board 2” 10-5 described in FIG. 3I, it is advantageous for any longer-range electronic tag to be oriented substantially perpendicular (as opposed to parallel for example by comprising in base 8c-9b) to the playing surface as depicted for “side tag” 8c-tag that is used for game piece base 8c-9 location tracking in combination with an “active game board 2” 10-5. As will also be understood by a careful consideration, it is possible to include any of join-card ID tag reader antenna 8c-ant1 or side tag for tracking 8c-tag in either or both of the physical portions/slats together forming “join-card” slot 8c-9s. Furthermore, in another variation of game piece base 8c-9, a side tag post 8c-9p is included in the physical form of base 8c-9 for comprising side tag for tracking 8c-tag in a different orientation that is or may be more advantageous for tag 8c-tag scanning, where a careful consideration of upcoming FIG. 3I will show that this alternative positioning allows tracking tag 8c-tag to not only be substantially perpendicular to the playing surface but then also substantially parallel to the interrogation antennas such as 10-5ant1, 10-5ant2, and 10-5ant3 comprised with a “side oriented” emitter/receiver array such as 10-5-a2, depending upon the assumed orientation of the game piece base 8c-9, all as a careful consideration will show.

And finally with respect to FIG. 3F, alternative game piece base with join-card slot 8c-9 preferably comprises one or more antenna such as 8c-ant2 and/or 8c-ant3 that are usable for scanning the electronic tag comprised within a first laid down card 70-3 onto which base 8c-9 has thereafter been substantially and properly placed upon. As a careful consideration of the present and PRIOR ART teachings related to generic game piece base 8c, it is possible that alternative base 8c-9 include means for use in determining both the placement act of, and a relative location over which, the base 8c-9 has been properly situated with respect to any of a game board 10-3, 10-4, 10-5, or 10-6, or otherwise the placement act of being situated on a playing surface 10-1, where in combination with means for determining the identity of a second join-card 70-3 as well as means for determining the identity of a first laid-down game card 70-3 provides valuable game-play mechanics information for determining and updating a digital representation of the state of game-play.

Those familiar with the design of electronic devices will also understand that while several electronic components were described as preferably comprised within base 8c-9c, it is possible to locate at least some of the taught components for example into the slot 8c-9s, or even the post 8c-9p, or still yet some other adaptation to the designed form of game piece base 8c-9, and as such the present invention should not be unnecessarily limited to the described preferred arrangement of components located within specific portions of the form of the game piece base 8c-9, as many alternative game piece base forms and configurations are possible without departing from the scope and spirit of the invention.

Referring next to FIG. 3G, there is depicted a series of three perspective views of a playable game card 70-3 being used as a “join-card” 70-3jc, where in the leftmost view the join-card 70-3jc is not placed in the game piece base 8c-9's reader slot 8c-9s, and where in the middle view and rightmost views the join-card 70-3jc is placed in reader slot 8c-9s, thus being detected by the game piece base 8c-9 by means for slot antenna 8c-ant1 (see FIG. 3F). While the middle view shows the game card face (presumably as seen by an opponent,) the rightmost view shows the game card back (presumably as seen by the player of the join-card 70-3jc,) where the slot 8c-9s of game piece base 8c-9 has been further adapted to comprise a display/visual output 8c-9vo for indicating information to the join-card-player, and where display 8c-9vo is preferably positioned so as to not be in the view of the opponent.

The careful reader will understand that alternative form game piece base 8c-9 provides substantially the same functionality for detecting and digitizing game-play mechanics as at least some other anticipated “coin-shape” implementations of a game piece base 8c, for example such as configurations 8c-3, 8c-5, 8-6, and 8c-7, excepting that the alternative form comprises the physical slot 8c-9s for placing an holding the join-card 70-3 and some perpendicular structure such as slot 8c-9s or post 8c-9p along with side tag for tracking 8c-tag. To this extent, descriptions provided herein of the operation and use of any game piece base 8c should be understood as also applicable to base 8c-9.

FIG. 3H is a set of three perspective drawings of game piece base 8c-9, first on the left as described in relation to FIGS. 3F and 3G, and then in the middle and on the right as a further adapted variation of game piece base 8c-9. In the leftmost depiction, base 8c-9 is shown resting upon a played-card 70-3pc situated in which it is then able to “read” for the played-card identity using an electronic tag reader 8c-tagR via an antenna 8c-ant2 or 8c-ant3 comprised within base with electronics 8c-9b, all as prior discussed. There is also shown a join-card 70-jc that has been typically subsequently inserted into slot 8c-9s (see FIGS. 3F and 3G) of base 8c-9, where then base 8c-9 is further able to “read” for the joined-card identity using an electronic tag reader 8c-tagR via an antenna 8c-ant1 comprised within slot 8c-9s, all as prior discussed. One anticipated advantage of this implementation 8c-9 of game piece base 8c as opposed to a “coin-shape” configuration and form, is that both the join-card 70-3jc and the played card 70-3pc are being held in a desirable “show” configuration where players more easily recognition their relationship and where, as will be discussed shortly, at least additional visual augmentations can be more readily provided.

Now referring to the further adapted game piece base 8c-9 as shown in the middle and rightmost depictions of the base 8c-9, where the base 8c-9 is still situated upon played-card 70-3pc and holding inserted join-card 70-3jc, what is different from the leftmost depiction as well as those depictions in relation to FIGS. 3F and 3G is that that base 8c-9 has been further adapted to least include preferably two visual outputs 8c-9vo (see especially the bottommost/middle depiction,) where both outputs 8c-9vo of which are increased in size compared to prior base 8c-9 description (see FIG. 3G the rightmost depiction) so as to substantially cover all or most of the join-card 70-3jc's front and back faces, where then also these expanded in size displays 8c-9vo1 and 8c-9vo2 are preferably (but not necessarily,) transparent. As a careful consideration will show, based upon the known and necessary “slot-inserted” location of the joined-card 70-3jc, where then by use of a tag reader 8c-tagR for example controlling two antenna 8c-ant, one on either side of slot 8c-9s and therefore able to read either or both of the front and back of the join-card 70-3jc, such that reading a front and/or back facing NFC tag positioned included with the join-card 70-3jc, allows game piece base 8c-9 to also determine the “facing orientation” of join-card 70-3jc. (It is further noted that to best support front-side “only” reading or back-side “only” reading of a front-side or back-side card 70-3 situated NFC tag, respectively, it is possible to include if necessary shielding in join-card 70-3jc such that any NFC tag used for example in the front side of the join-card 70-3jc is substantially shielded or otherwise prohibited from being sensed through an antenna situated on the opposite/therefore backside of the join-card 70-3jc such that reading the NFC tag positioned in slot 8c-9s can also determine its “facing orientation.”)

Still referring to FIG. 3H and the middle and rightmost depictions of a further adapted game piece base 8c-9, as will be well understood by those familiar with augmented reality, it is possible to have a pre-known representation of both the front and back images of a particular card 70-3 that is currently being used as a playable join-card 70-3jc inserted into slot 8c-9s, such that having determined the slotted-location and orientation of the particular card 70-3, it is then possible to cause visual output on either or both of the front and back facing visual outputs 8c-9v01 and 8c-9v02, respectively, where the caused visual outputs are substantially aligned and relevant to features of the pre-known front and back images, thus producing an “AR” effect. Also show as possible visual output adaptations are one or more light emitters such as LEDs 8c-9b-led1 for substantially creating a lighting effect on the face of a join-card 70-3jc, and one or more light emitters such as LEDs 8c-9b-led4 for substantially creating a lighting effect on the face of a join-card 70-3jc.

FIG. 3I is a perspective drawing of an alternative “active game board 2” 10-5, where the sensing antennas such as 10-5-ant1, 10-5-ant2, and 10-5-ant3 are moved from substantially underneath the playing area (see “active game board 1” in FIG. 3E as well as the PRIOR ART U.S. Pat. No. 10,688,378 entitled PHYSICAL-VIRTUAL GAME BOARD AND CONTENT DELIVERY SYSTEM filed on Jul. 4, 2018) to one or more sides of the playing surface area and comprised within emitter/receiver arrays 1 and 2, 10-5a1 and 10-5a2, respectively. Any configuration of one or more sensing arrays such as 10-5-a1 and 10-5-a2 preferably comprises two or more antenna such as 10-5-ant1, 10-5-ant2, and 10-5-ant3 included within array 10-5-a2 (similar antenna are present but not labeled for array 10-5-a1). Antennas such as 10-5-ant1, 10-5-ant2, and 10-5-ant3 are configured to either emit and/or receive signals that are substantially oriented to sense the playing surface area where player cards and game piece bases such as 8c-1 and 8c-8 are anticipated to be set down during on-going game-play.

As is necessary, and as will also be well-known in the art of wireless object tracking, often referred to generally as “local positioning systems” (LPS) that are implemented using wireless signals (i.e., as opposed to for example cameras and image processing,) other components such as processing and power are also preferably embedded in arrays 10-5-a1 and 10-5-a2 along with global wireless communications for at least transmitting location detection data to a computing element such as a tablet 15 or smartphone 17, or otherwise a computing element capable of running some of all of the game app for processing changes in at least game piece base and card locations. It is also noted that the “active game board 2” 10-5 can alternately be implemented using any LPS technology, including an array of one or more cameras for monitoring the playing surface area, or even implemented using a combination of technologies including the depicted wireless arrays 10-5-a1 and 10-5-a2 along with one or more cameras, or even combined with passive game boards 10-4 or 10-6 or active game board 10-3, and thus the while the wireless arrays are preferred for board 10-5, the present invention should not be limited to only using wireless arrays.

Still referring to FIG. 3I, locations of any card 70-3 or game piece base 8c are determined using a number of possible available wireless LPS technologies, each with varying degrees of accuracy, power requirements, size requirements, etc., including wireless technologies for use in a “method A” where the bases 8c are passive and a “method B” where the bases 8c are active. Any of a game board such as 10-3, 10-4, 10-6 and/or game board overlay 11-3 are also optionally placed within the sensed playing surface area and registered to the one or more arrays 10-5-a1 and 10-5-a2 such that tracked physical locations of cards 70-3 and/or game piece bases 8c within the playing surface area are then mappable to logical locations such as 11-3Ln of the game board and/or overlay for determining game board situations and game-play progression, etc., where, as taught in the referenced PRIOR ART, this “mapping” from a determined physical location to a pre-known and logical location requires a pre-registration of the physical-to-logical locations of which many variation approaches are possible as taught in the PRIOR ART.

In the preferred method B where the game pieces 8c are active, the interested reader is directed to new advancements in robot navigation being achieved using low-cost, low-power WiFi sensors (that can be embedded within a game piece base 8c) that are able to determine their own current local position with respect to a field of WiFi signals being emitted by multiple antenna (such as 10-5-ant1 and 10-5-ant2). (See TechExplore article entitled “Engineers develop a way to use everyday WiFi to help robots see and navigate better indoors,” published by University of California at San Diego.) The research group states that “the sensors” (thus within 8c) “call out to the access points” (thus antenna such as 10-5-ant1, 10-5-ant2, or 10-5-ant3 within an emitter/receiver arrays such as 10-5-a1 or 10-5-a2) “and listen for their replies, using them as landmarks. The key here is that every incoming and outgoing wireless signal carries its own unique physical information—an angle of arrival and direct path length to (or from) an access point—that can be used to figure out where the robot” (thus game piece base 8c) “and access points” (thus any antenna such as 10-5-ant1, 10-5-ant2, or 10-5-ant3 comprised within an array such as 10-5-a1 or 10-5-a2) “are in relation to each other. Algorithms developed by Bharadia's team enable the WiFi sensors to extract this information and make these calculations. As the call and response continues, the sensors pick up more information and can accurately locate where the robot is going.” Furthermore, the article also states that “the accuracy of localization and mapping provided by the WiFi sensors was on par with that of the commercial camera and LiDAR sensors” which is known in the relevant art to be within millimeters and is thus considered sufficient for game piece base 8c physical location tracking.

However, using method B for self-tracking with a playable game card 70-3 is problematic because of at least the anticipated (“grain-of-sand”) size of the WiFi sensor. In method A, a game card 70-3 (or a game piece base 8c) comprises preferably a longer-range passive electronic tag, such as an RFID or UWB (“ultra-wide-band”) tag which can be made very thin, where then the antenna size (and therefore tag size) of this electronic tag, and its orientation to the combined electro-magnetic field emitted by arrays 10-5-a1 or 10-5-a2, along with the power of the emitted signals are all factors effecting location tracking accuracy, all as is well-known in the art. It is not the purpose of the present invention to necessarily teach improvements in any of existing or to be develop “method A” or “method B” “object tracking” via “wireless signals” technologies, but rather to teach the use of such methods and technologies for combination as an “active game board 2” 10-5 within the present interactive game board, interactive card game, or interactive game board with card game platform.

And finally with respect to FIG. 3I, it is possible to use “active game board 2” 10-5 comprising one or more emitter/receiver arrays such as 10-5-a1 or 10-5-a2, where the field that is emitted/received by the one or more arrays 10-5-a1 or 10-5-a2 define a “playing surface area” within a “playing space volume,” and where within the playing space area it is possible to locate any of passive game boards such as 10-4 or 10-6 or “active game board 1” 10-3, where then game boards 10-3, 10-4 or 10-6 would function as described both herein and in the referenced PRIOR ART thus optionally working in conjunction with a calibrated and registered board game overlay 11-3 such that any determined physical locations of a game piece base 8c or playable game card 70-3 are relatable to logical locations such as 11-3Ln providing for game state associations of a base 8c or card 70-3 with a logical location 11-3Ln, where then interactive gaming system response and otherwise actions can be based at least in part on these determined game state associations.

Alternatively, game-play comprises the use of “active game board 2” 10-5 without any passive game board such as 10-4 or 10-6 or “active game board 1” 10-3, but still using a board game overlay 11-3 that is then calibrated and registered to the playing surface area prescribed by the one or more arrays 10-5-a1 or 10-5-a2. In one example of registration, the overlay 11-3 is laid upon a table and the arrays are set down along pre-marked edges of the overlay 11-3, such that the determined physical locations may then be mapped using this pre-known relative association between the overlay 11-3 and the location and position of the placed down arrays 10-5-a1 or 10-5-a2, all as will be clear from a careful consideration.

In another registration variation, the arrays 10-5-a1 or 10-5-a2 are placed leaving an open playing surface area that for example exceeds the size of an overlay 11-3 and may be sufficiently sized to allow for the fitting of multiple overlays 11-3 within the playing surface area. Once an overlay 11-3 is laid within the playing surface area, game piece bases 8c used for calibration may then be placed in select calibration locations preferably pre-designated and discernable to a player on each of any one or more overlays 11-3, where then the calibration game pieces bases 8c are physically located in combination with operation of arrays such as 10-5-a1 or 10-5-a2 and possibly computing executed on another computing device such as a tablet 15 or smartphone 17. After determining the physical location of the preferably two or more calibration game piece bases 8c situated on distinct calibration locations, these determined base 8c locations are then associated by the system with the pre-designated logical location(s) such as 11-3Ln, thus providing a “map.” It is then noted that other non-calibration locations may also be defined within the pre-known map, where they are defined mathematically with respect to the preferably two or more calibration locations such that once the physical locations of the calibration locations are determined, using the defined mathematics within the map the physical locations of the non-calibration logical locations can be determined, all as will be understood by those familiar with calibration systems and also by a reading of the referenced PRIOR ART.

What is important to see is that there are multiple different and sufficient ways to create a pre-known “registration” correlation between any one or more overlays 11-3 comprising one or more logical locations and a playing surface area prescribed by one or more “active game board 2” 10-5 arrays such as 10-5-a1 and 10-5-a2, and that by using this registration correlation along with a pre-known map of one or more calibration logical locations similar for example to 11-3Ln, any and all other “map” defined logical locations are then relatable to detected physical locations, such that it is then possible to correlate or “map” any on-going detected physical locations of a game piece base 8c or playable game card 70-3 placed within the playing surface area to a game overlay 11-3 logical location 11-3Ln.

And finally, it is also noted that “active game board 2” 10-5 can be used without any game board overlay 11-3, and as such the playing surface is “empty” or comprises no game boards, herein designated as 10-1 (see FIGS. 6E and 6F). As the careful reader and those familiar with software will also understand, the lack of any visualized surface locations (such as would be provided using any of a game board or overlay) does not prohibit the playing surface area from being logically divided into locations which comprise “game-meaning” and otherwise are tied to “game rules” or the “game state,” where the present invention anticipates that the physical determination of the current location of a game piece base 8c or a playable card 70-3 within a playing surface area in general and then more specifically in reference to any such “non-visualized” pre-established “logical divisions”/“logical locations” is usable as game state data especially with respect to game rules that are “playing surface area” “location based” rules, hence and for example the “middle of the playing surface area” is determinably different from either “side area nearest to either of the players,” etc., and as such different game rules and functions may be applied accordingly. It is also noted that by not providing visualizations to what are otherwise valid (but again, not visually perceivable to the player(s)) logical game locations, it is possible to add the element of surprise to current game as a given player is not certain if the physical location within the playing surface area is “safe” but otherwise this surprise element can be used for many game-play purposes such as to either increase or decrease game-play benefits, etc., all of which will be obvious to those familiar with game-play rules and ways for generating player engagement and excitement.

Referring next to FIG. 3J, there is depicted a perspective drawing of AR glasses 50 (such as currently available in the marketplace or to become available) that have been further adapted to preferably comprise one or more non-visible light emitters 50-ir-led such as LEDs for emitting any of UV or IR light, preferably one or more cameras such as 50-irc-1 and 50-irc-2 for sensing non-visible light such as non-visible light emitted by the lights 50-ir-led, and preferably one or more audible outputs such as speakers 50-spk-1 and 50-spk-2 (if these speakers are not already present in the AR glasses 50 to be further adapted). AR glasses 50 are well-known in the marketplace and are currently being provided or are under development by many companies, where the various companies are sometimes employing differing types of core components, but where these components in general are meant to provide visual and virtual augmentations typically reflected off of the AR glasses' lenes that are preferably aligned with the current view of the person wearing the glasses, such that person substantially perceives the physical reality that is currently in their view overlaid with the virtual augmentations.

Regardless of the many and various types of AR glasses now being sold, under development, or otherwise as anticipated by the those skilled in the art, and regardless of the core underlying components used in any of these many and various solutions, the present invention teaches a means for gathering additional current view non-visible registration data, where then this additional non-visible registration data is usable along with other traditional types of data determined by the various types of AR glasses to provide significant technical advantages when determining and visually locating the virtual augmentations. The anticipated non-visible registration data comprises one or more non-visible markings placed upon any of the “game portions” of an interactive gaming system such as game boards, game board overlays, game piece bases, game piece figurines, game wearables, etc., all as defined or anticipated herein and in the referenced PRIOR ART. The reader is directed to the parent application of this present application as identified in the cross references for further discussion on special coatings, engineered light, and matching image capture (such as using multi and hyperspectral cameras) and processing for supporting the present non-visible registration markings.

Still referring to FIG. 3J, the bottom of the figure shows a playable game card 70-3 in three different configurations, where each configuration comprises one or more non-visible markings such as card edge markings 70-3s-ir1, 70-3b-ir1, and 70-3a-ir1 or card ID markings 70-3s-ir2, 70-3b-ir2, and 70-3a-ir2. The leftmost configuration of playable game card 70-3 comprises a game card 70-3b that does not comprise a readable ID that is inserted into a game card sleeve 70-3s-ir that does comprise a readable ID (see the PRIOR ART combination in FIGS. 1B and 1C) and also has been further adapted to comprise non-visible registration marks including edge markings 70-3s-ir1 and ID markings 70-3s-ir2 (such as a non-visible bar code). The middle configuration of playable game card 70-3 comprises a game card 70-3b-ir that does not comprise a readable ID (such as an electronic NFC tag 70-3s-eid or a visible printed ID such as 70-3s-pid, see FIG. 1B) that is not inserted into a game card sleeve 70-3s-ir and that has been further adapted to comprise non-visible registration marks including edge markings 70-3b-ir1 and ID markings 70-3b-ir2 (such as a non-visible bar code). The rightmost configuration of playable game card 70-3 comprises a game card 70-3a-ir that does comprise a readable ID (such as an electronic NFC tag 70-3a-eid and/or a visible printed ID such as 70-3a-pid, see FIG. 1A) that is not inserted into a game card sleeve 70-3s-ir and that has been further adapted to comprise non-visible registration marks including edge markings 70-3a-ir1 and ID markings 70-3a-ir2 (such as a non-visible bar code).

As a careful reading of the present invention and the referenced PRIOR ART will show, there are many possible configurations of a game card with or without a game card sleeve that are usable for providing critical data with respect to game-play mechanics. What is important to see is that it is possible to further adapt these many possible configurations to further include non-visible registration and ID markings, where the currently depicted “edge markings” (such as 70-3s-ir1, 70-3b-ir1, and 70-3a-ir1) and “bar code IDs” (such as 70-3s-ir2, 70-3b-ir2, and 70-3a-ir2) should be considered as preferred but exemplary, as many variations in placement and otherwise layout, spacing, sizing, encoding, etc., are possible. As will become clear through a careful consideration, edge markings are a preferred location as it defines the perimeter of substantially the entire card 70-3, and some form of an ID marking placed substantially in the upper left corner of the card is preferred as this location is expected to be most reliably and consistently visible to the cameras such as 50-irc-1 and 50-irc-2 of glasses 50, especially when the card 70-3 is being held in a hand of cards 70-h (see for example FIG. 3K).

Still referring to FIG. 3J, those familiar with non-visible substances such as inks, dyes, and other substances (see the parent application as identified in the cross-references for additional teaching especially in relation to “special coatings 12g” for applying to “articles 12” such as a card 70-3) will understand that it is possible to apply such non-visible substances that are substantially non-visible to a player but which can be detected by a imaging sensor that has been further adapted to filter the incoming spectral range of visible and non-visible light to receive substantially only the non-visible energy spectrally overlapping with the spectral response of the non-visible substances, all as will be understood from a careful reading of the parent application and by those familiar with the image capture and processing of non-visible markings.

Non-visible markings preferably exhibit a spectral response that is substantially transmissive to the “visible light” that is discernible to the human eye, roughly ranging from 380 nm to 800 nm in wavelength, and as such substantially neither reflect nor absorb this visible light. However, non-visible markings preferably either substantially reflect or absorb non-visible light that is outside of this visible spectrum of 380 nm to 800 nm in wavelength, such as UVA (ultra-violet “A” type) light typically considered as 315 nm to 380 nm or NIR (near infrared light) typically considered as 800 nm to 2500 nm, where imaging sensors are available that can at least detect substantial portions of these UVA and/or NIR frequency ranges, all as is well-known in the art. Those familiar with indoor lighting systems will also appreciate that many such types of indoor lighting are optimized to emit significant visible light but often substantially no non-visible UVA or NIR light. Thus, the present invention teaches the further adaptation of AR glasses 50 to comprise one or more light emitters such as one or more LEDs 50-ir-led, where these LEDs may be emitting in either or both of the UVA or NIR spectrums, and as such then providing non-visible “tracking energy” for interacting with the non-visible markings such as “edge markings” (such as 70-3s-ir1, 70-3b-ir1, and 70-3a-ir1) and “bar code IDs” (such as 70-3s-ir2, 70-3b-ir2, and 70-3a-ir2).

As will be appreciated by those skilled in the art, by placing these non-visible light emitters 50-ir-led onto/into glasses 50, the non-visible (preferably IR and/or UVA) light field generated by these emitters 50-ir-led is ideally spatially located so as to illuminate the view substantially in front of the player currently wearing glasses 50, where this player-glasses-view may comprise any of game portions such as playable cards 70-3 in or not in a current card hand 70-h, game piece bases 8c, game boards 10-3, 10-4, 10-5, and 10-6, game board overlays 11-3, figurines 8a, wearbles, etc. Glasses 50 preferably also comprise one or more imaging sensors capable of detecting any of the non-visible tracking energy currently being emitted by light emitters 50-ir-led, where for example the tracking energy is NIR and the imaging sensors are filtered to substantially only receive the NIR energy within the limited spectral response anticipated for the non-visible markings.

One exemplary NIR non-visible ink is sold by MaxMax in two variations referred to as “IR1” and “IR2” inks. Both inks are fluorescers and as such absorb light over a first spectral range (often including visible light) but then readmit this light over a “shifted” second spectral range that is substantially non-visible. The MaxMax IR1 light is claimed to readmit over the “full width half maximum” (FWHM) range of roughly 790 nm to 840 nm and thus substantially non-visible. The MaxMax IR2 light is claimed to readmit over the “full width half maximum” (FWHM) range of roughly 815 nm to 855 nm and thus also substantially non-visible. There are many other non-visible UVA and NIR substances available in the marketplace as will be familiar to those skilled in the art of non-visible substances and non-visible imaging systems.

Referring next to FIG. 3K, there is shown a perspective drawing from the viewpoint of a card game-player looking though further adapted AR glasses 50 at any of “game portions” such as their playing hand 70-h comprising one or more playable game cards 70-3 and then also possibly any of a passive or active game board 10-3, 10-4, 10-5, or 10-6, with or without a game overlay 11-3 (not depicted). Playable game cards 70-3 and any of boards 10-3, 10-4, 10-5, or 10-6 preferably comprise non-visible markings that are detectable using image processing by glasses 50 for locating non-visible fiducials such as “IR landmarks” 10-1r1-1, 10-1r1-2, and 10-ir1-3, where using at least in part the detected fiducials/landmarks glasses 50 provide visible augmentations for the player to any of the “game portions” such as card 70-3 augmentation 70-h-ar, or game board augmentation 10-ar.

Those familiar with image processing in general, but more specifically image processing for use with graphic overlays such as AR augmentations, will understand that determining what objects are in a scene and are currently being imaged can be complex, especially when the cameras are free to be moved about to virtually any perspective in the scene, when this movement can be abrupt and quick, when the ambient lighting is uncontrolled with unpredictable luminance levels, and when the scene objects and scene background are substantially “unknown” to the image processing routine(s) (often referred to as “generalized scene processing”,) which are all challenges faced by traditional AR glasses further adapted as AR glasses 50. Those familiar with generalized scene processing will recognize that the present further adapted AR glasses 50 are anticipated for specific use in an interactive gaming system setting including any of the “game portions” as herein described, which then is no longer a “generalized scene” but a “specific scene,” and as such these game portions that are scene objects can be “pre-known” to the image processing and further include pre-known markings made with non-visible substances to provide a technical advantage to AR glasses 50 for locating and registering the pre-known game portions for use in providing subsequent AR virtual augmentations.

It is not the purpose of the present invention to teach the sufficient processing of generalized scenes or even “specific scenes,” for example teaching the types of data and means for representing “pre-known” objects (such as the current “game portions”) during image processing, as significant teachings are available in the art. What is important is to see that traditional AR glasses are anticipated for use with generalized scenes (and therefore are also anticipated for use without further adaptations with the present system,) and as such are presented with further challenges that can be problematic for providing the most pleasing visual augmentations when used with the present interactive gaming system for augmenting players views especially with respect to the “game portions.” Given the specific scene of one or more players playing with the present interactive gaming system (for use in board games, card games, and board and card games) comprising any of “game portions,” those skilled in the art of generalized scene processing will understand the significant benefits of being able to create specific pre-known object fiducials/landmarks for any of identifying game portions and/or denoting the surfaces of game portions.

For example, in the present depiction of card hand 70-h, the edges of cards 70-3 currently being held are more readily located during image processing due to the pre-known edge markings, as will be understood by those familiar with image processing. Preferably, after locating these pre-known edge markings (such as 70-3s-ir1, 70-3b-ir1, and 70-3a-ir1,) the specific scene (“gaming scene”) image processing as taught herein is then able to identify individual cards 70-3 being held within card hand 70-h by decoding ID markings (such as “bar code IDs” 70-3s-ir2, 70-3b-ir2, and 70-3a-ir2). As a careful consideration will show, once the edges and identities of the individual cards are determined by the specific scene/“gaming scene” processing herein taught, it is then possible to visually augment the view for example of a specific card 70-3, where for example the virtual augmentation is to cause the viewable card surface to appear to “glow” in a certain color, where any number of virtual augmentations are possible including providing textual information floating over or near the card.

Those familiar with image processing and card game-play, will also understand that it is alternatively possible (or possible in combination with the non-visible IDs) to identify a specific card 70-3 being held in a card hand 70-h by processing the image of the card surface within the set of edges defining its “viewable surface” (where this “set of edges” comprise the visible edges of the particular card itself, as well as the edges of any neighboring/overlapping card, all as a careful consideration of the present depiction will make clear). As a careful understanding of the present invention will also show, while there may be many possible unique cards 70-3 (often thousands) for use in a particular card game such as Magic the Gathering, the system is able to determine the specific few cards currently being held in card hand 70-3. By having prior determined this set of few current in-hand cards 70-3, the specific gaming scene processing can then select from a set of images for example of all card 70-3 “faces” only those face-images for cards currently being held in hand 70-3, where then the gaming scene processing can use image processing to efficiently compare the viewable surfaces of each of the current cards 70-3 within the hand 70-3 to the pre-known card-face images as a means of identification, all as will be well understood by those familiar with image based object identification to a pre-know object image.

Still referring to FIG. 3K, there are shown a multiplicity of exemplary markings/fiducials/landmarks such as IR landmarks 10-ir-Im depicted as “+” symbols. Those familiar with image processing especially for graphic overlay registration, will understand that preferred fiducials/landmarks include sharp edge lines, intersections and corners that are typically easier to locate within an image using traditional image processing algorithms (as opposed to non-sharp and curved lines,) where corner shapes such as “\hat{ }”, “<”, “>” and crosses “+” are preferable and can be implemented by placing non-visible markings such as 10-ir-1, 10-ir-2, and 10-ir-3 onto the game portion surfaces, such as any of a game board 10-3, 10-4, 10-5, 10-6. It is again noted that non-visible (such as IR) markers such as 10-ir-1, 10-ir-2, and 10-ir-3 may be either of substantially reflective or substantially absorptive of the non-visible tracking energy being emitted by glasses 50 (see FIG. 3J). Those familiar with image processing will also understand that pre-known images of game portions such as game boards 10-3, 10-4, 10-5, 10-6 and any of game overlays 11-3, can be pre-known to the system and therefore the gaming scene processing, where these pre-known images include the relative locations of preferably all fiducials/landmarks 10-ir-Im.

Similar to the multiplicity of possible game cards 70-3 from which a few select game cards 70-3 are identified by the system as currently being held in a hand 70-3, the present system is able to identify the specific game board 10-3, 10-4, 10-5, 10-6 and any game overlay (from a multiplicity of possibilities,) thus allowing the system to select the pre-known images representative of the currently used game board and possibly game overlay, where then this/these selected pre-known image comprise the locations of expected fiducials/landmarks 10-ir-Im, greatly assisting the efficient and most accurate gaming scene processing and then AR augmentation, all as will be well understood by those familiar with image based object identification to a pre-know object image.

As a careful reader will also see, by marking any of game boards 10-3, 10-4, 10-5, 10-6 and/or game overlays 11-3, it is then possible to determine a current location of a game piece base 8c (which may also be marked using the non-visible markers) as placed for example on a game board or game overlay, where then using a “mapping” that now relates logical game board and/or overlay locations (such as logical overlay location 11-3Ln, see FIG. 3I) with the non-visible markings such as 10-ir-1, 10-ir-2, and 10-ir-3 or the image processed fiducials/landmarks 10-ir-Im, it is possible to use further adapted glasses 50 to first determine a current physical location of a game piece base 8c or laid down card 70-3 and then to map this current physical location to a current logical location for use at least in part by preferably a game app running on a computing device such as tablet 15 or smartphone 17 as current game state data, where this game state data has many anticipated and possible uses as described herein and within the referenced PRIOR ART.

Those familiar with game-play will understand that it is also possible to use pre-known “visible” surface markings of game portions such as game boards and game overlays, either alone or in combination with the non-visible markings 10-ir-1, 10-ir-2, and 10-ir-3 and landmarks 10-ir-Im, to be included in the herein taught game board/overlay, logical-location to visible and/or non-visible markings map, and as such this mapping data is valuable for translating visually determined “physical locations” to game board and overlay “logical locations,” where visually determined is understood to be based upon image processing as opposed to wireless electronics such as described with game boards 10-3, 10-4, 10-5, 10-6. It will be further understood that these apparatus and methods can also be combined, for example to increase game piece and card location tracking accuracy.

And finally with respect to FIG. 3K and regarding the non-visible markings, as a careful reading of the cross-reference parent application will show, and as those familiar with both non-visible markings and image processing will understand, it is possible to concurrently implement multiple different non-visible markings, where each marking substantially operates over its own unique spectral range that is preferably non-overlapping with other non-visible markings at least within the FWHM of the unique spectral range. In one example, a first non-visible marking is in the UVA spectral range while a second non-visible marking operates in the NIR spectral range. In another example, two different IR markings “IR1” and “IR2” both operate in the NIR spectrum, and may even be overlapping in their FWHM spectral responses, but otherwise then have sufficiently different peak frequencies, where then the image sensor for example has multiple pixels filtered to substantially absorb light centered at these different peak frequencies and as such can differentiate the different markings, all as will be understood by those familiar with the image processing of non-visible markings.

Referring next to FIG. 3L, there is shown a top-view depiction of a playable game card 70-3 comprising the combination of a fluorescent game card 70-3b-fl inserted into a switchable window game card sleeve 70-3s-sw. Card 70-3b-fl is preferably coated with a UV fluorescent coating 13-5nv for absorbing a non-visible, such as UVA energy emitted by further adapted glasses 50 (see FIG. 3M,) and then readmitting visible light to be perceived by a card game-player. The interested reader is directed to the present application's parent application as identified in the cross-referenced art section. The parent application provides significant teaching related to “special coatings 12g” comprising fluorescent substances, amongst other types of substances.

There are many types of fluorescent substances well-known in the art, for example “Alexa Flour” dyes sold by Thermo Fisher Scientific that absorb in both the non-visible spectrum UVA spectrum and readmit in the visible spectrum. Other suppliers such as NCC specialize in the manufacturing and otherwise sale of invisible/“non-visible” UV/IR fluorescers that absorb in the UV and IR portions of the spectrum but then reemit/fluoresce as visible light. The present invention should not be limited to any particular fluorescent material, e.g., fluorescent game card 70-3b-fl may comprise coating 13-5 that is either a “UV” coating (i.e., absorbs substantially non-visible UV light and then readmits substantially visible light) or an “IR” coating (i.e., absorbs substantially non-visible IR light and then readmits substantially visible light). However, as will be discussed it is important to match the absorbing energies with the “switchable window” to be discussed shortly, thus the window must comprise an electronically switchable substance that either substantially transmits or substantially blocks the energy to be absorbed by the fluorescent coating 13-5, while than always substantially transmitting all visible energy.

Still referring to FIG. 3L, switchable window sleeve 70-3s-sw is preferably coated with an electronically switchable electrochromic coating 13-4c that is capable of electronic switching between a state of substantially blocking any non-visible (such as UVA, or NIR) energy emitted by glasses 50, and a state of substantially transmitting the emitted non-visible energy, such that when in the transmitting state game card 70-3b-fl is caused to fluoresce the transmitted non-visible energy as visible light to be perceived by a player. Again, coatings such as 13-5nv and 13-4c are discussed in the related parent provisional application 63/399,338.

What is important to see is that an electrochromic material undergoes a molecular state transition when a (relatively small) voltage is applied that alters the spectral response of the material, where this altering can be employed as a means for either substantially transmitting or substantially blocking any of the light frequencies that are alternatively “operated” upon (i.e., transmitted, absorbed, reflected) by the different states of the electrochromic coating. Several materials are known that effect changes in the visible spectrum, thus are usable as visible spectrum “light transmission windows.” However, what is preferred is that regardless of their “switched on” or “switched off” current state of the electrochromic coating 13-4c, a substantial majority of the visible spectrum is still transmitted, thus allowing a player to continually see and recognize the underlaying card 70-3 regardless of the coating 13-4c′1 current state (although it is noted that some changes in underlying card 70-3 visible colorization due to the state transition of coating 13-4c's effect on visible light transmisivity are considered to be acceptable, as the resulting “glowing” card effect is anticipated to be the dominant perceived experience).

What is preferred is that the electrochromic window 13-4c substantially operates to transmit or not transmit non-visible UVA energy, where then when transmitted the preferred game card 70-3 coating 13-5nv will absorb this UVA energy for readmission (fluorescing) in the visible spectrum. The parent application to the present application identifies for example electrochromic materials such as “Compact WO3” (CWO3) and “Porous WO3” (PWO3,) where in particular Compact WO3 substantially blocks UVA energy when switched on, and substantially transmits UVA energy when switched off, while then also substantially transmitting all visible light when switched on (the “non-glowing” state in which it is preferred that the player perceive the truest colorization of the game card 70-3,) but somewhat absorbing the visible wavelengths in the switched off state (and thus the game card 70-3 will be perceived by the player as changing its colorization by either “appearing more dim” and/or appearing “less blue.”)

It is noted that the fluorescent coating 13-5nv can be chosen to readmit visible energy centered at different visible peak frequencies, such as within the range of “visible red” which is substantially fully transmitted in the switched off state. Using this preferred combination of an electrochromic material 13-4c forming a non-visible “UVA” switchable window, and fluorescent coating 13-5nv for converting the UVA energy into visible red, a careful consideration will show that game card 70-3 will appear to be substantially a “normal” colorization when the window is switched on (and thus also not “glowing red,”) but will appear dimmed and glowing red when the window is switched off.

Still referring to FIG. 3L, electrochromic substances such as CWO3 or PWO3 can be switched between states using a relatively small electric voltage as can be supplied by using for example a technology generally referred to as “printed electronics,” where an advantage of printed electronics is that they can provide any of controller circuits 70-cir, energy sources 70-esrc (i.e., batteries,) and antennas 70-eha (that can receive and “harvest” energy for either directly powering the circuits 70-cir or recharging the energy source 70-esrc) that are often less-than-paper thin and can be incorporated for example onto flexible plastics and paper. The purpose of the present invention is not to teach improvements in any of these printed electronics (or similar) technologies, but rather to teach a technical advantage for providing a game card sleeve 70-3s-sw comprising any combination of various possible circuits 70-cir, and/or energy sources 70-esrc, and/or antennas 70-eha sufficient for allowing the game card sleeve 70-3s-sw to supply voltage for operating the switching on and off of the states of the electrochromic window 13-4c, where many technologies are possible and anticipated to be developed in the future, where any of these sufficient technologies may or may not be classified as “printed electronics” but will non-the-less share key properties such as being “thin” and often flexible for use with materials such as plastics and paper, all as will be well understood by those familiar with printed electronics, wearable electronics, thin film electronics, etc.

The interested reader is directed to companies such as ButlerTechnologies, KordSA, Advanced Optical Metrology, and Memtronick for more information on thin-film flexible electronic circuits (usable as circuits 70-cir,) to companies such as IDTechEx, Molex, and Renata Batteries for more information on currently available thin-film flexible battery technology (usable as energy source 70-esrc,) and to companies such as Ricoh and EEPower for more information on currently available thin-film flexible energy harvesting technology (usable as energy harvesting antenna 70-eha). And finally, it is noted that the teachings provided regarding FIG. 3L with respect to game card 70-3 are generally applicable to all other game portions such that game boards, game board overlays, game piece bases, and game piece figurines (all defined as “articles 12” in the parent application,) where any “article 12” as taught in the parent application can be coated using a special coating 12g comprising for example an underlying fluorescent layer that is substantially transmissive to visible light but that can be caused to emit or “glow”/fluoresce visible light when exposed to non-visible energy (such as UVA) and further comprising an overlaying electrochromic window layer for then electronically controlling when any such non-visible energy is transmitted to or blocked from reaching the underlying fluorescent layer. Thus, the present teachings should not be limited as simply applying to game cards 70-3, as a careful consideration will show that any game portion as discussed herein or in the crossed-reference PRIOR ART can also be so coated for achieving similar controllable game-effects.

Referring next to FIG. 3M, there is shown a perspective drawing of AR glasses 50 that are further adapted to include one or more non-visible (such as and preferably UV) LEDs 50-uv-led for emitting non-visible and preferably UVA energy to be controllably transmitted through switchable window sleeve 70-3s-sw for receiving, absorbing and readmitting (thus fluorescing) by fluorescent game card 70-3b-fl coating 13-5nv (see FIG. 3L,) where the fluorescing is then perceived by a player as playable game card 70-3 appearing to “glow.”

As a careful consideration of the teachings provided herein as well as the parent application will show, it is possible that further adapted AR glasses 50 comprise both non-visible light emitters 50-ir-led such as IR LEDs for use in illuminating any of non-visible markings such as card 70-3 edges 70-3s-ir1, 70-3b-ir1, or 70-3a-ir1 or identifiers 70-3s-ir2, 70-3b-ir2, or 70-3a-ir2 (see FIG. 3J) as well as the presently depicted non-visible light emitters 50-uv-led such as UV LEDs for use in illuminating fluorescent coatings 13-5nv, although those skilled in the necessary arts will understand that variations are possible where card 70-3's non-visible edges and identifiers are illuminated with one or more narrow bands of UVA or one or more narrow bands of NIR, and where card 70-3's fluorescent coating 13-5nv is illuminated with one or more narrow bands of UVA or one or more narrow bands of NIR. Thus, the present depictions should be considered as exemplary rather than as limiting, as may variations are possible without departing from the teachings presented herein, where it is even possible that the various NIR and UVA coatings as well as electrochromic coatings are provided in different combinations of layers causing different combined spectral responses, all as especially taught in the parent application with regard to “special coatings 12.”

FIG. 4 is a table showing various game piece base 8c configurations 8c-1, 8c-2, 8c-3, 8c-4, 8c-5, 8c-6, 8c-7, 8c-8, 8c-9, and 8c-10, each comprising different combinations of components including touch UI/buttons 8c-ui, visual output 8c-vo, audible output 8c-ao, processor/power 8c-prc, global data, wireless comm port 8c-Gcom, electronic tag(s) 8c-tag, electronic tag reader 8c, antenna switch 8c-ants, antenna 8c-ant, absolute orientation sensor 8c-aos, relative orientation sensor 8c-ros, local data comm port 8c-Lcom, top surface visualization 8c-dec, and bottom surface visualization 8c-dec, where the various game piece bases 8c work in combination with any one or more of “passive game board 1” 10-4 using electronic tags, “passive game board 2” 10-6 using magnets, “passive game board 3” 10-7 using electronic tags and magnets, “active game board 1” 10-3 using underside electronic tag readers, and “active game board 2” 10-5 using side electronic tag reader arrays.

The reader is directed to the other figures and descriptions provided herein that discuss the functionality of the various possible game piece components (see especially FIG. 3A) as well as game boards such as 10-3, 10-4, 10-5, and 10-6. As will also be clear to those skilled in the art of electronics, it is possible to add additional components beyond those list in the present table to any configuration of a game piece base 8c, in any form or shape, such that the present table is not meant to exclude additional components but to teach useful minimum variations of core components especially as those components interact with any of game portions including game boards, game cards, other game piece bases, as well as game piece figurines and wearables. And finally it is also noted that for exemplary teaching, configurations 8c-1 and 8c-6 are used with the upcoming figures and descriptions as representative of ways for digitizing different game-play mechanics using different game piece 8c configurations, where configuration 8c-1 includes fewer components and represents a more “minimal” functionality (for example excluding touch UI/buttons 8c-ui, visual output 8c-vo, audio output 8c-ao and any orientation sensors including absolute sensor 8c-aos and relative sensor 8c-ros, while further only having one NFC read antenna 8c-ant “facing downward”,) and where configuration 8c-6 includes additional components and represents a more “extended” functionality (for example including visual output 8c-vo, audio output 8c-ao and a relative orientation sensor 8c-ros, while further having two NFC read antennas 8c-ant, one “facing downward” and the other “facing upward,” the selection of each controlled through antenna switch 8c-asw). Game piece base configurations 8c-1 and 8c-6 are being used for exemplary purposes, and the careful reader will understand that other game piece base configuration that are not used herein for exemplary teaching have significant benefits that are made obvious by a careful reading of the present invention, where then it is also understood that the invention teaches a “platform” where many different game portions including game piece bases 8c are expected to be used in the marketplace in different configurations, thus be the “preferred” configuration for a given technical problem set.

Referring next to FIG. 5A, there is shown a flow chart of card game tracking system 100 comprising devices and apps 100-da for use in sensing and transforming physical card game mechanics 100-gm into game data and rules 100-dr. Data and rules 100-dr are usable with a game app 200-15 that provides game mechanics and rules processing as well as game app 200-1 that provides situational advice/help, such that the combination of game apps 200-15 and 200-1 provides for customized game information and virtual augmentations synchronized with, and situationally relevant to, each player's physical game play experiences, where the game information and augmentations are provided via one or more computing devices such as tablet 15, smartphone 17, or AR glasses 50. Card game tracking system 100 works with both non-unique deck card games such as Poker and Uno, as well as unique deck card games such as the exemplary Magic the Gathering game. As will be understood by those skilled in the art, in unique deck card games such as Magic the Gathering there are typically thousands of possible cards available in the marketplace, where each card has different “card-values” for combining with other cards into possible “game plays,” where the virtual limitless combination provides significant never-ending possibilities for the players, but also creates a significant barrier to entry/learning curve that limits game adoption and player experiences.

Now referring to the flow chart of FIG. 5A in overview, the chart is arranged as three interconnected vertical columns, where the middle column represents the steps (labeled as “100-x”) of traditional and typical physical card game play, where each of the steps “100-x” includes one or more detectable physical actions taken by the players to manipulate the game cards, and where these detectable physical actions are herein referred to as “game mechanics” 100-gm. The leftmost column provides for a number of specific devices and apps (labeled as “200-x”,) where some of these apps “200-x” are shown in the rightmost column for clarity, and where devices and apps “200-x” transduce the physical actions of the game mechanics into “mechanics data” which is then further transformed into “game data.” “Devices” “200-x” are shown in solid outline shapes whereas “apps” “200-x” are shown in dashed outline shapes. The rightmost column depicts this game data and game rules (labeled as “300-x”) as well as expected providers of at least some related data (labeled as “400-x”).

Each of game play steps 100-1 through 100-19 comprise a specific one or more mechanics (physical actions taken by the player) that are transduced into sensed electrical signals by a specific game device or game app 100-da, as indicated by an arrow pointing from the specific step to a specific device or app 100-da. In some of the steps 100-1 through 100-19 a player may receive game information and/or virtual augmentations from or caused by a game app 200-1 (“situational advice/help”) or 200-15 (“mechanics and rules processor”,) which is indicated by an arrow pointing from the specific game app 100-da to the specific step. While the intention of the flow chart with it various symbols and directional arrows is to help best teach the present invention, those familiar with software systems and design, as well as flow charting, will recognize that in actual implementation various depicted separate components (shown as flow chart shapes) may be combined or sub-divided, and that connections shown in one direction may in actual practice also flow in the opposite direction (thus a two-way data exchange,) and as such the present flow chart should be viewed as instructive but otherwise not limiting to the various ways of actually implementing the herein taught many devices, game apps, and datasets.

Now referring to the flow chart of FIG. 5A in detail, following along with the middle column comprising card-play game mechanics 100-gm, a first step 100-1 includes acquiring cards for a deck preferably using game app 200-15 that provides mechanics and rules processor and is adapted to assist the player in either connecting to a game card purchasing site (such as associated with a card manufacturer or distributor,) a card trading site or similar, or allowing the player to indicate card purchase information which is then recorded by the app 200-15 in the available card inventory 300-1. Thus, in step 100-1, a player purchases, trades for, or otherwise receives one or more cards to start or add to their game card inventory 300-1. Many card games use a single shared card deck while for other games such as Magic the Gathering, each player (typically two players) has acquired and uses their own deck. In some cases, like traditional poker, a deck comprises a uniform set of cards (in this case “52 cards”/“4 suits”) that are always used for each and every game-played, regardless of who is playing (herein referred to as a “non-unique deck”). In other games like Magic the Gathering, there can be thousands of cards in the marketplace to choose from/acquire for building a card inventory, where a minimum deck is formed from this card inventory for each game, where the formed deck (herein referred to as a “unique deck”) typically requires 30 to 60 cards. In both cases, as well as all other types of cards and decks, what is important to see is that physical game-play cannot be started without a proper deck.

A technical advantage of the present system is to provide to the player card acquisition and valuing advice substantially during step 100-1, where the advice is preferably provided by a situational advisor/help game app 200-1 that preferably has access to manufacturer & marketplace card data 300-2, player and card playmetrics 300-16, the player's current available card inventory 300-1, as well as advertising data 300-5. As will be clear to those familiar with unique deck card games such as Magic the Gathering, the card acquisition and valuing advice provided by app 200-1 to the player has significant benefit especially when a very large multiplicity of distinct cards are available in the marketplace.

Those familiar with card games will understand that typically for both unique and non-unique deck card games each distinct card has a visually-distinct “card face,” where the visual distinctions in a card face may be decorative but also typically are indicative of “card-play values.” Card-play values are typically tied to the look of a card in some way, where the look for example may include pictures, symbols or text, (herein referred to collectively as “value indicators”,) and where these value indicators are interpretable by the players as conveying game-play meaning, which for a standard 52 card (“non-unique”) poker deck includes for example symbols for “hearts” vs. “spades” as well as numbers such as “6” “7” “10” or letters such as “J” “Q” “K” and “A”.

In the exemplary unique deck game Magic the Gathering, the “card face” of each distinct card comprises typically 7 different sets of one or more value indicators, the 7 sets including: 1) name of card, 2) card type, 3) static abilities, 4) power/toughness, 5) triggered/activated abilities, 6) casting cost, and 7) set symbol/rarity. Each of these 7 different sets of value indicators has a specific understanding and interpretation with many possible values for each indicator, where a careful consideration will show that the permutations of possible values for all combined 7 sets supports a significant number of possible distinct cards for selection/acquisition by a player to add to their personal and available card inventory 300-1. Those familiar with the unique deck marketplace will also understand that new distinct cards with different card-play values are routinely introduced over time, and thus create an on-going ever-more-complex “card marketplace.”

(It is noted that while the present specification is using the card game Magic the Gathering as an exemplary unique deck card game, there are many other well-known or to be created unique deck and non-unique deck card games, where the present teachings apply to the playing of all types of card games, and while some card games will include game mechanics that are or will be different from Magic the Gathering, and/or are executed in a differing sequence, a careful consideration will show that the present invention may be generally used with any such unique or non-unique deck card game with a differing set of benefits for each different card game, where the digitization of game mechanics that are different from those discussed herein may be accomplished by an obvious use of the herein taught devices and apps 100-da or an obvious further adaptation of any of 100-da, and thus the present invention should not be limited to application with only Magic the Gathering or the herein discussed game mechanics 100-gm.)

Those familiar with unique deck card games will also understand that any two or more distinct cards will have different “combined” game-play values when used during actual game play. Considering Magic the Gathering, for any two or more individual cards (and not necessarily distinct cards) being “played” (for example determined by the mechanic of being “laid down” in step 100-9, subsequently moved in spatial relationship to each other or turned in step 100-11, and/or then joined with other cards via a “touching” action in step 100-13,) each played card possibly comprises a different combination of values (if distinct) from amongst the 7 different sets of card-play values, but in any case (distinct or not) some possible combinations and/or sequences of played cards becomes more advantageous than other possible combinations and/or sequences. Where understanding these possible played combinations is a significant and difficult to acquire game skill that is typically learned over time by a player, where the present system offers advantages for accelerating this learning for example using situational advisor/help app 200-1.

Still referring to FIG. 5A, players wishing to acquire new cards for a unique deck game may seek public forums or bloggers, YouTube reviews, etc., for more information on what the potential benefits of acquiring one card or set of cards might be, where then each new acquisition should be considered with respect to (hence for advantageously combining with) any cards currently already owned/acquired or otherwise being available in inventory 300-1 for the player's use. Further exacerbating the acquisition decision is that individual (but not necessarily distinct) cards may have different “rarities” and thus different market prices driven by their rarity. Still yet other distinct cards from earlier generations may have restrictions for game-play that are not easily known by the player, where situational advisor app 200-1 preferably has access to game rules 300-3 and is able to provide this card-restriction information to the player prior to the time of card acquisition. As a careful consideration will show, and as will be discussed in more detail, the present invention offers significant value to the marketplace at least when performing the step of acquiring cards for deck 100-1 by providing acquisition advice using advisor app 200-1 that has access to what is herein referred to as game data “300-x” including manufacturer & marketplace card data 300-2, player and card playmetrics 300-16, the player's current available card inventory 300-1, as well as advertising data 300-5.

Still referring to FIG. 5A, the data and services “300-x” aggregate four (4) key sources of information preferably about all cards available for acquisition including: 1) MFG and marketplace card data 300-2 comprising information from card manufacturers 400-1, 2) MFG and marketplace card data 300-2 comprising marketplace assessments 400-3 including pundit reviews and opinions, 3) player and card playmetrics 300-16 comprising game-play information such as historical assessments and results of actual player and card play referred to herein as playmetrics, where playmetrics 300-16 are derived at least in part from current game state 300-15 data aggregated over the many possible games being played across the marketplace using system 100, and 4) advertising data 300-5, for example ranging from card-related advertising to game-play training and services related advertising. Anticipated manufacturer's information 400-1 (1) included in game data 300-2 is an electronic dataset preferably representing each manufactured card and preferably including all relevant data for understanding the “card face” of each distinct card including in the example of Magic the Gathering, the particular values of all 7 different sets of possible values, thus being a digital representation of all information necessary to understand the use of the card during game-play. (It is noted that while the present invention designates this information 400-1 as being from the “card manufacturer,” as will be appreciated, the source of the information may be from any source including third-parties that are presumably working with the manufacturer or otherwise separately determining at least some of the information.) Preferably, each distinct card, with a given distinct card face representing a specific set of card-play values, will be manufactured in a certain quantity of 1 or more “instances” of the same distinct card, typically thousands to millions of instances of the same distinct card (especially in a non-unique poker deck for example a distinct card is an “Ace of Spades”).

What is also preferred is that each individual manufactured instance of a given distinct card includes a unique serial number or a substantially equivalent way of identifying the unique card (see the printed code 70-3a-pid or embedded code 70-3a-eid associated with manufactured cards 70-3a as shown in FIG. 1A). As will be shown, by giving each instance of each distinct card a unique identifier significant technical advantage is provided by the present invention for the game players by at least enabling the detection and tracking of the multiplicity of card game-play mechanics such as but not limited those anticipated herein in steps 100-1 through 100-19. However, there are currently a vast number of playing cards for use in both unique and non-unique decks being used in the marketplace today that do not comprise any such unique markings (see card without ID 70-3b in FIG. 1B). In such cases where the manufactured card is without ID (thus being card 70-3b,) is it then preferred that sleeves with ID 70-3s are made available in the marketplace into which a card without ID 70-3b can been inserted thus becoming a playable (trackable) game card, generally referred to herein simple as “playable card ID 70-3.”

It is considered advantageous that the sleeve 70-3s is optionally “sealable,” such that once a specific card without ID 70-3b is inserted into the sleeve 70-3, the sleeve 70-3s must essentially be destroyed in order to remove the card 70-3b. As will become more apparent during the upcoming discussion of player and card playmetrics 300-16 as well as published NFTs, p-NFTs 300-9, keeping an otherwise non-unique playing card 70-3b sealed within a unique sleeve with ID 70-3s provides the means for maintaining a digital record of the game playmetrics 300-16 (thus a “card provenance”) of the otherwise non-trackable card 70-3b, where amongst other significant benefits this allows for the selling of digital playmetrics information 300-16 as an NFT associated with the unique playable card 70-3b still sealed within 70-3s, where also the unique playable card 70-3 itself (such as card 70-3a with a unique ID, or card 70-3b without a unique ID but still sealed in a sleeve 70-3s with a unique ID) may be sold with the NFT, thus becoming what is herein referred to as a “p-NFT” (“physical” NFT, where physical refers to the physical card sold with the digital NFT asset).

Still referring to FIG. 5A, what will be shown is that by using this unique ID (such as a printed code 70-3a-pid or 70-3s-pid or an embedded code 70-3a-eid or 70-3s-eid) per each instance of a distinct playable card 70-3, each card instance 70-3 can be tracked throughout various game mechanics 100-gm such as comprising any one or more of steps 100-1 through 100-19, where this tracking results in a tracked current game state 300-15 that at least in part is usable for deriving player and card playmetrics 300-16. For any one or more games, playmetrics data 300-16 preferably comprises: 1) “card game-play history” pertaining to a given unique card instance 70-3 and preferably extending over the portion of a game where the unique card 70-3 is available to a distinct one or more players to play (for example being available starts for card 70-3 by being held within a player's current hand 70-h, see step 100-7) up until after the card 70-3 is no longer available to play (for example after card 70-3 has been discarded, see step 100-19,) where this “available to play portion of the game” is designated in the present figure as game play 101, in this example comprising steps 100-7 through 100-19, and 2) “player game-play history” pertaining to a unique player comprising associations with all “card game-play history” (1) of any and all given unique card instances 70-3 associated with the unique player during a game.

It is again and further noted that the present invention 100, including tracking player and card playmetrics 300-16 is not limited to “unique deck” games such as Magic the Gathering, Legends of Runeterra, Inscryption, Monster Train, Gwent, and Eternal Card game, but also applies to “non-unique deck” games such Poker, Blackjack, Rummy, Contract Bridge, Solitaire, Hearts, Ascension, etc., all of which can be played using the traditional “52 card deck” (also referred to as a “standard deck”) as well as other non-unique deck games such as UNO, Exploding Kittens, Apples to Apples, and Dutch Blitz. As a careful consideration will show, in a non-unique deck game such as any game played with a “standard 52 card deck,” within each trackable non-unique standard deck there is one instance 70-3 of each of 52 distinct cards, where then each one instance 70-3 of a distinct card preferably has a detectable ID (such as a printed code 70-3a-pid or 70-3s-pid or an embedded code 70-3a-eid or 70-3s-eid) that is unique across all or some trackable standard decks available in the market, and thus player and card playmetrics data 300-16 can be accumulated even when different players are at different times using the same one instance 70-3 of a distinct card in an otherwise non-unique deck.

Thus, using the present invention 100, it is now possible to have complete game-play histories (card playmetrics 300-16) of specific unique cards 70-3, where the cards throughout their tracked history may have been played with by any one or more unique players (even switching unique players during a single unique game or between games). Additionally, it is now possible to have complete game-play histories (player playmetrics 300-16) of specific unique players, where the player's game play history includes data or is associated with card playmetrics data 300-16 for any and all unique cards 70-3 that the player has played with throughout their player tracked history (where it is understood that the player has in some way registered an identity to be tracked with the system 100, see also the cross-referenced PRIOR ART).

The advantages and opportunities provided by the use of the herein taught MFG & marketplace card data 300-2 and player and card playmetrics 300-16 are significant, including for example applying any of AI and machine learning to any combination of the game data 300-2 and 300-16, as well as current game state data 300-15 (to be further discussed shortly,) game rules 300-3 and profile & motivation data 300-4 so as for example to provide game player situational advisor/help using app 200-1. Situational advisor/help app 200-1 in general includes providing any of training, help or otherwise advice during any of play mechanics steps 100-gm such as when acquiring new cards in step 100-1, when selecting from acquired cards to form a current playing deck in step 100-3, when adding cards from the current playing deck (optionally shuffled in step 100-5) to a personal current hand in step 100-7, when laying cards down from a personal current hand onto a playing surface in step 100-9, when in some card games (such as Magic the Gathering) moving the location of, and/or rotating/“turning” the orientation of, any given laid down card to change its game status and provide game play meaning in step 100-11 (where this rotating for example from a substantially portrait orientation to a substantially landscape orientation is referred to as “tapping” in the game Magic the Gathering,) and when in some card games (such as Magic the Gathering) touching one card onto a laid down card to indicate that the two cards are “joined” thus combining their respective card-play values in step 100-13 (where this touching action is referred to as “casting an instant spell” in the game Magic the Gathering).

It should also be understood that other game play mechanics 100-gm are possible, especially when considering new card games to be developed, and also when considering the combination of board and card games addressable by the referenced PRIOR ART and the teachings provided herein, and thus the present game play mechanics 100-gm which are anticipated to cover a large portion of all mechanics for all card games, are not intended to be limited to those discussed herein, as other mechanics (game play “actions” and “motions”) are anticipated and may either be digitized using the apparatus and methods described herein, or using further adaptations to the apparatus and methods described herein, or using entirely new adaptations to the apparatus and methods than those discussed described herein, where in any case the present system 100 still provides its core functionality even when so extended to accommodate addition game mechanics.

As a careful consideration will show, situational advisor/help app 200-1 is useful for providing player services during game play mechanics 100-gm by preferably accessing and processing for example using any of traditional programming algorithms, newer AI or machine learning algorithms, any of manufacturer's and marketplace information 300-2, player and card playmetrics 300-16, or current game state 300-15. Situational advisor/help app 200-1 preferably also has access to player profile and motivation data 300-4 supportive of a gaming player motivation theory, where data 300-4 and its uses will be discussed in more detail later in the present application. Advertising data 300-5 is also accessible by app 200-1, where for example a player can be connected with any of game play services such as personal training.

Still referring to FIG. 5A, after having acquired in step 100-1 game cards (either with IDs 70-3a, or without IDs 70-3b) for comprising available card inventory 300-1, either already comprising a complete formed deck or usable for forming (assembling) a deck, where the deck is either a unique deck or a non-unique deck, game play may then (optionally) proceed to forming current deck from available cards step 100-3. In the case where some acquired cards are without IDs (i.e., cards 70-3b as opposed to cards with ID's 70-3a,) the step 100-3 of forming a deck may additionally comprise the use of game devices 200-3 for placing cards (such as 70-3b) into detectable sleeves (such as 70-3s). (The reader is directed to upcoming FIGS. 5B and 6B for more detail of the steps, devices and methods comprising placing cards in detectable sleeves 200-3.) In summary, placing cards in a detectable sleeve 200-3 primarily applies to cards without IDs 70-3b, whereupon after inserting into a sleeve with ID 70-3s the resulting playable card 70-3 with ID (see FIG. 1B) is substantially equivalent to cards with IDs 70-3a (see FIG. 1A) with respect to the game-play tracking apparatus and methods described herein.

Forming a deck in step 100-1 can be a significant undertaking, especially when playing a non-unique deck card game such as Magic the Gathering comprising a potentially large multiplicity (e.g., hundreds to thousands or more) of available cards in inventory 300-1, where all available cards are usable for forming a “current deck,” and where a current deck size for Magic the Gathering is typically only thirty (30) to sixty (60) cards, thus a small fraction of the potential inventory 300-1. During step 100-1 (or any other steps of game mechanics 100-gm,) situational advice/help may be provided to the player directly from a distinct app 200-1 being executed on a computing device such as a tablet 17 or smartphone 15, or may be provided through a single main game app such as mechanics and rule processor 200-15 that is executed on a computing device such as a tablet 17 or smartphone 15 and for example either includes the functionality of situational advisor 200-1, or invokes the functionality of situational advisor 200-1 for example where 200-1 is a service provided over the internet for access by app 200-15, all as will be well understood by those familiar with the software systems.

As prior stated, situational advisor/help functions 200-1 preferably access any combination of game data 100-dr (i.e., “300-x”) and applies any of software algorithms including traditional programming, AI and machine learning to determine and provide situational advice/help. As will be clear from a careful consideration, this step 100-3 of forming a current deck is typically skipped when playing a card game with a non-unique deck, such as a standard 52 card poker deck, or an UNO deck, for which no significant decisions are typically necessary.

Still referring to FIG. 5A, after having selected for example a non-unique deck (such as a “standard 52 card poker deck” with playable cards comprising IDs 70-3) or optionally formed a unique deck (such as a Magic the Gathering 60 card deck with playable cards comprising IDs 70-3,) in some card games the next step is to randomize/shuffle the deck 100-5. Card shuffler machines are well-known in the marketplace, such as manufactured or otherwise provided Yuanhe, Silly Goose Games, Crazy Games, SK Casa, Shuffle Tech, and many others. The present invention teaches the further adaptation of at least the future design of any of current marketplace shufflers to further comprise a playable card 70-3 ID reader, where for example if the card ID is implemented as the preferred NFC electronic tag 70-3a-eid or 70-3s-eid (see FIGS. 1A and 1B, respectively,) then the ID reader is any of well-known NFC tag reader, and where if the card ID is alternatively or additionally implemented as a printed code 70-3a-pid or 70-3s-pid (see FIGS. 1A and 1B, respectively,) then the ID reader is any of well-known scanner/camera apparatus.

It is not the purpose of the present invention to teach the specific structural adaptations to any particular card shuffler design for holding, powering, providing computer processing and communications (for preferably communicating with the game app 200-15 for processing mechanics data and rules,) and otherwise accommodating any of NFC and/or scanner/camera apparatus, all of which will be obvious to those skilled in the art of device design. Preferably, rather than further adapting each of the currently available card shufflers with the necessary ID readers, it is possible to create an independent card reader, such as a “sequential card ID reader/non-shuffler” that for example is adapted to receive into an input receptacle a pre-shuffled deck after which the received cards with IDs 70-3 are singulated through mechanical means from the input receptacle through the aforementioned necessary card ID reader(s) and then either back into the input receptacle or into an separate output receptacle, such that the sequential ordering of received cards 70-3 is not changed (i.e., not shuffled/re-shuffled) but the IDs of received cards 70-3 are read and preferably kept as data in a sequence matching the received card 70-3 ordering, all as will be well understood by those familiar with automatic card shufflers and otherwise mechanical designs and electronic devices.

As a careful consideration will also show, while it is preferable to minimally perform in the step 100-5 the reading of card IDs for all playable cards 70-3 forming either a unique or non-unique deck for communication to preferably the game processor app 200-15 and optionally the situational advisor/help 200-1 (if these are not implemented as a single module,) this is not strictly necessary in order for the herein taught system 100 to perform card game tracking and therefore also game state (300-15) tracking, since as will be seen in relation to upcoming step 100-7 for adding card(s) to current hand it is possible to essentially wait (i.e., skip card ID reading in step 100-3) and determine the ID of each card 70-3 as it is effectively being moved from the deck (or otherwise card pile) into a player's hand 70-h.

Still referring to FIG. 5A, after having optionally shuffled the deck of playing cards 70-3 (either automatically or manually,) and optionally determined via card ID reader means (either comprised within an automatic shuffler or comprised in a separate device) all IDs (preferably in shuffled sequence) for cards 70-3 comprising the current deck, the sequenced and read IDs are communicated to game processor app 200-15 and/or situational advisor 200-1. Typical game-play mechanics advance next to step 100-7 for adding card(s) to the current hand 70-h of a player. Adding cards to a player's hand 70-h comprises the use of devices and apps 200-7 to detect card added to hand (see especially upcoming FIGS. 5C and 6C for more detail of steps, devices and methods).

In summary, add card(s) to current hand step 100-7 comprises means for determining the card ID of a current playable card 70-3 being moved into the current hand 70-3, where then this next inserted card ID is preferably communicated to the game processor app 200-15 and optionally the situational advisor/help 200-1 (if these are not implemented as a single module,) where preferably the game processor app 200-15 then updates the current game state 300-15 indicating each next playable card 70-3 that has been removed from the current deck and moved into a player's current hand 70-h. (It is noted that typically cards 70-3 added to a player's hand remain “hidden” essentially by the way the player physically holds their current hand 70-h, such that substantially only the player can see the faces of the cards 70-3 comprising their card hand 70-h.) Note that as cards 70-3 are added to the current hand 70-h, it is possible for the situational advisor/help 200-1 to provide meaningful game-play information to the player holding hand 70-h, for example using any of associated computing devices such as 17 or 15, or AR glasses 50.

Still referring to FIG. 5A and step 100-7 as well as all game-play steps 101, it is noted that AR glasses 50 may be used at least in part to provide “step-appropriate information” to the player and/or visual effects such as providing a visual augmentation that is only perceived by the viewer looking through glasses 50 (see FIG. 3K, visual card augmentation 70-h-ar) or providing for example a “glowing” effect to a card that is perceivable with or without looking through glasses 50 (see FIG. 3M).

As will be understood by those familiar with AR glasses technology, while it is possible that all scene registration and augmentation type processing including image processing of any non-visible card markers such as borders 70-3a-ir1, 70-3b-ir1, or 70-3s-ir1 or IDs 70-3a-ir2, 70-3b-ir2, or 70-3s-ir2 or non-visible game board fiducials/landmarks 10-ir-Im can be executed by computing elements incorporated within the glasses 50, it is also possible to perform some or all of any such scene registration and augmentation through communication with a game computing device such as a tablet 17 or smartphone 15 that is preferably running the game processor app 200-15 and/or situational advisor game app 200-1. While it is preferred that scene registration and augmentation is performed by computing elements embedded within AR glasses 50, it is also preferred that at least any of the step-appropriate information to be provided for example through AR glasses 50 (including any of visual augmentations or audio output) is first determined and then communicated by the game app 200-15 and/or situational advisor 200-1 to AR glasses 50 for output to the player.

Still referring to FIG. 5A, after having added card(s) to a player's current hand in step 100-7, typically game-play mechanics advance next to step 100-9 for laying down card(s) to play onto any of a playing surface (such as game boards 10-3, 10-4, 10-5, or 10-6, or a no game board surface 10-1, see FIG. 6D). Laying down card(s) to play comprises the use of devices and apps 200-9 to detect card laid down (see especially upcoming FIGS. 5D and 6D for more detail of steps, devices and methods).

In summary, laying down card(s) to play in step 100-9 comprises determining at least the card ID for the playable card 70-3 being laid down, either determined at least in part by the game processor app 200-15 or determined separately by a gaming device such as a game piece base 8c, a wearable 9c, and/or a game board such as 10-3, 10-4, 10-5, or 10-6 for communication to the game processor app 200-15. Preferably, game processor app 200-15 and/or gaming device(s) also determine both a time (relative or absolute) of the event of being laid down as well as any of a distinct location amongst two or more possible distinct locations that the card 70-3 was placed upon the any playing surface.

Preferably, game processor app 200-15 then updates the game state 300-15 with at least the card ID of the playable card 70-3 that has been laid down, along with event timing (or some other indication such as event sequence) as well as any determined placed-upon distinct location, thus indicating that a playable card 70-3 has been removed from a current hand 70-3 and added to any one or more playable cards 70-3 already placed upon any of a playing surface. (It is noted that typically cards 70-3 that have been laid down upon a playing surface are now “in view,” such that substantially any player can see the face of the laid down card 70-3.) Note that as cards 70-3 are laid down upon any of a playing surface, it is possible for the situational advisor/help 200-1 to provide meaningful game-play information to any player, for example using game app's associated computing device such as 17 or 15, or AR glasses 50.

Still referring to FIG. 5A, after having laid down card(s) to play in step 100-9, for some select games such as Magic the Gathering, game-play mechanics optionally advance next to step 100-11 where a player spatially moves or turns a played card 70-3. In at least games such as but not limited to Magic the Gathering, the spatial location of played cards 70-3 with respect to either the playing surface or other played cards 70-3 (belonging to the player or their opponent(s)) conveys game play meaning. (For example, this spatial-relation-meaning is also true for non-unique deck games such as Solitaire, but not necessarily true for other games such as versions of Poker.) Moving and turning played cards 70-3 comprises the use of devices and apps 200-11 to detect move and turn of cards (see especially upcoming FIGS. 5E and 6E for more detail of steps, devices, and methods).

In summary, move/turn card(s) to change status step 100-11 comprises means for determining that a specific played card 70-3 resting upon any of a playing surface (such as 10-1, 10-3, 10-4, 10-5, or 10-6) has been any of 1) moved from a first detectable spatial location to a second detectable spatial location, where the change in location may indicate game play meaning, and/or 2) turned from a first rotational orientation such as “portrait” with respect to the player, to a second rotational orientation such as “landscape” with respect to the player, where the change in orientation may indicate game play meaning and for example in the game of Magic the Gathering this “card turning” is referred to as “tapping.” Any of played card 70-3 movement (1) and/or turning (2) as determined by devices and apps 100-da is preferably communicated to game processor app 200-15 and optionally the situational advisor/help 200-1 (if these are not implemented as a single module,) where preferably the game processor app 200-15 then updates the current game state 300-15 indicating any of the new location or orientation for the played card 70-3 along with the move/turn event timing (or some other indication such as event sequence). Note that as cards 70-3 are moved and turned, it is possible for the situational advisor/help 200-1 to provide meaningful game-play information to any of the game players, for example using any of associated computing devices such as 17 or 15, or AR glasses 50.

Still referring to FIG. 5A, after having moved or turned card(s) in step 100-11, for some select games such as Magic the Gathering, game-play mechanics optionally advance next to step 100-13 where a player touches a second card to a played first card to indicate that their card-play values are being “joined”/combined in step 100-13 (where this touching action is referred to as “casting an instant spell” in the game Magic the Gathering). Touching cards 70-3 to join values comprises the use of devices and apps 200-13 to detect touch to join cards (see especially upcoming FIGS. 5F and 6F for more detail of steps, devices, and methods).

In summary, touch cards to join values step 100-11 comprises means for determining that a specific played first card with ID 70-3 resting upon any of a playing surface (such as 10-1, 10-3, 10-4, 10-5, or 10-6) has been touched (or otherwise brought into a sufficiently close proximity) with a second card with ID 70-3, where the determination of touching is preferably based upon detecting a position (over a certain duration of time) of the second card that is determined to be spatially overlapping (or at least at a minimum distance from) that known spatial location of the first played card. Any touched cards 70-3 as determined by devices and apps 100-da are preferably communicated to game processor app 200-15 and optionally the situational advisor/help 200-1 (if these are not implemented as a single module,) where preferably the game processor app 200-15 then updates the current game state 300-15 indicating the IDs of the touched cards along with the touch event timing (or some other indication such as event sequence). Note that as cards 70-3 are touched and joined, it is possible for the situational advisor/help 200-1 to provide meaningful game-play information to any of the game players, for example using any of associated computing devices such as 17 or 15, or AR glasses 50.

Still referring to FIG. 5A, after optionally touching and joining any two cards 70-3 in step 100-13, typically game-play mechanics advance next to step 100-15 to determine played card(s) results based upon the current configuration of played cards from all competitors. (It is noted that it is also possible, especially in some games such as Magic the Gathering, that any of game-play steps 100-7 through 100-13 may first be repeated in any ordering according to game rules 300-3 prior to advancing next to step 100-15, and thus although not depicted in the present flow chart, especially game-play game mechanics and associated steps 101 may be combined, repeated, and conducted in many ways and as such the present invention should not be limited to the exemplary sequence of steps as many variations are possible without departing from the true spirit and scope of the present invention.) When executed, step 100-15 for determining played card(s) results preferably comprises the use of game rules processor app 200-15 to process all played cards according to game rules 300-3.

In summary, determine played card(s) results step 100-15 comprises executing any of game rules 300-3 available to game app 200-15 for determining and informing any one or more players of the outcome of the current played configuration of cards 70-3. (It is noted that game rules 300-3 are presumably made available by any one of or any combination of the game manufacturer, a game-play rules source, or otherwise a governing body.) It is not the purpose of the present invention to teach or focus upon any particular card game's rules 300-3, as these are all well-known in the art. However, it is noted that especially with respect to non-unique deck games such as Magic the Gathering, where the total marketplace available cards for use as playable cards 70-3 is significant and changing over time, the total possible permutations of card-values that become combinable during game-play are significant, thus making rules problematic to adjudicate, or stated differently, even if the rules per-se are well-known they can be difficult to implement or interpret due to the complexity of the net current combined card-values for consideration during step 100-15.

Those familiar with typically more modern software implementations of complex systems will understand that the ever increasing complexity of the inputs for consideration often leads to a burden for traditional “if-then-else” programming languages and “rules-based algorithms,” thus leading to the adaptation of newer software algorithms based upon what is generally known as machine learning that are for example directed to “categorization of similar features into groups” and “pattern matching,” where similar prior situations or configurations of inputs become useful predictors of a current state or “outcome.” However, while this type of newer machine learning has proven invaluable for dealing with complexity, it typically relies upon a larger body of prior “situations” (as “training data”) from which the categories and patterns can be “learned.” Those familiar with such machine learning (of which there are many types,) will appreciate that the present invention teaches the necessary methods and means for accumulating this larger body of game-play data (i.e., the accumulation, typically in a centralized database, of at least card playmetrics and optionally also player playmetrics all as comprised within data 300-16).

It is further noted that there are often tournaments for the more popular card games such as Magic the Gathering, where during these tournaments officials are present to participate in at least step 100-15 of determining played card(s) results. In this or similar cases, the determinations aided by human reasoning (therefore and for example the officials) are preferably captured by the system and indicated as data within the current game state 300-15 and/or the player and card playmetrics 300-16, but otherwise are made available to the machine learning algorithms as a part of the larger body of game-play data accumulated by the system. Thus, as those familiar with machine learning will understand, for the most complex and rules ambiguous situations, the machine learning algorithm can essentially learn from expert human reasoning and thus apply this added expert value through the use of game app 200-15 to a typical card game at which such officials/experts are not present or otherwise available. It is also noted that beyond the category of newer software referred to as machine learning, there is also a broader category generally referred to as “AI” (artificial intelligence,) which itself may include some of machine learning, where AI is herein also supported by the novel data collected by the system and thus anticipated for use at least during step 100-15.

Still referring to FIG. 5A and step 100-15 for determining played card(s) results, after determination of the results the game app 200-15 preferably collectively informs the players of these results, for example by presentation on a commonly shared device such as a tablet 17, or otherwise by the sharing of common or private information on a typically personally used device such as a smartphone 15 and/or AR glasses 50.

Preferably, game app 200-15 also updates the game state 300-15 with at least the results of the played cards 70-3, along with any of results-event timing or otherwise any indication of rule adjudication (such as sequencing) that could for example be useful for the aforementioned machine learning and AI. It is noted that at least game state 300-15 is a dataset that is either stored for local access by the game app 200-15 or is a remote dataset available for real-time access/updating, and that furthermore, game state 300-15 data is processed and used at least in part for determining any of player and card playmetrics 300-16, where the playmetrics 300-16 may also be updated in substantially real-time or otherwise non-real-time, and may be stored in any of a local or remote database. Furthermore, as card play results are determined and provided in step 100-15, it is possible for the situational advisor/help 200-1 to provide meaningful game-play information to any player, for example using game app's associated computing device such as 17 or 15, or AR glasses 50.

Still referring to FIG. 5A, after having determined played card results in step 100-15, at least for some select games such as Magic the Gathering, game-play results may require a next step 100-17 for updating/resetting a player's current hand based upon the results, where step 100-17 optionally comprises any of the physical moving of position or orientation of any of already played cards 70-3 that are currently laid down upon the any of playing surfaces, or the picking up and returning of a prior played card back into a current hand 70-h. After the determination of played card results in step 100-15, it is also possible for some games including Magic the Gathering, that any of prior played cards are to be discarded and thus considered no longer available for current game play, shown herein as a separate step 100-19 (although this could also be combinable as a step with update/reset hand step 110-17). Discarding played cards 70-3 is often a matter of spatially moving the card 70-3 to a specific playing surface location that can be implemented as a specific determinable location using the present system 100, and thus the detection of a played card 70-3 to now be present in a designated discard-location provides valuable game-play meaning.

A careful considerations of the teachings provided herein for the game devices and apps 100-da especially including 200-7, 200-9, 200-11, and 200-15, will show that these same devices and apps are usable for digitizing either or both of steps 100-17 and 100-19, where the present depiction simply includes the game devices 200-11 for detecting moving turn of card(s) 70-3, but where the present invention should not be exclusively limited. For example, determining that are prior played card 70-3 has been picked back up and placed into a current hand 70-3 can at least be accomplished using game devices 200-9 and 200-7, or even by implication simply device 200-7, all as a careful consideration will show. Moving a prior played card 70-3 from a valid played location into a designated discard location can at least be determined using game devices 200-11.

As a careful consideration of the present teachings will make clear to those familiar with card game play, and especially unique deck card game play, the present system 100 provides for many significant technical advantages which then in turn enable many significant benefits to the marketplace such as but not limited to: 1) providing situational advice and help that reduces barriers to game-play entry caused at least by the learning curves associated with game complexity, 2) providing game play tracking with rule adjudication that increases the speed and accuracy of game-play especially for complex games, 3) providing for the determination of player and card playmetrics that becomes valuable data for the application of AI and machine learning for enhancing many aspects of game play and understanding as well as being valuable data for sale as NFTs and p-NFTs, 4) providing means for virtual game augmentations and otherwise digital game information and play effects through computing devices including mobile computing devices, wearables, and AR glasses, 5) providing means for game play recording and live or on demand streaming, 6) providing means for ad insertion into any of (4) or (5), and 7) providing means for an automated opponent that especially when combined with the situational advisor is usable as a training service, where other advantages and benefits of the present invention 100 will be clear upon a careful consideration. As will also be clear from a careful understanding of the cross-referenced PRIOR ART and the new teachings provided herein, the present system 100 is adaptable for use with board games as well as board games that are combined with card games, and thus the various apparatus and methods taught for the present invention 100 should not be limited exclusively to card game tracking.

Referring next briefly to FIG. 6A and prior to proceeding with the detailed steps associated with each of the present invention 100's devices and apps 100-da, there is shown two exemplary game piece bases 8c-1 (on the upper left side) and 8c-6 (on the upper right side). Base 8c-1 and 8c-6 have components as listed in the components table of FIG. 4, where both bases comprise electronic tag readers 8c-tagR and a “downward facing” antenna 8c-ant for emitting an electric field 10-6-ef for communicating with electronic tags such as the preferred short-range NFC (near field communications) tag. Base 8c-6 has been further adapted to additionally comprise a second “upward facing” antenna 8c-ant as well as both a downward and upward facing magnetic field reader comprising the relative orientation sensor 8c-ros, where then base 8c-6 is additionally capable of detecting a magnetic field such as 10-6-mf-1 and 10-6-mf-2.

Still referring to FIG. 6A, on the bottom left side there is shown the PRIOR ART “passive game board 1” 10-4 comprising a matrix of preferably short-range NFC tags that can be detected by tag reader 8c-tagR and thus a relative location of a game piece bases 8c-1 or 8c-6 can be determined when used with board 10-4. On the bottom right side is shown an alternative “passive game board 2” 10-6 comprising one or more areas of varying magnetic field strength such as “magnetic field 1” area 10-6-mf1 and “magnetic field 2” area 10-mf2, where both magnetic fields are static as opposed to dynamic (where dynamic requires and energy source) and where these magnetic fields 10-6-mf can be detected by relative orientation sensor 8c-ros. Depending upon the implementation of magnetic sensors within 8c-ros, it is possible to determine the relative magnetic field strength of fields 10-6-mf1 for example versus another field such as 10-6-mf2, and thus a relative location of a game piece base 8c-6 can be determined when used with board 10-6.

The present invention further anticipates an alternative active game board that uses a matrix of row/col wiring so as to be able to generate either or both of 1) select magnetic fields in a single area of the board, or 2) multiple different strength magnetic fields in multiple different areas of the board, where using electronics the both the location and strength of the field can be varied at a rapid rate, all as will be well understood by those familiar with electronic circuits and the creation of varying magnetic fields based upon varying electric currents. It is anticipated that using an active game board comprising variable magnetic field areas, it is possible to perform a dynamic “search” for game piece bases such as 8c-6, where the active board sequentially alters the magnetic fields emitted in various game board areas such that ultimately each and every game piece base 8c-6 detects a magnetic field, possible of a different field strength exceeding a provided threshold, where then each game piece base 8c-6, along with the active game board, is in communication with the game app 200-15 such that game app 200-15 can associate the timing of the altered magnetic fields with the timing by the bases 8c-6 of these fields.

What will be evident from a careful consideration, is that it is possible to provide either of a passive or active game board with two or more distinct areas comprising a magnetic field of a given strength that is detectable by a game piece base such as 8c-6 comprising a magnetic field reader. Those familiar with both the electronic tag reader technologies used for “passive game board 1” 10-4 and the magnetic static and dynamic materials and circuit technologies used for a “passive game board 2” 10-6 or an active variation of 10-6, respectively, will also understand that a passive game board 10-4 will reasonably provide a finer granularity of detectable “physical locations” (one per each NFC tag, thus dependent upon the tag size which is currently in the millimeter's squared) than any implementation of a passive game board 10-6 based on static magnetic fields, although it is possible to use dynamic magnetic fields in an active game board alternative of 10-6 where the resulting size of the “physical locations” approaches that of a passive game board 10-4 based upon NFC tags. And finally, it will also be clear that it is possible and useful to combine at least a “passive game board 1” 10-4 with a “passive game board 2” 10-6 forming a “passive game board 3” 10-7 that comprises different overlapping “physical locations” detectable by the combinations of a tag reader 8c-tagR and a relative orientation sensor 8c-ros.

Referring next to FIG. 5B there is shown a flowchart of steps related to the use of the devices and apps for placing cards in detectable sleeves 200-3 as depicted in FIG. 5A associated with game mechanics step 100-3 for forming a deck from available cards. (The reader is also directed to the PRIOR ART cross-referenced U.S. Pat. No. 10,688,378 entitled PHYSICAL-VIRTUAL GAME BOARD AND CONTENT DELIVERY SYSTEM filed on Jul. 4, 2018, see especially the PRIOR ART FIGS. 9A and 9B along with the related specification.) It is first noted that in particular, this devices and apps 200-3 function of “digitizing” the association of a playable card without ID 70-3b with a sleeve with ID 70-3s in order to form a playable card with ID 70-3 may be carried out at any time, thus prior, during, or even after step 100-3 of forming a deck from available cards.

What is important to see is that it is necessary that step 100-3 result in a deck comprising preferably all and only playable cards with ID 70-3, as all other subsequent digitizing devices and apps comprising 100-da along with at least game-play mechanics 101 require cards with IDs 70-3 as a means of creating digital information in relation to unique cards for forming at least the current game state 300-15. What is also evident from a careful reading of the present and PRIOR ART teachings is that a card game manufacturer could provide cards with ID 70-3a and as such the need for performing the function 200-3 for placing cards in detectable sleeves is not necessary as cards with embedded or printed IDs 70-3a are playable cards with IDs 70-3 and therefore can be tracked as described herein.

Still referring to FIG. 5B, if as presumed a player wishes to play and track a card game but is starting with one or more “non-trackable” cards 70-3b without either of a printed ID or electronic ID (see FIG. 1B herein) then it is first necessary to insert this non-trackable card 70-3b into a trackable card sleeve 70-3s with either or both of a printed or electronic ID (see FIG. 1B). Thus, the first necessary decision as show in FIG. 5B is “does the card already have an NFC tag?” shown as step 200-3-1. It is noted that the PRIOR ART as referenced did also discuss that the face image of the otherwise non-trackable card 70-3b can also be used as a means of card-tracking, however this is problematic for at least two reasons. First, it requires the use of cameras and image processing, where for example a computing device such as tablet 17 or smartphone 15 executing the mechanics and rules processor game app 200-15 (see FIG. 5A) is used to capture images of the face of the otherwise non-trackable card 70-3b during substantially each of the game-play steps 101 (see FIG. 5A,) and while this is possible a careful consideration will show that the required effort for the players is most likely prohibitive. Second, a careful consideration will also show that while the image of the face of a card could be analyzed through image processing (preferably using a pre-known image face example) to determine the “distinct type” of the card (such as an “Ace of Spades” card in a non-unique standard 52 card poker deck or a “Zur the Enchanter” card in a unique Magic the Gathering deck) it is not then also possible to determine the specific “instance” of such a distinct card, where the instance requires some per-card-unique symbol, printed code or marking (visible, or non-visible such as taught herein) such as a PID 70-3a-pid (see FIG. 1A).

If and after a player determines that the card is essentially of type 70-3a comprising a determinable unique card ID (preferably an embedded electronic tag,) then assuming the card ID is electronically readable, the player proceeds to step 200-3-6 to then scan the NFC tag using an NFC reader either included for example with a computing device such as tablet 15 or smartphone 17, or in a companion game device such as a wearable 9c or game piece 8c (see for example FIG. 4C for possible game piece configurations including an electronic tag reader 8c-tagR,) where after scanning either directly by device 17 or 15 or via and in communication with a game device 9c or 8c, associated mechanics processor 200-15 preferably updates at least the available card inventory data 300-1 and in some circumstances where a current deck is being formed (i.e., in step 100-3 of FIG. 5A) then possibly also current game state 300-15. If the card type is determined in step 200-3-1 to be with ID thus a card 70-3a, but where the ID is a printed code 70-3a-pid rather than an embedded electronic tag, then step 200-3-6 alternatively comprises reading this printed code 70-3a-pid that can at least be accomplished using game processor app 200-15 that is capturing and processing an image of the card ID 70-3a-pid using a computing device such as 17 or 15.

Still referring to FIG. 5B but now also in combination with FIG. 6B, if a player determines that the card is without ID thus a card 70-3b, the first step 200-3-3 is to use app (200-15) to scan the face image (see “Step 1” and card image 70-3b-img of FIG. 6B) (or PID) on card 70-3b to determine through image processing a match of the card image 70-3b-img to a pre-known card image, or otherwise to process the image including or not including a PID to determine at least the unique “distinct card” type of the card 70-3b (all as will be clear to those familiar with image processing and from a reading of the present and PRIOR ART). Alternatively, it is also possible that the game processor app 200-15 comprises an interface for allowing the player to self-select the distinct type of card, for example by first selecting the type of card game deck, such as “Poker” or “Magic the Gathering,” after which any number of well-known user interface methods may be used to allow the player to search for the card 70-3b within a list for the selected card game deck type to for example choose “Ace of Spades” or “Zur the Enchanter,” respectively. In either case, step 200-3-3 of FIG. 5B, and Step 1 of FIG. 6B, results in game processor app 200-15 having determined the distinct type of the card 70-3b.

In the next step 200-3-5 of FIG. 5B, the player then uses game app 200-15 running on a computing device such as tablet 15 or smartphone 17 to scan the electronic tag 70-3s-eid comprised within sleeve 70-3s (see “Step 2” of FIG. 6B,) or alternatively scans electronic tag 70-3s-eid with a companion game device such as a wearable 9c or game piece 8c (see for example FIG. 4C for possible game piece configurations including an electronic tag reader 8c-tagR,) where after scanning either directly by device 17 or 15 or via and in communication with a game device 9c or 8c, associated mechanics processor 200-15 preferably updates at least the available card inventory data 300-1 and in some circumstances where a current deck is being formed (i.e., in step 100-3 of FIG. 5A) then possibly also current game state 300-15.

Still referring to FIG. 5B now onto step 200-3-7, and 6B “Step 3,” the player then inserts the otherwise non-trackable game card 70-3b into trackable sleeve 70-3s resulting in trackable game card 70-3, and depending upon the type of sleeve 70-3s preferably seals the card 70-3b into the sleeve 70-3s so as to essentially make permanent the relationship between the physical card 70-3b and the ID comprised within the sleeve 70-3s, all supporting the unique tracking of card instance 70-3b for example allowing for the sale of the actual “played-with-card” 70-3b (sealed within sleeve 70-3s) along with the digital record of the history of the card 70-3b (see the prior discussions on NFTs and “p-NFTs” as defined herein).

Referring next to FIG. 5C, there is shown a flowchart of steps related to the use of the devices and apps 200-7 for detecting that a playable card with ID 70-3 has been added to a player's current hand 70-h, as depicted in FIG. 5A associated with game mechanics step 100-7 for adding card(s) to a current hand. It is first noted that in particular, this devices and apps 200-7 function of “digitizing” the association of a playable card with ID 70-3 with a current player's hand 70-h in order to form a playable card with ID 70-3 may be carried out in virtually any sequence with respect to at least any other game-play mechanics 101 and furthermore has no necessary requirement as to where the playable card 70-3 has been taken/“drawn” from. For example, typically the card 70-3 to be added into a current hand 70-h is drawn from the current deck, but alternatively this card 70-3 could be taken/drawn from another player's hand 70-h, the playing surface, or any other location.

The reader will understand through a careful consideration that tracking the movement/change of a game object (such as a playable card 70-3, a game piece 8c, or a trackable figurine 8a with for example added 8c-tag) from an initial game location/state “LS1” to a second and then multiple subsequent locations/states “LSn” (thus a potential series of “A-to-B” transitions) can be minimally accomplished by determining the final “B” states and then assuming the initial “A” states to be the last known state (e.g., as recorded in the game state data 300-15). This understanding simplifies the task of the player during each next game object movement as the mechanics need only determine a new “final” position B and do not need to reestablish the “starting” position A. When starting a card game where the game object is a playing card with ID 70-3, the initial and first location (“LS1”) of the game object is typically assumed to be within the current deck (and therefore does not necessarily need to be confirmed or “digitized”).

Location/state transitions from this LS1/current-deck location/state typically include moving the card to a current hand (e.g., designated as “LS2”) or a playing surface (e.g., designated as “LS3”,) but any other location/state is trackable according to the teachings provided herein. Once in the LS2 position, a card might then be moved to LS3, or back to LS1, or into another player's hand, thus creating a distinction for example designated as LS2-1 (player 1's hand) and LS2-2 (player 2's hand). Other location/states to be tracked as described in FIG. 5A include a discard pile (e.g., designated as “LS4”). Within some location/states such as a playing surface (“LS3”) or even a current deck (“LS1”,) it is also possible to track the cards relative position with respect to other cards or the containing object itself (where the containing objects comprising cards 70-3 in these examples are the playing surface and the current deck, respectively). These relative positions (spatial location in the case of a playing surface as a container or sequential positions in the case of a current deck as a container) can be assigned sub-values, such as LS1-xxx.

What is important to see is not any specific nomenclature (such as “LS1-xxx”) used for representing the trackable locations and states (as many nomenclatures are possible,) but rather that there is an “A-to-B” progression that once understood can be applied to simplifying playable card 70-3 tracking. More specifically, once the initial possible “first location/state” (“A”) is digitized (or presumed) by the system, such as having determined which cards 70-h are in a current deck at the start of a game (which can be determined by the automated shuffler with ID reader devices and app 200-5, see earlier discussion in relation to FIG. 5A,) it is then only necessary to determine the next “B” state for any given card (e.g., “LS2” or “LS3”). Hence, the devices and apps 100-da are minimally configured to determine a “next location/state” (“B”) as opposed to first reconfirming the current location/state “A” and then digitizing the next location/state “B”. Thus, “A” is assumed as already indicated within the game state data 300-15. Hence, if a particular card 70-3 has a current location/state “A” as indicated and tracked in the current game state 300-15 (for example “LS1”) and a new location/state “B” is detected by any of the devices and apps 100-da (for example “LS2” or “LS3”,) then the game processor 200-15 updates the current game state 300-15 to the new state “B” from the current state “A” indicated in the data 300-15.

Regarding the determination of a first initial state “A” for starting many card games, which is typically any number of playable cards 70-3 being in single shared current deck (e.g., 52 cards in standard deck used in the game of Poker,) or alternatively being in both a first player's not-shared current deck 1 (e.g., 60 cards in the game of Magic the Gathering) and in a second player's non-shared current deck 2 (e.g., a different 60 cards in the game of Magic the Gathering,) the present teachings prefer the use of an automated shuffler with ID reader device and apps 200-5 as taught in several variations with respect to FIG. 5A. However, a careful consideration will show that the available card inventory 300-1, as determined by game processor 200-15 by several various alternative means as prior described, can be used as the first initial state “A”. By using the available card inventory 300-1, especially for non-unique decks like the standard 52 card deck, but also even for games like Magic the Gathering that might include 1,000 or more cards in inventory 300-1, it is then possible to simply detect when a playable card 70-3 (which is in the tracked inventory 300-1, location/state “A”) next becomes present in in some location/state “B”, which can for example be a player's hand (e.g. “LS2”) or a playing surface (e.g., “LS3”) and thus the location/state of being in a current deck is never necessarily tracked.

In one alternative operation, a standard deck such as a 52 card Poker Deck is contained in a deck box, where the deck box has a unique ID that is associated in a dataset with the unique IDs of all the 52 standard playable cards 70-3 comprising the deck and within the deck box. To start a card game play, a player uses game processor 200-15 executing on a computing devices such as 17 or 15 to first scan (or otherwise determine, such as by entering through a user interface) the deck box unique ID and then to obtain/retrieve the associated dataset indicating the IDs for all playable cards 70-3 comprising the deck box, where then this dataset becomes “A” in the current game state 300-15, which could be represented as either the available card inventory 300-1 or the current deck. In either case, the next determined location/state “B” for any given playable card 70-3 might for example be in a player's hand 70-h (“LS2”) or on a playing surface (“LS3”). Thus, determining the initial state “A” is shown to be a very simple operation using the present invention and card game tracking then moves onto any of game-play mechanics 101 such as adding card(s) to a current hand 100-7 or laying a card down on a playing surface 100-9. (It is again noted that when using an automated shuffler with ID reader device 200-5, the initial state “A” is not simply recorded in game state 300-15 as “in deck,” but rather as a “position 99” “in deck,” where this information is considered especially interesting when streaming a live game via app 200-21 and the watchers of the live game might be interested in for example seeing/knowing the next card available in the deck to be drawn by a player.)

A careful consideration will also show that it is possible for a player with a large inventory 300-1 of available cards to create multiple “starter decks” comprising a multiplicity of individual playable cards 70-3, where then the player using game processor app 200-15 might then assign names to these “starter decks” (where the names serve as a “deck box unique ID”) such that the player simply uses game app 200-15 to select the name of a starter deck after which game app 200-15 is then able to update the game state 300-15 to indicate that the pre-known (and pre-identified) cards 70-3 in the starter deck are to be set with a state of “in deck” (regardless of their physical state of shuffling). Many variations of a starting state “A” are herein shown as possible with others that will be obvious based upon a consideration of the present teachings, and thus the present teachings should be considered as exemplary rather than as limiting the present invention to any particular starting state “A” just as the next states “B” have many possible variations, some explicitly taught herein where others will be clear from a careful reading and consideration.

Still referring to FIG. 5C but now also in combination with FIG. 6C, prior to placing a playable card 70-3 into a current hand 70-3 (thus a second location/state “B”) in “Step 2” (see FIG. 6C) the player presumably and typically draws the playable card 70-3 from the current deck in step 200-7-1 (see FIG. 5C) (where then the current deck is a first location/state “A”, and where other first locations/states “A” are possible as prior discussed). A careful consideration will show that step 200-7-1 represents both the removal of the playable card 70-3 from location/state “A” (i.e., “pull card from Deck”) and then also the placing of the playable card 70-3 into location/state “B” (i.e., “tap on reader”), where tapping on the reader is represented in FIG. 6C as “Step 1”.

FIGS. 5C and 6C assume the preferred case where the card ID is electronically readable and thus the player scans the NFC tag using an NFC reader either included for example with a computing device such as tablet 15 or smartphone 17, or in a companion game device such as a wearable 9c or game piece 8c (see for example FIG. 4C for possible game piece configurations including an electronic tag reader 8c-tagR,) where after scanning either directly by device 17 or 15 or via and in communication with a game device 9c or 8c, associated mechanics processor 200-15 preferably updates the scan card ID 70-3 as “in player X's” hand within current game state 300-15. In this case as in others game mechanics, it is noted that individual players such as “X” versus “Y” in a two-player game, each preferably have access to and use their own computing device such as 17 or 15 executing a copy of the game processor app 200-15 associated with themselves (although a shared device is possible by players selecting turns,) and/or use their own game device such as wearable 9c or game piece 8c associated with their app 200-15 and thus also themselves, all as will be well understood by those familiar with computer systems and connected devices.

If the card ID type is alternatively a printed code such as 70-3a-pid rather than an embedded electronic tag, then “tap on reader” in step 200-7-1 (and “Step 1” of FIG. 6C) are implemented using any of the means described herein for capturing/scanning printed codes (visible or non-visible) such as bar codes, at least accomplished using game processor app 200-15 that is capturing and processing an image of the card ID 70-3a-pid using a computing device such as 17 or 15, or even any of a bar code scanner or magnetic code reader included within a game device 9c or 8c (see the discussion in relation to FIG. 3F).

Still referring to the combination of FIGS. 5C and 6C, after determining the ID of a playable card 70-3 the player proceeds to place the card physically into their current hand 70-3 in step 200-7-5 (also “Step 2” in FIG. 6C). In a preferred implementation, the process of detecting a card being added to hand 200-7 includes providing an indication to game app 200-15 that the player has either started “their turn” (for example because an opponent's turn has just ended as determined by game app 200-15 in step 100-15 or 100-17 of FIG. 5A, which assumes next placing cards 70-3 in their hand 70-h) or otherwise has requested to add cards 70-3 to their hand 70-h by an action such as tapping a user interface element comprised within the system to request/indicate that a card 70-3 that is being or has been scanned should be added to the current hand 70-3. The tapped user interface element can be a software button implemented in game app 200-15, or a hardware button on a gaming device 9c or 8c, with other variations possible as will be clear to those familiar with computers and devices. And finally, in step 200-7-3, the game processor app 200-15 updates the game state 300-15 to indicate that determined card 70-3 has been added to a specific player “X”'s hand and preferably also the time of this event.

In another variation, game piece bases 8c have different physical looks or designs, where for example a first game piece base 8c has a certain distinct shape and/or look such that the player recognizes the first base 8c as a “add-card-to-hand” detector, such that during the present step 100-7 the first base 8c is remaining at a certain location as determined by the convenience of the player, the first base 8c is in communications with the game processor app 200-15, and the player simply draws as card 70-3 from the current deck and without needing to move the first base 8c touches the drawn card 70-3 to the first base 8c, whereupon the first base 8c reads the card 70-3's ID for communication to the game app 200-15 and the game app 200-15 preferably provides a perceivable indication that the card 70-3 has been detected, such as by emitting a visual or audible signal, and/or by causing the first base 8c to emitting such a signal assuming the base has sufficient video 8c-vo and/or audio 8c-ao output means.

It is then also desirable to have a second base 8c with a sufficiently different shape and/or look such that the player recognizes the second base 8C as a “laid-down-card” detector, such as would be used in the upcoming step 100-9 for determining that a certain card 70-3 with a given ID has been moved onto a playing surface (see the discussions with respect to upcoming FIGS. 5D and 6D). As a careful consideration will show, by using two otherwise similar (but not necessarily the same configuration) game piece bases 8c, the first base 8c may substantially remain stationary through game-play so as to make a common place for the player to easily reach out and “tap” the card 70-3 being drawn (presumably) from the current deck, where such card 70-3 tapping on the first base 8c that is electronically identifiable to the game processor 200-15 as the “add-to-card-detector” (e.g., it has a registered unique ID) is interpreted by app 200-15 as adding the detected card 70-3 to the player's current hand 70-h. Thus, the second base 8c (also uniquely identifiable to the game app 200-15) which has a need to be moved about to more positions remains separately and conveniently available to the player for this movement, where the combination of the first (mostly stationary) and second (often moving) bases 8c serves at least to reduce the overall movement of the player's hands during game play when digitizing the game play mechanics 101. There is also no limit on having one, two, or more different game piece bases, each preferably with a unique shape and/or look, where at least the look can be set at play time if the base(s) have for example a visual output 8c-vo, such that the multiple bases, each uniquely identifiable to the game app 200-15, can be designated for digitizing any one or more particular game mechanics 101, all as a careful understanding will show.

Referring next to FIG. 5D, there is shown a flowchart of steps related to the use of the devices and apps 200-9 for detecting when a playable card with ID 70-3 has been laid down upon a playable surface, as depicted in FIG. 5A associated with game mechanics step 100-9 for laying down card(s) to play (see also FIG. 6D for a depiction of laying down cards in relation to various playable surfaces such as 10-1, 10-3, 10-4, 10-5, or 10-6). It is first noted that in particular, this devices and apps 200-9 function of “digitizing” the association of a playable card with ID 70-3 with a playing surface and possibly a location within the playing surface may be carried out in virtually any sequence with respect to at least any other game-play mechanics 101 and furthermore has no necessary requirement as to where the playable card 70-3 has been taken/“drawn” from (i.e., the prior location “A”). For example, typically the card 70-3 to be laid down upon a playing surface is drawn from a player's current hand 70-h, but alternatively this card 70-3 could be taken/drawn from another location such as but not limited to a location on any one or more playing surfaces, from the current deck, or from the opponents hand 70-h.

Still referring to FIG. 5D but now also in combination with FIG. 6D, prior to placing a playable card 70-3 onto a playing surface (thus a next location/state “B”) (see step “(1) lay down card” in FIG. 6D) the player presumably and typically draws the playable card 70-3 from their current hand (thus a prior location/state “A” that is presumably already defined in the game state data 300-15 for the given card 70-3). In detailed consideration of the use of devices and apps 200-9 for detecting that a card has been laid down upon a playing surface, it is first necessary to consider the type of playing surface being any of 1) an active game board/playing surface such as “active game board 1” 10-3 (defined in the related PRIOR ART U.S. Pat. No. 10,688,378) or “active game board 2” 10-5 as defined herein, as considered in step 200-9-1, 2) a passive game board/playing surface such as “passive game board 1” 10-4 (defined in the related PRIOR ART U.S. Pat. No. 10,857,450,) “passive game board 2” 10-6, or the combination 10-7 of 10-4 with 10-6 as defined herein, as considered in step 200-9-7, or 3) any other surface 10-1. (It is expected that this information is pre-known/pre-determined before the start of the card game (board game, or board and card game) and thus continually available as information to the game processor app 200-15.)

Assuming that the playing surface is an active game board such as 10-3 (see PRIOR ART U.S. Pat. No. 10,688,378 and the present application's FIGS. 1E and 3E,) it is then also assumed and necessary that the playable card with ID 70-3 comprises an electronically readable tag such as a (sort-range readable) NFC tag (e.g. 70-3a-eid for card 70-3a in FIG. 1A, or 70-3s-eid for sleeve 70-3). Assuming that the playing surface is an active game board such as 10-5 (see the present application's FIGS. 3I) it is then also assumed and necessary that the playable card with ID 70-3 comprises an electronically readable tag such as a (longer range readable) RFID tag (e.g. 70-3a-eid for card 70-3a in FIG. 1A, or 70-3s-eid for sleeve 70-3) or that the playable card 70-3 is being used with an appropriate configuration of a game piece base 8C (such as passive bases 8c-8 or active bases 8c-1, again see FIG. 3I). When a playable card with electronic tag ID 70-3 is laid down in step 200-9-3 upon any of an active game board 10-3 or 10-5 comprising active elements for radiating RF energy to be received and reflected by the electronic tag, active game board 10-3 or 10-5 can then detect in step 200-9-5 at least the timing of the event of laying down the card 70-3 along with the card 70-3's ID, and then possibly a more specific location and even orientation within the active board 10-3 or 10-5 depending upon the technologies implemented. Preferably, the active game board 10-3 or 10-5 is in communications with game app 200-15, such that game app 200-15 then uses this detected information as the “B” location for updating the current game state 300-15 for the detected playable card 70-3 in step 200-9-19.

Referring now to FIG. 6D in combination with FIGS. 1E and 3E, given a playable card 70-3 with a single electronic (NFC) tag (see PRIOR ART U.S. Pat. No. 10,857,450 and the present application FIGS. 1A and 1B,) a careful consideration of the PRIOR ART and present teachings will show that the active game board 10-3's ability to provide a location for the laid down card 70-3 is dependent at least upon the granularity of the NFC readers 10-3a and/or antennas such as 10-3c1 through 10-3cn (see FIG. 1E) for forming a matrix of “physical locations” upon which the laid down card 70-3 can be sensed. Given a playable card 70-3 with two or more electronic (NFC) tags (see FIGS. 3D and 3E,) it is possible for an active game board 10-3 with a sufficiently granular matrix of readers and/or antenna to detect the two or more tags and thus to determine both a location where the card 70-3 was laid down as well as an orientation (which has meaning in at least some card games such as Magic the Gathering).

Referring now to FIG. 6D in combination with FIG. 3I, given a playable card 70-3 with an electronic (RFID) tag a careful consideration will show to those skilled in the art that the active game board 10-5's ability to determine a granular location of the card 70-3 is at least dependent upon by the power and shape/coverage of the emitted/received RF field. As prior discussed, there are many RFID reader systems in the market and significant new research and development is anticipated such that at a minimum the active game board 10-5 determines that a playable card 70-3 has been laid down upon the surface circumscribed by the RF field, but that by using a maximal system further determinations of one or more detailed locations are possible and anticipated. When combined with an appropriate game piece base (either passive base 8c-8 or active base 8c-1, see discussion in relation to FIG. 3I,) active game board 10-5 is anticipated to provide a detailed location of the base 8c with the assumption that the base 8c has been placed upon the playable card 70-3 (as depicted in FIG. 6D,) such that by determining the location of the base 8c, where the base 8c is then also capable of reading the electronic (NFC) tag of the card 70-3, active game board 10-5 is able to determine when/that a card 70-3 has been placed upon board 10-5, the ID of the card 70-3, and at what location on board 10-5 given a certain granularity/accuracy.

Still referring to FIGS. 5D and 6D, assuming that the playing surface is a passive game board such as 10-4 (see PRIOR ART U.S. Pat. No. 10,857,450 and the present application's FIGS. 1D and 6A,) it is then also assumed that determining a physical location upon which a game object (such as a playable card 70-3, a game piece bases 8c, or a trackable figurine 8a) is laid upon the passive game board 10-4 requires an electronic tag reader 8c-tagR (preferably short-range NFC) embedded within the game object. Although the current state-of-the-art in readers 8c-tagR are significantly small in size and low in power, currently placing a reader in a playable card 70-3 is considered problematic due at least to the added thickness, which however is not a problem for game piece bases 8c, or a trackable figurine 8a with added reader 8c-tagR.

When using a passive game board such as 10-4, as taught in the referenced PRIOR ART and as preferred herein, a playable card 70-3 (without a reader 8c-tagR, but with an electronic tag 8c-tag) is placed board 10-4 in step 200-9-9, after which as depicted in FIG. 6D the player places a game piece base 8c over the card 70-3 in step 200-9-11. Depending upon the positioning of the game piece base 8c over the card 70-3, in step 200-9-13 the game piece base 8c is able to read the ID of card 70-3, and depending upon the positioning of the game piece base 8c over the board 10-4, the game piece base 8c is able to read the ID of one or more “physical locations” (see the PRIOR ART for discussion of “physical locations” versus “logical locations”,) where the combination of this information (along with for example the “time of event” for any such digitized game mechanics 100-gm) is used as the “B” location preferably by game app 200-15 for updating the current game state 300-15 for the detected playable card 70-3 in step 200-9-19.

As discussed in relation to the active game boards, a “second” game piece base 8c, preferably with its own distinct shape and/or look, is used for the “laid-down-card” detector in game mechanics such as 100-9, 100-11, and 100-13 (as opposed to a “first” preferably “stationary” “add-card-to-hand” detector, all as prior described,) where all these such game mechanics 100-9, 100-11, and 100-13 are similar in that they all involve the combination of the playable card 70-3 and a playing surface (such as a “no game board surface” 10-1, active game boards 10-3 or 10-5, and passive game boards 10-4 or 10-6). However, again, this is not mandatory as a single game piece base 8c can be configured to work with the game processor app 200-15 for digitizing all game play mechanics 101 as a careful review of FIG. sets 5 and 6 will especially show.

Assuming that the playing surface is a passive game board such as 10-6 as described herein (see FIGS. 3A and 6A in relation to the static magnetic field 10-6-mf) it is then also assumed that determining a physical location upon which a game object (such as a playable card 70-3, a game piece bases 8c, or a trackable figurine 8a) is laid upon the passive game board 10-6 requires a relative orientation sensor 8c-ros (e.g., comprising a magnetic field sensor such as a reed switch or hall effect sensor, all as described in relation to FIG. 3A). Although the current state-of-the-art in relative orientation sensor 8c-ros are significantly small in size and low in power, currently placing a reader in a playable card 70-3 is considered problematic due at least to the added thickness, which however is not a problem for game piece bases 8c, or a trackable figurine 8a with added relative orientation sensor 8c-ros.

When using a passive game board such as 10-6, as taught herein, a playable card 70-3 (without a relative orientation sensor 8c-ros, but with an electronic tag 8c-tag) is placed board 10-6 in step 200-9-9, after which as depicted in FIG. 6D the player places a game piece base 8c over the card 70-3 in step 200-9-11. Depending upon the positioning of the game piece base 8c over the card 70-3, in step 200-9-13 the game piece base 8c is able to read the ID of card 70-3 (using an embedded tag reader 8c-tagR,) and depending upon the positioning of the game piece base 8c over the board 10-6 (e.g., positioned over a first-strength magnetic field such as 10-6-m1 or positioned over a second-strength magnetic field such as 10-6-m2, where the number of possible different fields is determined by the sensitivity of the hall effect sensor used as relative orientation sensor 8c-ros, all as prior discussed in relation to FIG. 3A and as will be understood by those familiar with hall effect sensors,) the game piece base 8c is able to read the ID of one or more “physical locations” demarcated by a distinct magnetic field, where the combination of this information (along with for example the “time of event” for any such digitized game mechanics 100-gm) is used as the “B” location preferably by game app 200-15 for updating the current game state 300-15 for the detected playable card 70-3 in step 200-9-19.

Still in relation to FIG. 6D, there is also anticipated a passive board 10-7 that is a combination of passive boards 10-4 and 10-6 (see FIG. 6A for a discussion,) where a careful understanding of the features of combined passive board 10-7 and the various possible configurations of a game piece base such 8-4, 8-6, and 8-10 (see FIG. 4) that include both magnetic field sensors (used in relative orientation sensor 8c-ros) and electric field sensors (the combination of antenna(s) 8c-ant and readers 8c-tagR) will show that such an arrangement can be used to digitize both the playing card 70-3 ID and a physical location.

Still referring to the combination of FIGS. 5D and 6D, it is possible to play a card game on a “no game board” playing surface 10-1 that lacks any of an active game board such as 10-3 or 10-5 or a passive game board such as 10-4 or 10-6. Using “no game board” playing surface 10-1, in step 200-9-14 the player lays down a playable card with ID 70-3 upon the playing surface after which in step 200-19-15 the player places an electronic tag reader over/within the proximity of the card 70-3 sufficient to read the card 70-3's ID, where example readers include (see FIG. 6C) game piece bases 8c, wearables 9c, or simply the game processor app 200-15 executing on a computing devices such as a tablet 17 or smartphone 15. In step 200-9-17, any of electronic tag readers such as 8c, 9c, or app 200-15 executing on 17 or 15 proceeds to detect the ID of card 70-3 along with the timing of the read for use as “B” location/state, where then the game app 200-15 preferably updates the current game state 300-15 using this sensed information. It is noted that in many card games the spatial location of the played/laid-down card is not material to the meaning of the game, and at least in these card games using a no-board 10-1 provides at least cost advantages, all as will be obvious by a careful consideration. It is also noted specially regarding the sequence of steps for first laying down a card in 200-9-14, and then for detecting information related to the card in 200-9-15 and 200-9-17, at least the sequence can be inverted such that steps 200-9-15 combined with 200-9-17 for example executed by the game app on device 17 or 15 can be accomplished prior to, and thus then followed by, the step 200-9-14 of laying down the card 70-3 on a playing surface (see the depiction in the bottom right of FIG. 6D,) where this reordering of the sequence of certain steps is generally applicable throughout the present invention's various method teachings as will be obvious using a careful consideration.

Referring next to FIG. 5E, typically after a player has positioned a playable card 70-3 upon any of a playing surface, but especially presuming the playing surface is capable of being used to determine a relative spatial location and preferably also orientation of the card 70-3's placement, such as when using any of active game boards 10-3 or 10-5 or passive game boards 10-4 or 10-6, it is then possible that the player would make a subsequent adjustment to any of the placed card 70-3's current location or orientation/rotation, where the change, like the initial placement, can have game meaning and is desirably tracked by using the detect move/turn of card(s) devices and apps 200-11 of the present system 100. The present teachings have no particular limit on the number of card 70-3 moves, the number of turns, the sequence of moving versus turning as opposed to turning versus moving, or even the separation of moving versus turning into distinct physical steps as opposed to alternately being performed as a single physical motion by the player, and thus the present teachings should be understood as determining an after state “B” of a playable card 70-3 that comprises either or both of spatial movement change information or spatial orientation change information, where then the after state “B” is comparable to the prior state “A” to determine additional information by comparing any such movement and orientation changes to and initial prior location and orientation so as to derive additional game meaning.

Still referring to FIG. 5E, there is shown a flowchart of steps related to the use of the devices and apps 200-11 for detecting when a playable card with ID 70-3 has been moved or rotated/turned after having been initially laid upon a playable surface, as depicted in FIG. 5A associated with game mechanics step 100-11 for detecting move/turn of card(s) (see also FIG. 6E for a depiction of moving and/or turning cards in relation to various playable surfaces such as 10-1, 10-3, 10-4, 10-5, or 10-6). It is first noted that in particular, this devices and apps 200-11 function of “digitizing” the subsequent moving and/or turning of a playable card with ID 70-3 with respect to a playing surface and possibly a location within the playing surface may be carried out in virtually any sequence with respect to at least any other game-play mechanics 101 and furthermore has no necessary requirement as to where the playable card 70-3 has been taken/“drawn” from on the playable surface (i.e., the prior location and orientation “A”). For example, typically the card 70-3 to be moved and/or turned upon a playing surface is prior situated upon the same playing surface, but alternatively when playing for example any of a multi-surface game, a multi-game board game, or a combination game board with card game playing surface game, the prior “A” location and orientation may not be the same playing surface.

Still referring to FIG. 5E but now also in combination with FIG. 6E, prior to moving or turning a playable card 70-3 on a playing surface (thus a next location/state “B”) (see “(1) move card, or (1) rotate card” in FIG. 6D) the player presumably and typically moves/rotates the playable card 70-3 from some other location/orientation on the playing surface (thus a prior location/state “A” that is presumably already defined in the game state data 300-15 for the given card 70-3). In detailed consideration of the use of devices and apps 200-11 for detecting that a card has been moved or rotated upon a playing surface, it is first necessary to consider the type of playing surface being any of 1) an active game board/playing surface such as “active game board 1” 10-3 (defined in the related PRIOR ART U.S. Pat. No. 10,688,378) or “active game board 2” 10-5 as defined herein, as considered in step 200-9-1, 2) a passive game board/playing surface such as “passive game board 1” 10-4 (defined in the related PRIOR ART U.S. Pat. No. 10,857,450,) “passive game board 2” 10-6, or the combination 10-7 of 10-4 with 10-6 as defined herein, as considered in step 200-9-7, or 3) any other surface 10-1. (It is expected that this information is pre-known/pre-determined before the start of the card game (board game, or board and card game) and thus continually available as information to the game processor app 200-15.)

Still referring to FIG. 5E, as a careful consideration will show, if in step 200-11-1 the player determines to move in step 200-11-3 a playable card 70-3 from a first location/orientation “A” to a second location/orientation “B” on any of playing surfaces (10-1, 10-3, 10-5, 10-4, or 10-6,) then it is possible to determine the new location “B” using devices and apps 200-9 with the associated methods discussed in relation to FIG. 5D, where game app 200-15 then uses this detected “B” location information for updating the current game state 300-15 for the detected playable card 70-3 in step 200-11-11 (which by a careful consideration is also step 200-9-19 in FIG. 5D). As will also be clear from a careful consideration, it is also possible that the use of devices and apps 200-9 determines both a final “B” location and/or orientation thus detecting either of a “move” and/or a “turn,” where then steps 200-11-5, 200-11-7, and 200-11-9 for determining the turning or rotating of the orientation of the playable card 70-3 are not necessary.

However, steps 200-11-5, 200-11-7, and 200-11-9 specifically teach the determination of the turning or rotating of a playable card 70-3 in step 200-11-17 using a game piece base 8c further comprising an absolute orientation sensor 8c-aos (refer to FIG. 3A for more details regarding both apparatus and methods,) or in step 200-11-9 using a user interface (“UI”) such as available on a game piece base 8c (see touch UI/buttons 8c-ui in FIG. 3A) or a graphical user interface available on the game processor app 200-15. (It is also possible to use steps 200-11-5, 200-11-7, and 200-11-9 in combination with devices and apps 200-9, thus in combination with step 200-11-3, where it is understood that the steps as actual player movements may be fluid and performed essentially together as opposed to the sequential representation inherent to using a flowchart description.)

Regarding the use of a user interface in step 200-11-9 as opposed to the physical determination of a change in rotation as accomplished in either of steps 200-11-5 or 200-11-3, it is noted that while a user interface can be adapted to allow a player for example to “digitally rotate” a virtual card to indicate some physical rotation, it is considered to be much easier for the player to simply touch/tap some aspect of the UI to mean a rotation was performed. In actual game play, physically rotating a card will provide a visual indication to the opponent of a change in card/game status, for example in the game Magic the Gathering, rotating a card from substantially a portrait orientation to substantially a landscape orientation is referred to as “tapping” and indicates to the opponent that the “tapped” card is going to be used in an “attack.” With a UI, a careful consideration will show that it is first possible to easily identify/re-identify a particular card using any of NFC readers described herein or by selecting a card within at least the game processor app 200-15 UI that has already been determined to be “in play,” where once the particular playable card 70-3 is determined, before or after the player physically turns or rotates the card 70-3, they may touch or tap a single UI to indicated that the card has been (for example) “tapped” (i.e. rotated). Regardless of the use of apparatus such as an absolute orientation sensor 8c-aos to “automatically” determine the rotation of a card 70-3, or the use of a user interface element to receive an indication from a player, in step 200-11-11 any combination move and/or turn information (along with for example the “time of event” for any such digitized game mechanics 100-gm) is used as the “B” location/orientation preferably by game app 200-15 for updating the current game state 300-15 for the detected playable card 70-3.

Referring next to FIG. 5F, as prior discussed and as will be understood by those familiar with various types of card games, for both games using non-unique decks like Poker and unique decks like Magic the Gathering, a significant amount of game-play meaning is derived by the players with respect to 1) which cards 70-3 are presented face-up (thus “played”) onto a playing surface for all players to see (detected by devices and apps 200-9, FIG. 5D and step 100-9,) 2) where on the playing surface is each played card 70-3 located, and more particularly at what relative locations are these played cards placed with respect to each other played card 70-3 (detected by devices and apps 200-9, FIG. 5D and step 100-9,) 3) the rotational orientation a played card 70-3 typically with respect to either or both of the playing surface and/or one or more other played cards 70-3 detected by devices and apps 200-9, FIG. 5D and step 100-9,) 4) which cards 70-3 are played in what sequence (i.e., the “time of event” corresponding with the detected location and orientation, preferably all collectively recorded by game app 200-15 into the current game state 300-15,) FIG. 5D and step 100-9,) 5) which played cards 70-3 with a current game state experience a change in the state of any of their spatial attributes such as their current location and/or current orientation (detected by devices and apps 200-11, FIG. 5E and step 100-11,) as well as 6) a determination of which played cards 70-3 are located/oriented in such a ways as to imply “combining” or “joining” (for example any of card values or functions) with respect to one or more other cards 70-3, where this joining of cards can be both (6a) implicit joining, and (6b) explicit joining.

Implicit joining (6a) is primarily accomplished by the processing of detected information (e.g., time of event, location, orientation) comprising the current game state 300-15 for at least each of played cards 70-3, where the processing is conducted by algorithms preferably executing as a part of the game processor app 200-15. Those familiar with computer software and algorithms will understand that there are many possible computer languages and also algorithms for deriving meaning from sets of data such as game state 300-15, where implementations include the use of machine learning and AI beyond the more classic “if-then-else” “rules based” algorithms. Those familiar with machine learning and AI will also appreciate that the current game state data 300-15 such as the sensed location and orientation of a played card 70-3 carries some “accuracy ambiguity” that is traditionally more difficult to resolve using classic algorithms, and furthermore, even at higher levels of sensed accuracy individual players will vary the “played card proximities” between themselves and even between “laying down” card events, such that there are no anticipated hard-and-fast rules for determining that a certain card 70-3 is for example located “close enough” to another card so as to be considered “joined.” What will also be clear, is that especially the presently described game piece bases 8c, wearable 9c, and game processor app 200-15 (preferably executing on a device 17 or 15,) can provide substantially immediate sensory feedback to for example visually and/or audibly indicate that a particular just-played card 70-3 has been determined to be located and/or oriented in such a way so as to confirm (or disaffirm) its joining with another one or more already played cards 70-3, the ability of which is one of the many technical advantages offered by the present teachings of system 100, where then this feedback can be used by the player to adjust the positioning of the just-played card 70-3 if the confirm or disaffirm does not meet expectations.

Explicit joining (6b) comprises the use of devices and apparatus 100-da such as game piece base 8c-9 described in relation to FIGS. 3F, 3G, and 3H. Explicit joining removes accuracy ambiguity by essentially limiting the placement of a particular card 70-3 to be joined/combined with/associated with another card 70-3, where the presently taught base 8c-9 requires that the base 8c-9 be placed substantially over an already played card 70-3pc (see FIG. 3H) presumably resting upon a playing surface (typically) followed by then inserting a “to-be-joined” card (70-3jc of FIG. 3H) into a set location (in this case a “slot” 8c-9s) comprising the base 8c-9 such that the base 8c-9 is able to substantially simultaneously detect both cards 70-3pc and 70-3jc positively confirming the association which can include sensory feedback. Many variations of explicit joining apparatus 8c-9 are anticipated, where for example more than one join-card 70-3jc can be “inserted”/situated with respect to the joining apparatus (such as by further adapting base 8c-9s to comprise multiple slots 8c-9s) allowing for the explicit indication by a player that two or more cards 70-3jc are to be associated with a played card 70-3pc. In other anticipated variations, a game devices such as a base 8c may comprise a base 8c-9b shaped and large enough to substantially simultaneously detect multiple played cars 70-3pc along with one or more joined cards 70-3jc, thus providing for a “many-to-many” type explicit association. In still yet other variations, the base 8c-9b might be configured with for example visual readout such as 8c-9v0 such that base 8c-9b is used in a sequence of registered detections of either of played cards 70-pc and/or joined cards 70-jc, thus no longer requiring substantially simultaneous detection of the totality of cards 70-pc and 70-jc to be considered as explicitly joined.

And finally, with respect to joining two or more cards it is also noted that there is no particular restriction that the “join” criteria be “spatial,” as the criteria may also be “temporal” (e.g., “next card played”) or “spatio-temporal” (e.g., “next card played to the right of an already played card”) and furthermore the join criteria may include being with respect to the playing surface in general, but more specifically with respect to one or more “logical locations” on the playing surface or a playing surface overlay (element 11-3 of FIG. 1E,) such that in practice two different cards might be placed significantly “far-away” from each other on the playing surface, but each of the far-away locations is demarcated as a logical location recognized by the players and meaning “joined.”

Still referring to FIG. 5F, there is shown a flowchart of steps related to the use of the devices and apps 200-13 for detecting when a playable card join-card 70-3jc has been properly situated so as to be associated with at least one already played card 70-pc, generally referred to as “touch to join cards” where strictly speaking cards 70-3jc and 70-pc may or may not actually touch, and where devices and apps 200-13 are depicted in FIG. 5A associated with game mechanics step 100-13 for detecting touch to join cards (see also FIG. 6F for a depiction of touching/associating a join-card with a played card in relation to various playable surfaces such as 10-1, 10-3, 10-4, 10-5, or 10-6). It is first noted that in particular, this devices and apps 200-13 function of “digitizing” the subsequent joining of one playable card with ID 70-3jc with another playable card with ID 70-3pc may be carried out in virtually any sequence with respect to at least any other game-play mechanics 101 and furthermore has no necessary requirement as to where the playable join-card 70-3jc has been taken/“drawn” from such as (a) using a prior played card 70-pc to then be picked up off the playable surface and re-located as a join-card 70-jc, (b) using a card taken 70-3 from a current hand 70-h, or (c) using a card 70-3 taken from the current deck, any of which (a), (b), or (c) thus serving as the prior location and orientation “A”.

Still referring to FIG. 5F but now also in combination with FIG. 6F, prior to placing a join-card 70-3jc onto any of a game device such as a playing surface or a game piece base such as 8c-9, it as first then taken from a location “A” that is for example any of (a), (b), or (c) as stated above to then be placed in the next location/state “B” to indicate joining (see for example “using laid-down card: (1) place join card over/near laid-down card” in FIG. 6F,) where prior location/state “A” is again presumably already defined in the game state data 300-15 for the given card 70-3jc. In detailed consideration of the use of devices and apps 200-13 for detecting that a card 70-3jc has been situated with respect to a played card 70-3pc already situated on a playing surface, it is first necessary to consider the type of playing surface being any of 1) an active game board/playing surface such as “active game board 1” 10-3 (defined in the related PRIOR ART U.S. Pat. No. 10,688,378) or “active game board 2” 10-5 as defined herein, as considered in step 200-13-1, 2) a passive game board/playing surface such as “passive game board 1” 10-4 (defined in the related PRIOR ART U.S. Pat. No. 10,857,450,) “passive game board 2” 10-6, or the combination 10-7 of 10-4 with 10-6 as defined herein, as considered in step 200-13-7, or 3) any other surface 10-1. (It is expected that this information is pre-known/pre-determined before the start of the card game (board game, or board and card game) and thus continually available as information to the game processor app 200-15.)

It is noted that FIG. 6F assumes implicit (6a) joining based for example on an algorithmic confirmed “proximity” or at least the determined specific location of the join-card 70-3jc with respect to either or both the playing surface, such as a demarcated “logical location,” or to a prior played card 70-3pc, whereas the interested reader is directed to especially to the consideration of game piece base 8c-9 with respect to FIGS. 3F, 3G, and 3H for an understanding of how devices and apps 200-13 (which includes game piece base 8c-9 or similar) process explicit (6b) joining to alternatively accomplish step 100-13.

Still referring to FIG. 5F, as a careful consideration will show, if in step 200-13-1 it is determined or preferably pre-known that an active game board is being used, where then if using an active game board 10-3 the player in step 200-13-3a simply places the join card over/near the laid-down card 70-3pc (assuming that this absolute or relative location is defined by the game rules 300-3 to be indicative of a “joining,” otherwise the join-card 70-3jc is differently located according to the rules). Otherwise, if using active game board 10-5, the player in step 200-13-3b simply touches the join card to the game piece base 8c already placed over the laid-down card 70-3pc. In step 200-13-5, either the reader associated with active game board 10-3 or with game piece base 8c detects the ID of the join-card 70-3jc along with the time of event, location, and/or orientation, where then optionally the same reader also re-confirms the ID, location, and/or orientation of the plaid card 70-3pc (otherwise this is assumed to be as prior determined and currently stored in the game state 300-15). In either case, this reader detected “B” location associated information is used by game app 200-15 for updating the current game state 300-15 for the detected playable join-card 70-3jc in step 200-13-17, where the game app 200-15 using any of join-determining-algorithms as prior discussed presumably based at least in part upon game rules 300-3 and in part upon game state 300-15, determines that join-card 70-3jc is now associated with played card 70-3pc, possibly causes sensory feedback to the player, and updates the game state 200-15 accordingly.

It is noted regarding the join-card 70-3jc, that this placed location “B” (i.e., for “joining”) may be an intermediate location, and that after join-detection the player may be given for example a visual or audible confirmation signal by system 100, after which in step 200-13-19 the player may then optionally decide to further “move” the join-card 70-3jc from this “first B” (now updated in the game state as the current “A” location of the join-card) to a “subsequent B” location where it is redetected in step 200-13-21 (see devices and apps 200-9 for detecting a laid down card in FIG. 5D) for additional updating in the game state 300-15, all as a careful consideration will make clear.

Still referring to FIG. 5F in combination with FIG. 6F, if not using an active game board, then a determination is also made in step 200-13-7 if a passive board 10-4 or 10-6 is being used (once again, this and similar steps where the system has pre-known information are presumed to be “automatically determined” in that the player simply takes a physical action regardless of the playing surface and this action is detected by the system 100 in accordance with the pre-known information such as the type of game board). If using a passive game board, then it is preferred that a game piece base 8c is currently situated over the played card 70-3pc, where also preferably the base 8c comprises both an “up” and “down” oriented antenna 8c-ant for substantially simultaneously reading the electronic tag on both the played card 70-3pc and the join card 70-3jc, and otherwise if game piece base 8c comprises only a single antenna 8c-ant that after being faced down to read the played card 70-3pc is flipped over by the player as a part of step 200-13-9 so as to be positioned to read the join-card 70-3jc. With an antenna 8c-ant facing upward, join-card 70-3jc in step 200-13-9 is “touched” (i.e., brought into a sufficient proximity for sensing) to the game piece base 8c, where then the reader comprising the base 8c detects the ID of the join-card 70-3jc along with the time of event, location, and/or orientation, and where optionally the same reader also re-confirms the ID, location, and/or orientation of the plaid card 70-3pc (otherwise this is assumed to be as prior determined and currently stored in the game state 300-15). In either case, this reader detected “B” location associated information is used by game app 200-15 for updating the current game state 300-15 for the detected playable join-card 70-3jc in step 200-13-17, where the game app 200-15 using any of join-determining-algorithms as prior discussed presumably based at least in part upon game rules 300-3 and in part upon game state 300-15, determines that join-card 70-3jc is now associated with played card 70-3pc, possibly causes sensory feedback to the player, and updates the game state 200-15 accordingly.

It is noted regarding the join-card 70-3jc, that this placed location “B” (i.e., for “joining”) may be an intermediate location, and that after join-detection the player may be given for example a visual or audible confirmation signal by system 100, after which in step 200-13-19 the player may then optionally decide to further “move” the join-card 70-3jc from this “first B” (now updated in the game state as the current “A” location of the join-card) to a “subsequent B” location where it is redetected in step 200-13-21 (see devices and apps 200-9 for detecting a laid down card in FIG. 5D) for additional updating in the game state 300-15, all as a careful consideration will make clear.

And finally, still referring to FIG. 5F in combination with FIG. 6F, if using a playing surface 10-1 that is not a game board, a careful consideration of the teachings thus far will show that there are many possible solutions for “digitizing” the intended association by a player of a join-card 70-3jc with an already played card 70-3pc (including the use of an explicit (6b) join device such as game piece base 8c-9 that is not depicted and has already been described). What is presumed is that the already played card 70-3pc has been prior placed upon the not a game board playing surface 10-1 such that its ID has been confirmed and the game state data 300-15 has been updated by game app 200-15 to at least indicated that card 70-3pc is “currently played” (even if no particular location has been indicated, although an “event time” of playing is preferably still indicated). It is noted that when using playing surface 10-1, given that no location for the currently played card 70-3pc (or for that matter joined card 70-3jc) will be available within game state data 300-15 for algorithmic analysis by game processor app 200-15, the only type of implicit joining (6a) is temporal, rather than spatial or even spatio-temporal, all as a careful consideration will show. Using temporal joining, it could for example be assumed that a very next card (such as 70-3jc) played is to be joined to the very last card played (such as 70-3pc) at least under some conditions that can optionally include indications by the player through any of system 100's many user interfaces.

Still referring to the combination of FIGS. 5F and 6F, the present depictions for use with no game board 10-1 presume that the game app 200-15 has already determined the ID of the played card 70-3pc that is to be joined by the next player-presented join-card 70-3jc. As prior mentioned, this “already determined” can be based upon a temporal rule included with game rules 300-3, such as “the last card 70-3pc confirmed as having been played” “can be joined to the next card 70-3jc played” with the possible conditions of for example “within X seconds” or “if confirmed by a player using a system 100 user interface,” or similar. However, it is also possible that there are multiple current played cards 70-3pc and that the player first indicates which of the multiple possible cards is to be used for joining with the next player-presented card 70-3jc, where the are at least two ways of making this selection. First, the player may use a system 100 user interface, such as a visual “screen” interface presented by game app 200-15 on a computing device such as 17 or 15, where the screen interface can show or otherwise allow a player to indicate/select which of the currently played cards 70-3pc is to be joined. Alternatively, each of the multiple currently played cards 70-3pc may each have an associated game piece base 8c presumably placed over the card, where then the player simply “touches” (brings into proximity) the join-card 70-3jc with the particular game piece base 8c associated with the desired played card 70-3pc (see the bottom left of FIG. 6F). (Also note the this presumes that the game piece base 8c to be “touched” either has both downward and upward facing antenna 8c-ant or has been flipped over by the player to have an upward facing antenna 8c-ant.)

In still yet another alternative, the player may have multiple concurrently played cards 70-3pc but be using only a single game piece base 8c (at least base designated for indicating joins,) where the player first positions this base 8c over one of the multiple already played cards 70-3pc, where the base then automatically reads the ID of the “one” card 70-3pc for use as associating with a next played join-card 70-3jc (thus “implicit” temporal,) or where the player next explicitly indicates that the “one” played card 70-3pc should be joined to the next detected card 70-3jc for example by pushing a “join-button” 8c-ui (or otherwise any UI element) available on the base 8c or on the game app 200-15's executing device 17 or 15, where this pushing or otherwise indicating either initiates a reading of the played card 70-3pc's ID over which the game piece base 8c is currently situated, or if the ID was read immediately upon the situation of the game piece base 8c, then being the “last read ID,” this “one” played card 70-3pc is selected for next-joining. (As the careful reader will appreciate, the present system 100 teaches many useful devices and apps 100-da that have uses as described herein, or that may be used in variations for digitizing either game mechanics that are also described herein as being digitized by different apparatus or methods, or for digitizing other game mechanics not described herein, and thus the present invention should not be limited only to the current examples of game mechanics or to the current examples of means for digitizing the exemplary game mechanics.)

Still referring to FIGS. 5F and 6F, once an already played card 70-3pc has been identified by any means, in step 200-13-13 the player then proceeds to identify the joined card 70-3jc by using a reader (such as a game piece base 8c, wearable 9c, or game app 200-15 executing on a computing device) after which the player in step 200-13-15 chooses a proper location onto which to place the join-card 70-3jc according to game rules for visually presenting the game meaning of “joined.” It is noted and will be clear from a careful consideration, it is also possible to first lay down the join-card 70-3jc in a step 200-13-15, which is then followed by identifying the join-card in a step 200-13-12 by any of the means presented herein, and thus it should also be recognized that many of the particular steps presented in the many flowcharts provided herein should be considered as exemplary of a preferred sequence, where the sequence can be varied, some steps removed and other steps added without departing from the teachings provided herein.

And finally, once the detected “B” state for the join-card 70-3jc is determined by the system 100 (i.e, the “time of the event” of playing and associating the join-card 70-3jc with an already played card 70-3pc, where no particular location or orientation is detected for describing the “B” state,) preferably this “B” state associated information is used by game app 200-15 for updating the current game state 300-15 for the detected playable join-card 70-3jc in step 200-13-17, where the game app 200-15 using any of join-determining-algorithms as prior discussed presumably based at least in part upon game rules 300-3 and in part upon game state 300-15, determines that join-card 70-3jc is now associated with played card 70-3pc, possibly causes sensory feedback to the player, and updates the game state 200-15 accordingly.

### CONCLUSION AND RAMIFICATIONS

While only certain features of the invention have been illustrated and described herein, many modifications and changes will occur to those skilled in the art. It is, therefore, to be understood that the appended claims are intended to cover all such modifications and changes as fall within the true spirit of the invention.

We claim:

1. A system for providing one or more digital experiences or services to one or more game players in relation to a physical card game, comprising:
a plurality of electronically trackable game cards for use by the one or more players in the physical card game, where each electronically trackable game card comprises at least two electronic tags, where each of the at least two electronic tags comprises identification information and are arranged at substantially different locations with respect to the game card such that the electronic detection of the at least two electronic tags is further interpretable as a current location and a current orientation of the trackable game card, where the identification information is distinguishable between each of the at least two electronic tags, and where an electronically trackable game card is either of:
(i) a traditional game card further comprising the at least two electronic tags, or
(ii) a traditional game card inserted into a game card sleeve, where the game card sleeve comprises the at least two electronic tags;
an interactive game play system comprising at least one tracked playing area and one or more electronic readers for sensing any of a trackable game card placed upon or otherwise situated within the tracked playing area, where the tracked playing area comprises or is otherwise interpretable as comprising two or more distinct physical locations, where during game play the player places, moves, rotates, or removes a given trackable playing with respect to the tracked playing area to indicate a distinct play of an on-going physical game card, where the interactive game play system subsequently determines game play data for each distinct play comprising the distinguishable identification information of a first electronic tag of the at least two electronic tags with respect to a first distinct physical location and the distinguishable identification information of a second electronic tag of the at least two electronic tags with respect to a second distinct physical location, and
a first computing device in communications with the interactive game play system for executing or otherwise providing a game app, where the game app receives the game play data from the interactive game play system for one or more distinct plays, where either the interactive game play system further determines and provides to the game app additional game play data or the game app at least in part uses the received game play data to further determine the additional game play data comprising both a current playing area location and a current playing area orientation respective of the tracked playing area and associated with the identification information of the trackable game card used in each of the one or more distinct plays, and where the game app provides the one or more digital game experiences or services to the one or more game players based at least in part upon any one of or any combination of the game play data comprising identification information, a current location, or a current orientation of the trackable game card used in at least one distinct play.

2. The system of claim 1 wherein the interactive game play system comprises either:
an electronically active playing surface forming the at least one tracked playing area, where the active playing surface comprises two or more antenna each representing a distinct physical location of the two or more distinct physical locations, where the one or more electronic readers at least in part use the two or more antenna for determining the game play data, or
an electronically sensed playing space volume encompassing the at least one tracked playing area, where the sensed playing space volume is divisible into distinct spatial volume increments each encompassing a distinct physical location of the two or more distinct physical locations, where the interactive game play system comprises two or more electronic readers for determining electronic tag identification information within a distinct spatial volume increment, where the two or more electronic readers determine the game play data, or
an electronically passive playing surface forming the at least one tracked playing area, where the passive playing surface comprises two or more electronic tags each comprising distinguishable identification information and each representing a distinct physical location of the two or more distinct physical locations, where the one or more electronic readers at least in part use the two or more electronic tags for determining the game play data.

3. The system of claim 1 for associating the electronically trackable game card with game card descriptions and with a person, further comprising:
a game card database accessible by the game app, where the game card database comprises (a) game card image related information usable for at least in part identifying or confirming the identification of the game card, and (b) the game card descriptions comprising any one of or any combination of card-play values or otherwise value indicators corresponding to one or more visual distinctions on the game card, where visual distinctions comprise any one of or any combination of pictures, symbols, or text;
where the first computing device is further adapted to comprise or otherwise communicate with a camera and an electronic tag reading means for determining information for use by the game app;
where prior to game play, the person performs any of the following three (3) steps in any sequence:
(1) uses the game app to capture or otherwise receive one or more images of the game card;
(2) uses either one of or any combination of the first computing device and game app or the interactive game play system to electronically read the distinguishable identification information for one or more of the at least two electronic tags included with the game card in the case of (i) or otherwise included with the game card sleeve in the case of (ii), and
(3) in the case of (ii) inserts the game card into the game card sleeve, and
where the game app at least in part uses the one or more images (1) and at least in part uses the game card image related information (a) to first identify the game card and then to associate the identified game card including the game card descriptions (b) with the distinguishable identification information (2) for use in determining the game card descriptions during any given distinct play based at least in part upon the first determination of the identification information (2), where the game app further determines a person to associate with the distinguishable identification information (2) forming a person-card relationship for use as additional game play data such that each distinct play of a given game card is associated with the person, and where the game app determines and maintains an available game card inventory representing all electronically trackable game cards associated with the person.

4. The system of claim 3 for determining and processing a game state representative of the on-going game play, further comprising:
a game state dataset or otherwise database comprising any of the game play data representative of one or more of the distinct plays made by the one or more players throughout the on-going game play, where the game play data further comprises play timing information sufficient for temporally sequencing the one or more distinct plays;
any one of or any combination of a game rules dataset or otherwise database for providing sufficient game instructions in digital format for use by the game app in determining game play results and outcomes respective of each of the sequential distinct game plays, or a game rules algorithm executable by the game app for determining game play results and outcomes respective of each of the sequential distinct game plays, and
wherein for each of the sequential distinct game plays the game app determines the game play results and outcomes for updating the game state dataset or otherwise database, where the game app determines the results and outcomes using at least in part the game play data associated with the distinct game play, at least in part the associated game card description related information (b), and at least in part the game rules or game algorithm.

5. The system of claim 4 wherein the game state dataset or otherwise database further comprises game play data for representing one or more trackable game cards as forming the current hand or otherwise being in the current possession of a player, or as currently discarded from game play but otherwise not currently paced upon or otherwise situated within the tracked playing area so as to be a currently played card, wherein:
the player selects a given trackable game card for current in-hand possession and uses any one of or any combination of the first computing device and game app or the interactive game play system to determine the identification information of the selected game card, where the game app at least in part uses the selected game card identification information to update the game state associating the selected game card to be in the current in-hand possession of the player but otherwise not currently discarded from the game and not currently a played card, and
the player selects a given trackable game card to be represented as discarded from game play and uses any one of or any combination of the first computing device and game app or the interactive game play system to determine the game card identification information of the card selected for discard, where the game app at least in part uses the selected game card identification information to update the game state associating the selected game card to be currently discarded from the game but otherwise not currently in the in-hand possession of the player and not currently a played card.

6. The system of claim 5 where the game app is further adapted to comprise or otherwise interface with a situational advisor function for providing to the player situational advice or help, further comprising or otherwise having access to any one of or any combination of:
a manufacturer and marketplace card database comprising any of information regarding specific game cards for understanding the use of game cards during game play comprising any of the game rules or game rules algorithm or any of the game card data (a) or (b) comprising the game card database, any of information from marketplace assessments, pricing or monetary value regarding game cards, or any of marketplace reviews and opinions regarding game cards;
a player and card playmetrics database comprising any of the game play data or calculation results based at least in part upon any of the game play data comprising the game state dataset or otherwise database, where the player and card playmetrics database forms a card game play history from a multiplicity of games pertaining to one or more given unique instances of one or more game cards as related to any one or more players;
an advertising database comprising any of information from advertisers and otherwise sellers of game play training and services;
a player profile and motivation database comprising any information representative of a player profile or a player motivation assessment according to a gaming player motivation theory, and
wherein either of the game app or otherwise the situational advisor function provides advice or help to the player based at least in part upon any one of or any combination of the available game card inventory, the game state dataset or otherwise database, and the game rules, and at least in part upon any one of or any combination of the manufacturer and marketplace card database, the player and card playmetrics database, the advertising database, and the player profile and motivation database, where the advice or help comprises any one of or any combination of acquiring, advising, or otherwise recording the acquisition of the game cards to add to the available game card inventory, selecting from the available game card inventory one or more cards to be used for game play, selecting from game cards in the current in-hand possession of the player to be played in the next sequential distinct game play of the player, and providing rules and rule explanations for any of results and outcomes as represented in the game state.

7. The system of claim 5 further comprising any one of or any combination of:
an automated opponent function for simulating the game play of one or more virtual opponent players in a game being played by one or more human players, where the game app is further adapted to comprise or otherwise interface with the automated opponent function, and where the automated opponent determines game play choices for the automated virtual opponent based at least in part upon the game state dataset or otherwise database, and
a game streaming function for providing one or more representations of game play to a remote audience, where the game app is further adapted to comprise or otherwise interface with the game streaming function, where the game streaming function has optional access to advertising data for inserting into the one or more game play representations, and where the game streaming function determines the one or more game play representations based at least in part upon the game state dataset or otherwise database.

8. The system of claim 5 for determining a provenance and game play history of a specific instance of a specific game card for use as digital information associated with a non-fungible token (NFT), wherein:
the specific instance of a specific game card is a traditional game card inserted into a game card sleeve (ii), wherein the game card sleeve is further adapted to be a sealable sleeve such that after sealing the game card cannot be removed from the sealed sleeve without substantially damaging the game card sleeve so as to prevent further use of the game card sleeve, and the provenance and game play history is established when a specific instance of a specific game card is first inserted into the sealable game card sleeve and the game card sleeve is sealed, whereafter all game play associated with the specific game card as represented in a game state dataset or otherwise database associated with any one or more games played using the specific game card is accumulated as an NFT digital game play history, whereupon exchange, sale, or otherwise transfer of the use of the still sealed specific game card to an acquiring or otherwise different player the NFT history is transferred and associated with the acquiring or otherwise different player such that the NFT history is further accumulated based upon the game play as represented in a game state dataset or otherwise database related to the different player, and where upon the removing of the sealed specific game card instance from the sealed game card sleeve the NFT history is closed for accumulation with respect to the sealed game card sleeve.

9. The system of claim 1 for providing a player with a second computing device to assist in determining any of game play data, wherein:
the second computing device is in communications with the first computing device and comprises any one of or any combination of electronic reader means and at least one electronic tag comprising device identification information, wherein any one of or any combination of:
the player uses the second computing device to determine the identification information of a trackable game card for providing to the game app;
the player uses the second computing device to determine a distinct physical location of the tracked playing area for providing to the game app;
the interactive game play system determines a distinct physical location of the tracked playing area or otherwise any of game play data for providing to the game app at least in part using information determined by the second computing device;
the player uses either of the first computing device and game app or the interactive game play system to determine the device identification information of the second computing device for providing to the game app, where the game app at least in part uses the device identification information to form a player-device association for use during game play, and
where the second computing device optionally comprises sensory outputs comprising any one of or any combination of visual outputs, audio outputs, or tactile outputs for use in providing at least in part any of the one or more digital game experiences or services, and where the second computing device optionally comprises user interface mechanisms comprising touch sensors and buttons for excepting game play directives to be provided to the game app.

10. The system of claim 9, where the second computing device is in the form of any of:
one or more game piece bases operating individually or in a combination where each game piece base has two opposingly oriented surfaces, wherein:
a) operating individually a first game piece base determines the game card identification information of a first game card whenever the first game card is substantially in contact with one of the two opposingly oriented surfaces and optionally determines the game card identification information of a second game card whenever the second game card is substantially in contact with the remaining of the two opposingly oriented surfaces;
b) operating in the combination a second game piece base is attached to the first game piece base such that the first and the second bases adjoin on a common surface each then having a single remaining exposed surface oppositely oriented from each other, where the first game piece base in the combination detects the game card identification information of the first game card whenever the first game card is substantially in contact with the exposed surface of the first game piece base and the second game piece base detects the game card identification information of a second game card whenever the second game card is substantially in contact with the oppositely oriented exposed surface of the second game piece base;
c) operating individually a given game piece base detects and communicates single played game card identification information related to the first game card and optionally to the second game card to the game app and where operating in the combination the adjoined first and second game piece bases detect and communicate combined played game card identification information related to both the first game card and the second game card, and where the game app when receiving game card identification information relating to both the first and the second game cards determines joined played game card data that is an association between the first and second game cards representing that the cards have been joined by a player to indicate game play meaning;
d) optionally the game piece base further comprises either of absolute or relative orientation sensors and determines and provides played game card data to the game app further comprising an indication of the orientation of the game piece base determined substantially at the time of detecting the first or the second game card, and
e) optionally a game piece decoration is attached to an exposed surface of a game piece base, where the game piece decoration optionally comprises an electronic tag comprising game piece decoration identification information such that the interactive game play system determines device identification information further comprising the game piece decoration identification information for providing to the game app;
a join-card game piece base that is a further adapted game piece base additionally comprising a join card slot on one of the two opposingly oriented surfaces, where the join card slot comprises electronic tag reading means, where the join card slot accepts the second game card to be associated with the first game card, where the player places the first game card onto the surface of the tracked playing area, places the join card game piece base substantially over the first game card with the join card slot oppositely oriented from the surface of the tracked playing area and then inserts the second game card into the join card slot, where the join card game piece base detects and communicates the combined game card data to the game app related to both the first game card and the second game card, where the game app when receiving the combined game card identification information determines joined played game card data that is an association between the first and the second game cards representing that the cards have been joined by the player to indicate game play meaning, where optionally the join card slot is further adapted to comprise either or both of a front display and a back display for extending the slot into which the second game card is accepted, and where the game app communicates images to be displayed on either of the front or back displays based at least in part upon any of the played game card data;
a wearable optionally comprising any of visual, audible, or tactile output means, where the player uses the wearable to substantially make contact with the first game card at a location on the first game card associated with any one of the at least two electronic tags for determining the game card identification information of the first game card for provision to the game app as played game card data, where optionally a first player using a first wearable uses the first wearable to substantially come into contact with a second wearable being used by a second player for determining the device identification information of the second wearable, where the first wearable provides to the game app device-device contact data used at least in part along with the player-device association data by the game app to determine player-player contact data, and where either of the device-device or player-player association data is used at least in part by the game app in determining the one or more of the digital game experiences or services provided to the one or more game players, and
a game card dispenser comprising a receptacle for receiving a deck of the trackable playing cards and at least one electronic reader means situated so as to determine the game card identification information for any given next game card withdrawn by the player from the receptacle, where the dispenser provides the next game card identification information to the game app, and where the receptacle optionally comprises or otherwise interfaces with shuffling means for additionally shuffling the deck prior to any given next game cards being withdrawn.

11. The system of claim 1 for providing a multiplicity of logical locations each providing game play meaning, further comprising:
one or more game area overlays for substantially placing over or otherwise situating within the tracked playing area, where each game area overlay comprises one or more of the logical locations upon which a trackable game card is substantially placed over or otherwise situated, where the game app accesses a pre-known mapping relationship between any of the two or more distinct physical locations and any of the one or more logical locations such that upon receiving a physical location determined by the interactive game play system the game app determines a corresponding logical location using at least in part the pre-known mapping relationship and at least in part the received physical location, and where the game play data further comprises the determined logical location.

12. The system of claim 1 where the game is a combination board and card game, further comprising:
one or more electronically trackable game pieces for use by a player during game play, where each electronically trackable game piece comprises at least one electronic tag, where the at least one electronic tag comprises game piece identification information, where during game play the player places or moves a given trackable game piece upon or within the tracked playing area to indicate a distinct play of the on-going board and card game;
where the interactive game play system is further adapted to determine game play data further comprising the game piece identification information of the at least one game piece electronic tag with respect to a physical location, and
where the game app is further adapted to receive the game piece game play data, and where the game app provides at least one of the one or more digital game experiences or services to the one or more game players based at least in part upon the game piece game play data.

13. The system of claim 1 for providing any of the one or more of the digital game experiences or services as visual augmentations viewable through augmented reality (AR) glasses being worn by the player, further comprising:
at least one pair of AR glasses to be used by one or more of the players during game play, where the at least one pair of AR glasses is in communications with the first computing device and the game app for receiving game play augmentation information based at least in part upon any of the game play data, where the AR glasses provide one or more visual augmentations based at least in part upon the received game play augmentation information, and
where optionally any one of or any combination of the tracked playing area and any one or more of the plurality of electronically trackable game cards are further adapted to comprise non-visible markings, where the AR glasses are further adapted to comprise at least one non-visible light emitter and at least one camera for capturing one or more images representing at least the non-visible light emitted by the AR glasses and reflected off of the non-visible markings, where any one of or any combination of the game app or AR glasses processes the one or more images for determining one or more alignment fiducials based at least in part upon the reflected non-visible light, and where the AR glasses determine the alignment of at least one visual augmentation based as least in part upon the one or more alignment fiducials.

14. The system of claim 1 for accommodating virtual leagues and tournaments of card game play conducted over a distribution of two or more interactive game play systems, further comprising:
an organization for conducting any of the virtual league, tournament, or otherwise distributed game play, wherein the organization maintains a registry of players, where the game app being used by any given one of the two or more distributed interactive game play systems associates the one or more players conducting the game play being tracked by the given distributed system with the registry of players, and where the game app being used by the given distributed interactive game play system provides to the virtual league or tournament any of game play data for use in aggregating league and tournament game play, results and outcomes.

15. The system of claim 1 for training machine learning (ML) and otherwise artificial intelligence (AI) algorithms to better predict and adjudicate card game play, where the algorithms are used to provide one or more one of the one or more digital experiences or services to the one or more players, further comprising:
a first version of a ML or AI algorithm for use by the game app for at least in part determining game results and outcomes respective of each of a multiplicity of distinct plays made by one or more of the game players in an on-going card game, where the first version of the ML or AI algorithm determines the results and outcomes based at least in part upon the game play data provided to the game app by the interactive game play system;
a remote player and card playmetrics database comprising a multiplicity of the game app determined results and outcomes and any of the corresponding game play data used at least in part to determine the results and outcomes, where the multiplicity of determined results and outcomes are determined over a multiplicity of card games played using a multiplicity of interactive game play systems;
one or more officiating persons for providing expert human reasoning to adjudicate the veracity of at least one of the multiplicity of game app determined results and outcomes relative to any given one or more of the multiplicity of distinct plays, where the official adjudications are provided to the playmetrics database in correspondence to the any given one or more of the multiplicity of distinct plays, and
where a second version of the ML or AI algorithm is trained on or otherwise updated using the playmetrics database comprising the distinct plays, the results and outcomes as determined by the first version of the ML or AI algorithm and any corresponding results and outcomes determined by the one or more officiating persons, and where the second version of the ML or AI algorithm is then provided to the game app for replacement or otherwise update of the first version.

16. A method for providing one or more digital experiences or services to one or more game players in relation to a physical card game, comprising the steps of:
providing one or more electronically trackable game cards for use by the one or more players, where each of the one or more trackable game cards comprises two or more distinguishable electronic tags each comprising distinct tag identification information;
providing an interactive game play system comprising at least one tracked playing area for determining game play data relating to any played trackable game card of the one or more trackable game cards that are currently present within the tracked playing area, where the tracked playing area comprises two or more electronically determinable distinct physical locations, where the interactive game play system comprises electronic means for determining a distinct given physical location in association with the distinct tag identification information of a distinct one of the two or more distinguishable electronic tags of a given played trackable game card that has been situated within the trackable playing area such that the distinct one distinguishable electronic tag is substantially located over or within a detectable area associated with the distinct given physical location, where the determined game play data comprises distinct physical location information associated with the distinct tag identification information of each of the two or more distinguishable tags of each given played trackable game card, and where the game play data is at least interpretable as both of a current location and a current orientation of the each given played trackable game card based at least in part upon the two or more distinct physical locations in association with the two or more distinguishable electronic tags;
providing a game app for executing on a first computing device or otherwise providing a first computing device comprising or otherwise executing the game app, where the computing device comprises or otherwise is in communications with at least one camera for use in capturing one or more images of a given trackable game card and at least one electronic tag reader for use in determining the distinct tag information associated with at least one of the two distinguishable electronic tags comprising the given trackable game card;
providing a game card database accessible by the game app, where for each of a multiplicity of possible game cards the game card database comprises (a) game card identification information comprising any of information representative of at least one visual distinction on the each game card, and (b) game card descriptions comprising any one of or any combination of card-play values or otherwise value indicators corresponding to one or more visual distinctions on the game card, where visual distinctions comprise any one of or any combination of pictures, symbols, or text;
providing an available card inventory dataset or otherwise database for maintaining a relationship between a given player and the one or more given trackable game cards either available for use or being used by the given player during game play, where for each of the one or more given cards the available card inventory represents (1) given player identity information, and (2) the distinct tag identification information associated with any one or more of the two or more electronic tags comprising each of the one or more given trackable game cards;
providing game rules comprising any one of or any combination of game rules data or a game rules algorithm for use by the game app in determining game play results and outcomes;
providing a game state dataset or otherwise database for use or update by the game app comprising (i) game play data representing or otherwise indicating any one or more trackable game cards currently in the in-hand possession of each of the one or more players, (ii) game play data representing or otherwise indicating any one or more trackable game cards currently played into the presence of the at least one tracked playing area by any of the one or more players, and (iii) game play data representing game results and outcome data determined at least in part using the game rules, at least in part using any of game card descriptions (b), and at least in part using any of the game play data (i) and (ii);
using the first computing device and game app prior to game play or otherwise prior to trackable game card use to establish, maintain, or otherwise update the available card inventory by determining player identity information (1) for a given player associated with distinct tag identification information (2) for each of the one or more trackable game cards to be used during game play by the given player;
using the first computing device and game app prior to game play or otherwise prior to trackable game card use to form any of combined data or otherwise to establish associations between data comprising the game card database and the available card inventory, where the combined data or established associations join or relate the distinct tag identification information (2) for a trackable game card with the game card identification information (a) of a specific game card found in the game card database comprising any of the at least one visual distinction sufficiently matching any of information determined using image processing of one or more images captured by the computing device and game app of the trackable game card, where any of game card descriptions (b) relating to the specific game card are further combined or otherwise associated with the distinct tag identification information (2) based upon the determination of the relation between (2) and (a);
using any one of or any combination of the first computing device and game app or the interactive game play system during game play to determine any of distinct tag identification information (2) associated with game play for providing to the game app;
using the first computing device and game app for updating the game state database using at least in part the game play data associated with the distinct tag identification information (2);
using at least in part the first computing device and game app for providing any of the digital experiences or services at any time prior, during, or after game play using at least in part any one of or any combination of the current location of a given trackable game card currently present within the tracked playing area and the current orientation of a given trackable game card currently present within the tracked playing area, and at least in part any one of or any combination of the game state database, the game rules, the available card inventory, and the game card database.

17. The method of claim 16, further comprising the steps of:
providing electronically trackable game cards using traditional game cards further adapted to additionally comprise the at least two distinguishable electronic tags, or providing game card sleeves comprising the at least two distinguishable electronic tags wherein the player inserts a traditional game card into the provided game card sleeve to in combination form the electronically trackable game card, and
where the provided game card sleeve is optionally sealable such that after sealing the game card sleeve the traditional game card cannot be removed from the sealed game card sleeve without substantially damaging the game card sleeve so as to prevent further use of the game card sleeve, where a provenance is determined comprising game play history established when a specific instance of a specific traditional game card is first inserted into the sealable game card sleeve and the game card sleeve is sealed, whereafter any of game play data associated with the specific instance of the specific traditional game card as represented in a game state dataset or otherwise database associated with any one or more games played by a specific player using the specific instance of the specific traditional game card is accumulated as the game play history, whereupon exchange, sale, or otherwise transfer of the use of the still sealed specific instance of the traditional game card to an acquiring or otherwise different player the provenance is transferred and associated with the acquiring or otherwise different player such that the provenance is further accumulated based upon the game play as represented in a game state dataset or otherwise database related to the different player, and where upon the removing of the sealed specific instance of the traditional game card from the sealed game card sleeve the provenance is closed for accumulation with respect to the sealed game card sleeve.

18. (canceled)

19. The method of claim 16, wherein the game state dataset or otherwise database comprises game play data for representing each of the one or more trackable game cards being used by a player during game play as in a game state of either currently in-hand, currently played, or currently discarded, further comprising the steps of:
the player selects a given trackable game card for current in-hand possession and uses the first computing device and game app to determine the distinct tag identification information (2) of the selected game card, where the game app at least in part uses the selected game card distinct tag identification information (2) to update the game state dataset or otherwise database representing the selected game card to be in the game state of currently in-hand of the player but otherwise not currently played and not currently discarded;
the player selects and places a currently in-hand trackable game card unto the at least one tracked playing area whereafter the distinct tag identification information (2) of the selected and placed game card is determined using at least in part interactive game play system, where the game app at least in part uses the selected and played game card distinct tag identification information (2) to update the game state dataset or otherwise database representing the selected and played game card to be in the game state of currently played by the player but otherwise not currently in-hand and not currently discarded, and
the player selects for discard either of a currently in-hand game card or a currently played game card, where the player then either places the selected for discard game card upon a specific discard area of the tracked playing area whereafter the distinct tag identification information (2) of the selected for discard game card is determined using at least in part interactive game play system or otherwise the player uses the first computing device and game app to determine the distinct tag identification information (2) of the selected for discard game card, where the game app at least in part uses the selected for discard game card distinct tag identification information (2) to update the game state dataset or otherwise database representing the selected for discard game card to be in the game state of currently discarded by the player but otherwise not currently in-hand and not currently played.

20. The method of claim 16 further comprising any one of or any combination of the steps of:
providing a manufacturer and marketplace card database comprising any of information regarding specific game cards for understanding the use of game cards during game play comprising any of the game rules or game rules algorithm or any of the game card data (a) or (b) comprising the game card database, any of information from marketplace assessments, pricing or monetary value regarding game cards, or any of marketplace reviews and opinions regarding game cards;
providing a player and card playmetrics database comprising any of the game play data or calculation results based at least in part upon any of the game play data comprising the game state dataset or otherwise database, where the player and card playmetrics database forms a card game play history from a multiplicity of games pertaining to one or more given unique instances of one or more game cards as related to any one or more players;
providing an advertising database comprising any of information from advertisers and otherwise sellers of game play training and services;
providing a player profile and motivation database comprising any information representative of a player profile or a player motivation assessment according to a gaming player motivation theory, and
wherein the game app provides advice or help to the player based at least in part upon any one of or any combination of the available game card inventory, the game state dataset or otherwise database, and the game rules, and at least in part upon any one of or any combination of the manufacturer and marketplace card database, the player and card playmetrics database, the advertising database, and the player profile and motivation database, where the advice or help comprises any one of or any combination of acquiring, advising, or otherwise recording the acquisition of the game cards to add to the available game card inventory, selecting from the available game card inventory one or more cards to be used for game play, selecting from the game cards to be used for game play a next game card to be played in the next sequential distinct game play of the player, and providing rules and rule explanations for any of results and outcomes as represented in the game state.

21. The method of claim 16 wherein the interactive game play system comprises either:
an electronically active playing surface forming the at least one tracked playing area, where the active playing surface comprises two or more antenna each representing a distinct physical location of the two or more distinct physical locations, where the one or more electronic readers at least in part use the two or more antenna for determining the game play data, or
an electronically sensed playing space volume encompassing the at least one tracked playing area, where the sensed playing space volume is divisible into distinct spatial volume increments each encompassing a distinct physical location of the two or more distinct physical locations, where the interactive game play system comprises two or more electronic readers for determining electronic tag identification information within a distinct spatial volume increment, where the two or more electronic readers determine the game play data, or
an electronically passive playing surface forming the at least one tracked playing area, where the passive playing surface comprises two or more electronic tags each comprising distinguishable identification information and each representing a distinct physical location of the two or more distinct physical locations, where the one or more electronic readers at least in part use the two or more electronic tags for determining the game play data.
